(19) United States
(12) Patent Application Publication
(10) Pub. No.: US 2022/0192324 A1
(43) Pub. Date: Jun. 23, 2022

(54) Foot Size Measurement Tool and Foot Size Measurement Tool Set

(71) Applicant: OSHIMA-SHOJI CO., LTD., Ichinomiya-shi (JP)

(72) Inventor: Noboru Oshima, Ichinomiya-shi (JP)

(73) Assignee: OSHIMA-SHOJI CO., LTD., Ichinomiya-shi (JP)

(21) Appl. No.: 17/599,690

(22) PCT Filed: Apr. 1, 2020
(86) PCT No.: PCT/JP2020/015124

§ 371 Date: Sep. 29, 2021

(30) Foreign Application Priority Data
Apr. 5, 2019 (JP) 2019-073184

(51) Int. Cl. A43D 1/02; G01B 5/02

(52) U.S. Cl. CPC A43D 1/027; G01B 5/02

(57) ABSTRACT

To provide a foot size measurement tool that enables easy measurement of a ball girth and an instep girth without winding a scale measuring section. A foot size measurement tool is made up of a first wearable element and a second wearable element. The first wearable element has a sock-shaped cover and scale mark indicators. The second wearable element has a cover, a ball girth measurement portion, and an instep girth measurement portion. Foot wears the foot size measurement tool, and a length between ends of a belt-like portion is measured by means of the scale mark indicator. A length between ends of a belt-like portion is measured by means of the scale mark indicator. The thus-measured values are added to the length of the belt-like portion and the length of the belt-like portion. Thus, a length of a ball girth and a length of an instep girth are measured.

### TECHNICAL FIELD

The present invention relates to a measurement tool for measuring a foot size.

### BACKGROUND OF THE INVENTION

Applicant have already filed Patent Document 1, Patent Document 2, and Patent Document 3 relating to a foot size measurement tool. Specifically, the foot size measurement tools described in Patent Document 1, Patent Document 2, and Patent Document 3 have a foot length measurement portion; a ball girth measurement portion; and an instep girth measurement portion, respectively. Particularly, in a foot size measurement tool disclosed in Patent Document 3, a ball girth measurement section 40 has openings 44a through openings 44f for inserting a scale measuring section. Points of intersection between an imaginary straight line showing a direction from one opening to its counterpart opening and a center line 30 are located at positions where a ratio of a length from the heel-side end point to the foot length ranges from 61.5 to 71.5%. The toe-side direction of the center line forms angles with inner direction with respect to foot position in directions of the plural ball-girth-oriented insertion portions. For men, the angles range from 69.0 to 79.0. For women, the angles range from 68.0 to 78.0. Likewise, an instep girth measurement portion 50 has openings 54a through 54f for inserting a scale measuring section. Points of intersection between the imaginary straight line showing the direction from one opening to its counterpart opening and the center line 30 are located at positions where the ratio of a length from the heel-side end point to the foot length ranges from 51.0 to 61.0%. The toe-side direction of the center line forms angles with the foot's-inner-side directions of the plural instep-girth-oriented insertion portions. For men, the angles range from 75.5 to 85.5. For women, the angles range from 74.5 to 84.5. Thus, the ball girth and instep girth of the foot can be measured highly accurately.

### PRIOR ART DOCUMENTS

### Patent Documents

Patent Document 1: JP-A-2001-204510
Patent Document 2: JP-A-2004-618
Patent Document 3: JP-A-2008-206916

### SUMMARY OF THE INVENTION

### Problems to be Solved by the Invention

However, the foot size measurement tools described in Patent Documents 1 through 3 require consumption of much time and effort to measure the ball girth and the instep girth because a scale measuring section with scale marks must be wrapped around the foot by hands (specifically, one stretched portion of the scale measuring section is held by one hand, whilst the other stretched portion of the same is held by the other hand). Another problem is that performing measurement by use of the scale measuring section requires a knack of wrapping the scale measuring section around the foot without loosening or fastening the scale measuring section excessively.

Accordingly, the present invention relates to a foot size measurement tool for measuring a ball girth and an instep girth, and aims at providing a foot size measurement tool that enables easy measurement of ball and instep girths without the necessity of wrapping the foot with the scale measuring section.

### Means for Solving the Problems

The present invention has been created to solve the drawbacks. First, a foot size measurement tool for measuring the size of a foot, comprising:

a first wearable element (5, 5′) and a second wearable element (70);

the first wearable element has a first cover (12) and a bottom plate (60) assuming substantially-foot-like shape and plate-shape;

the first cover is formed from a stretchable, flexible material and having a shape for covering at least an instep and having a shoe opening for letting the foot in;

a bottom plate is secured to the first cover such that the bottom plate is situated on a bottom of the foot while the foot is kept in the first wearable element;

the second wearable element has a second cover (72), a ball girth circumferential portion (102) provided on the second cover, and an instep circumferential portion (122) provided on the second cover;

the second cover is formed from a stretchable, flexible material, assumes a bag-shaped form for letting the foot in, and has a shoe opening for letting the foot in; and an opening (76a) being provided in a second cover instep (76) that is an area located on an instep side when the foot wears the second wearable element (which can also mentioned as “an area located on the instep side of the foot when the foot wearing the first wearable element is slipped into the second wearable element”);

the ball girth circumferential portion is formed in a narrowly-elongated shape on an exterior or interior surface of the second cover at a position on the second cover corresponding to a ball girth of the foot when the foot wears the second wearable element from an area on one side of left and right sides of the instep to an area on the other side of the instep via a second cover sole (74) that is an area situated below the bottom plate when the foot wearing the first wearable element is slipped into the second wearable element, and a pair of first end sides (106c, 108c), which are ends on longitudinal both sides of the ball girth circumferential portion are spaced from each other;

the instep girth circumferential portion is formed in a narrowly-elongated shape on an exterior or interior surface of the second cover at a position on the second cover corresponding to an instep girth of the foot when the foot wears the second wearable element from an area on one side of left and right sides of the instep to an area on the other side of the instep via the second cover sole (74), and a pair of second end sides (126c, 128c), which are ends on longitudinal both sides of the instep girth circumferential portion, being spaced from each other;

the ball girth circumferential portion and the instep girth circumferential portion are formed from an unstretchable or stretch-resistant material; and

the foot size measurement tool is used while the second wearable element is worn over the first wearable element with the foot inside.

The foot size measurement tool having the first configuration measures a length between the pair of first end sides and a length between a pair of second end sides with the foot wearing the first wearable element and the second wearable element. The ball girth can be obtained by adding the length between the first end sides to the length of the ball girth circumferential portion. The instep girth can be obtained by adding the length between the second end sides to the length of the instep girth circumferential portion.

Thus, the length between the pair of first end sides and the length between the pair of second end sides are measured with the foot wearing the first wearing element and the second wearing element that adapt to the length of the foot, and the ball girth and the instep girth can be obtained from the thus-measured values. A scale measuring section with scale marks does not need to be wound around the foot, so that the ball girth and the instep girth can be easily measured.

Since the first wearable element is provided with the bottom plate, the instep girth can be measured with the space created below the foot arch. Thus, shoes can be manufacturing in consideration of a shoe last.

Further, the foot wearing the first wearable element and the second wearable element is photographed from above, thereby an image for measurement purpose can be obtained. Hence, the image for measurement can be easily photographed.

In the first configuration, space is created below the foot arch by the bottom plate while the foot having the foot arch wears in the first wearable element.

Second, the first configuration is characterized in that the first cover has a first cover sole that is an area situated on the bottom of the foot when the foot wears the first wearable element, and as a whole assumes the shape of a bag into which the foot is slipped; and the bottom plate is provided on an exterior or interior surface of the first cover sole. Since the first cover assumes a bag-shaped form, the first cover is deemed as a sock, so that the ball girth and the instep girth can be measured as if the foot is held in a sock. Hence, the shoe last fitting the foot that is wearing the wearable elements can be created.

Third, the second configuration is characterized in that the bottom is secured to the first cover sole along at least a circumference of the bottom.

Fourth, the first configuration is characterized in that the first cover assumes a shape that covers an instep, toe and a heel and a downwardly-opened shape, and a lower end of the first cover is secured to a circumference of the bottom plate.

Fifth, any one of the first through fourth configurations is characterized in that the first cover has a first scale mark indicator (40) and a second scale mark indicator (50);

the first scale mark indicator is provided at a position on the exterior surface of the first cover corresponding to a ball girth on the instep-side of the first cover when the foot wears the first wearable element, and scale marks for measuring a size are arranged on the first scale mark indicator in a direction in line with the ball girth;

the second scale mark indicator is provided at a position on the exterior surface of the first cover corresponding to an instep girth on the instep-side of the first cover when the foot wears the first wearable element, and scale marks for measuring a size are arranged on the second scale mark indicator in a direction in line with the instep girth;

the first scale mark indicator and the second scale mark indicator are formed from an unstretchable or stretch-resistant material;

a pair of first end sides on the ball girth circumferential portion protrudes from an edge of the opening toward the opening or along the edge of the opening;

a pair of second end sides on the instep girth circumferential portion protrudes from an edge of the opening toward the opening or along the edge of the opening; and

the first scale mark indicator is visible between the pair of first end sides and the second scale mark indicator is visible between the pair of second end sides in a plan view while the second wearable element is worn over the first wearable element with the foot inside.

Thus, the length between the pair of first end sides can be easily measured by reading the scale marks of the first scale mark indicator. The length between the pair of first end sides can be easily measured by reading the scale marks of the second scale mark indicator. As a result, the ball girth and the instep girth can be easily measured.

Sixth, any one of the first through fourth configurations is characterized in that the foot size measurement tool further comprises a measurement ancillary tool (150) that is to be photographed along with the foot size measurement tool while the second wearable element is worn over the first wearable element with the foot inside, wherein a first photographing point (150A), a second photographing point (150B) and a third photographing point (150C), which serve as three measurement targets to be photographed, are provided so as to be spaced apart from each other.

Accordingly, the dimension obtained by the measurement ancillary tool is compared with the length between the first end sides and the length between the second end sides. Thereby, the length between the first end sides and the length between the second end sides can be measured. Even if the first cover is not equipped with the scale mark indicator, the length between the first end sides and the length between the second end sides can be measured.

In the sixth configuration, the measurement ancillary tool has scale marks for measuring a dimension or a member having a predetermined length.

Seventh, a foot size measurement tool for measuring the size of a foot, comprising:

a first wearable element (5, 5′) and a second wearable element (70);

the first wearable element has a wearable main body (10) and a bottom plate (60) assuming substantially-foot-like shape and plate-shape;

the wearable main body is formed from an elastic, flexible material and has a first cover (12) that assumes a bag-shaped form for letting a foot in and that has a shoe opening for letting the foot in, a first scale mark indicator (40) which is placed on an exterior surface of the first cover at an instep-side position corresponding to a ball girth when the foot wears the first wearable element, and a second scale mark indicator (50) which is placed on the exterior surface of the first cover at an instep-side position corresponding to an instep girth when the foot wears the first wearable element; scale marks used for measuring a size are arranged on the first scale mark indicator in a direction in line with the ball girth; scale marks for measuring a size are arranged on the second scale mark indicator in a direction in line with the instep girth; and the first scale mark and the second scale mark being formed from an unstretchable or stretch-resistant material;

the bottom plate is secured to an exterior or interior surface of a first cover sole (14) that is an area of the first cover situated on bottom of the foot when the foot wears the first wearable element;

the second wearable element has a second cover (72), a ball girth circumferential portion (102) provided on the second cover, and an instep circumferential portion (122) provided on the second cover;

the second cover is formed from an elastic, flexible material, assuming a bag-shaped form for letting the foot in, and has a shoe opening for letting the foot in; and an opening (76a) being provided in a second cover instep (76) that is an area situated on an instep-side position when the foot wears the second wearable element;

the ball girth circumferential portion is formed in a narrowly-elongated shape on an exterior or interior surface of the second cover at a position on the second cover corresponding to a ball girth of the foot when the foot wears the second wearable element from an area on one side of left and right sides of the instep to an area on the other side of the instep via a second cover sole (74) that is an area situated below the bottom plate when the foot wearing the first wearable element is slipped into the second wearable element, and a pair of first end sides (106c, 108c), which are ends on longitudinal both sides of the ball girth circumferential portion are spaced from each other; and the pair of first end sides protrudes from a edge of the opening toward the opening or along the edge of the opening;

the instep girth circumferential portion is formed in a narrowly-elongated shape on an exterior or interior surface of the second cover at a position on the second cover corresponding to an instep girth of the foot when the foot wears the second wearable element from an area on one side of left and right sides of the instep to an area on the other side of the instep via the second cover sole (74), and a pair of second end sides (126c, 128c), which are ends on longitudinal both sides of the instep girth circumferential portion, being spaced from each other; and the pair of second end sides protrudes from the edge of the opening toward the opening or along the edge of the opening;

the ball girth circumferential portion and the instep girth circumferential portion being formed from an unstretchable or stretch-resistant material; and

the first scale mark indicator being visible between the pair of first end sides and the second scale mark indicator being visible between the pair of second end sides in a plan view while the second wearable element is worn over the first wearable element with the foot inside.

In the foot size measurement tool having the seventh configuration, the foot size measurement tool is viewed from above with the foot wearing the first wearable element and the second wearable element. Thereby, the first scale mark indicator is interposed between the pair of first end sides, and the second scale mark indicator is interposed between the pair of second end sides. Accordingly, the length between the pair of first end sides is measured by means of the first scale mark indicator, and the length between the pair of second end sides is measured by means of the second scale mark indicator. The ball girth can be obtained in accordance with the value that is produced by adding the length between the first end sides to the length of the ball girth circumferential portion. The instep girth can be obtained in accordance with the value that is produced by adding the length between the second end sides to the length of the instep girth circumferential portion.

Hence, the length between the pair of first end sides and the length between the pair of second end sides are read with the foot wearing the first wearable element and the second wearable element that adapt to the length of the foot, and the ball girth and the instep girth can be obtained from the read value. As a result, the scale measuring section with the scale marks does not need to be wound around the foot, so that the ball girth and the instep girth can be easily measured.

Since the first wearable element is provided with the bottom plate, the instep girth can be measured with the space created below the foot arch. Shoes can be manufactured in consideration of the space below the foot arch.

Further, the foot wearing the first wearable element and the second wearable element is photographed from above, thereby an image for measurement purpose can be obtained. Hence, the image for measurement can be easily photographed.

In the seventh configuration, when the foot having the foot arch wears the first wearable element, space is created below the foot arch by the bottom plate.

In the second or seventh configuration, the first cover can also have the first cover sole (14), and also has, when the foot wears the first wearable element, a first cover instep (16) that is an area located on the instep side of the foot, a first cover toe (18) that is an area located on the toe side of the foot, and a first cover heel (20) that is an area located on the heel side of the foot. The second cover has the second cover sole (74) and also has, when the foot wears the second wearable element, a second cover instep (76) that is an area located on the instep side of the foot, a second toe (78) that is an area located on the toe side of the foot, and a second cover heel (80) that is an area located on the heel side of the foot.

In the fifth or seven configuration, the description of “the first scale mark indicator is visible between the pair of first end sides and the second scale mark indicator is visible between the pair of second end sides in a plan view while the second wearable element is worn over the first wearable element with the foot inside.” may also be changed to a description of “the first scale mark indicator is interposed between the pair of first end sides, and the second scale mark indicator is interposed between the pair of second end sides when the foot size measurement tool is viewed from above on the side opposite the second cover sole of the second wearable element while the second wearable element is worn over the first wearable element with the foot inside.”

Eighth, the fifth or seventh configuration is characterized in that the first cover has, when the foot wears the first wearable element, a first cover instep (16) that is an area located on the instep side of the foot, a first cover toe (18) that is an area located on the toe side of the foot, and a first cover heel (20) that is an area located on the heel of the foot;

the first scale mark indicator is provided on a first imaginary line (31G) on the first cover instep; the first imaginary line substantially coincides with a first imaginary curve (31L) as viewed in plan perspective view; in a first worn state in which the first wearable element is worn over the foot whose length adapts to a length from the toe-side end to heel-side end of the first wearable element and in a plan view of the first wearable element, the first imaginary straight line passes (30L) through a location where a first ball girth ratio, which is a ratio of a length (H2) of the first imaginary center line from the heel-side end to a length (H1) of a first imaginary center line (34L) which is a straight line from a toe-side end to heel-side end of the first wearable element, ranges from 61.5 to 71.5%; and where a first ball girth angle (α1), which is an angle formed between a toe-side direction of the first imaginary center line and a foot's-inner-side direction of the first imaginary straight line with respect to a left-right direction of the first wearable element, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate as viewed in a plan view, and is bowed toward the toe;

the second scale mark indicator is provided on a second imaginary line (33G) on the second cover instep; the second imaginary line substantially coincides with a second imaginary curve (33L) as viewed in plan perspective view; when the first wearable element is viewed in plan view in the first worn state, a second imaginary straight line (32L) passes through a location where a first instep girth ratio, which is a ratio of a length of the first imaginary center line from the heel-side end to the length (H1) of the first imaginary center line from the toe-side end to heel-side end of the first wearable element, ranges from 51.0 to 61.0%; and where a first instep girth angle (α2), which is an angle formed between the toe-side direction of the first imaginary center line and a foot's-inner-side direction of the second imaginary straight line with respect to the left-right direction of the first wearable element, ranges from 75.5 to 85.5 degrees for men and from 74.5 to 84.5 degrees for women; and the second imaginary curve interconnects two contact points (32P, 32Q) between the second imaginary straight line (32L) and the contour of the bottom plate as viewed in a plan view, and is bowed toward the toe;

the second cover has the second cover sole and the second cover instep and, when the second wearable element is worn over the first wearable element with the foot inside, also has a second cover toe (78) that is a toe-size area of the foot and a second cover heel (80) that is a heel-side area of the foot;

the ball girth circumferential portion has a ball girth bottom configuration (104) provided on the second cover sole, a ball girth first lateral configuration (106) provided from one end of the ball girth bottom configuration and on the second cover instep, and a ball girth second lateral configuration (108) provided from the other end of the ball girth bottom configuration and also on the second cover instep;

the ball girth bottom configuration is provided on a third imaginary line (104G) in the second cover sole, and the third imaginary line substantially coincides, in a plan perspective view, with the first imaginary straight line (30L) in a second worn state in which the second wearable element is worn over the first wearable element with the foot inside while the length of the second wearable element from a toe-side end to heel-side end corresponds to a length of the first imaginary center line;

the ball girth first lateral configuration and the ball girth second lateral configuration are provided on a fourth imaginary line (105G) in the second cover instep, and the fourth imaginary line substantially coincides with the first imaginary curve (31L) in the second worn state when the second wearable element is viewed in plan perspective view;

the instep girth circumferential portion has an instep girth bottom configuration (124) provided on the second cover sole, an instep girth first lateral configuration (126) provided from one end of the instep girth bottom configuration and on the second cover instep, and an instep girth second lateral configuration (128) provided from the other end of the instep girth bottom configuration and also on the second cover instep;

an instep girth bottom configuration is provided on a fifth imaginary line (124G) in the second cover sole, and in the second worn state, the fifth imaginary line substantially coincides with the second imaginary straight line (32L) in plan perspective view; and the instep first lateral configuration and the instep second lateral configuration are provided on a sixth imaginary line (125G) in the second cover instep, and the sixth imaginary line substantially coincides with the second imaginary line (33L) in the plan perspective view of the second wearable element.

The first ball girth ratio and the second ball girth ratio are the above ratios, and the first ball girth angle and the second ball girth angle are the above angles. Hence, the ball girth can be measured accurately. The first instep girth ratio and the second instep girth ratio are the above ratios, and the first instep girth angle and the second instep girth angle are the above angles. Hence, the instep girth can be measured accurately.

The eighth configuration may also be embodied as below. Specifically, in the eighth configuration, the description of “the first cover has, when the foot wears the first wearable element, a first cover instep (16) that is an area located on the instep side of the foot, a first cover toe (18) that is an area located on the toe side of the foot, and a first cover heel (20) that is an area located on the heel of the foot” can also be changed to a description of “the first cover has, when the foot wears the first wearable element, a first cover sole (14) that is an area located on the bottom of the foot, a first cover instep (16) that is an area located on the instep side of the foot, a first cover toe (18) that is an area located on the toe side of the foot toe, and a first cover heel (20) that is an area located on the heel side of the foot.” The “bottom plate” in the description of “the first scale mark indicator is provided on a first imaginary line (31G) on the first cover instep; the first imaginary line substantially coincides with a first imaginary curve (31L) as viewed in plan perspective view; in a first worn state in which the first wearable element is worn over the foot whose length adapts to a length from the toe-side end to heel-side end of the first wearable element and in a plan view of the first wearable element, the first imaginary straight line passes (30L) through a location where a first ball girth ratio, which is a ratio of a length (H2) of the first imaginary center line from the heel-side end to a length (H1) of a first imaginary center line (34L) which is a straight line from a toe-side end to heel-side end of the first wearable element ranges from 61.5 to 71.5%; and where a first ball girth angle (α1), which is an angle formed between a toe-side direction of the first imaginary center line and a foot's-inner-side direction of the first imaginary straight line with respect to a left-right direction of the first wearable element, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate as viewed in a plan view, and is bowed toward the toe” can also be changed to “first cover sole.” Further, the “bottom plate” in the description of “the second scale mark indicator is provided on a second imaginary line (33G) on the second cover instep; the second imaginary line substantially coincides with a second imaginary curve (33L) as viewed in plan perspective view; when the first wearable element is viewed in plan view in the first worn state, a second imaginary straight line (32L) passes through a location where a first instep girth ratio, which is a ratio of a length of the first imaginary center line from the heel-side end to the length (H1) of the first imaginary center line from the toe-side end to heel-side end of the first wearable element ranges from 51.0 to 61.0%; and where a first instep girth angle (α2), which is an angle formed between the toe-side direction of the first imaginary center line and a foot's-inner-side direction of the second imaginary straight line with respect to the left-right direction of the first wearable element, ranges from 75.5 to 85.5 degrees for men and from 74.5 to 84.5 degrees for women; and the second imaginary curve interconnects two contact points (32P, 32Q) between the second imaginary straight line (32L) and the contour of the bottom plate as viewed in a plan view, and is bowed toward the toe” can also be changed to “first cover sole.”

In the eighth configuration, the description of “the ball girth bottom configuration is provided on a third imaginary line (104G) in the second cover sole, and the third imaginary line substantially coincides, in a plan perspective view, with the first imaginary straight line (30L) in a second worn state in which the second wearable element is worn over the first wearable element with the foot inside while the length of the second wearable element from a toe-side end to heel-side end corresponds to a length of the first imaginary center line” can also be changed to a description of “the ball girth bottom configuration is provided on a third imaginary line (104G) in the second cover sole, and the third imaginary line substantially coincides with a third imaginary straight line (104L) in a plan perspective view; in the second worn state where the second wearable element, the length of the second wearable element from a toe-side end to heel-side end corresponding to a length of the first imaginary center line, is worn over the first wearable element with the foot inside while, a third imaginary straight line passes, in a plan view of the second wearable element, through a position where the first ball girth ratio is substantially identical with a second ball girth ratio, which is a ratio of the length of the second imaginary center line from the heel-side end to a length (H11) of a second imaginary center line (90L), which is a straight line from a toe-side end to heel-side end of the second wearable element; and where a second ball girth angle (β1), which is an angle formed between the toe-side direction of the second imaginary center line and a foot's-inner-side direction of the third imaginary straight line with respect to the left-right direction of the second wearable element is substantially identical with the first ball girth angle”.

In the eighth configuration, the description of “an instep girth bottom configuration is provided on a fifth imaginary line (124G) in the second cover sole, and in the second worn state, the fifth imaginary line substantially coincides with the second imaginary straight line (32L) in plan perspective view” can also be changed to a description of “the instep girth bottom configuration is provided on a fifth imaginary line (124G) in the second cover sole; and the fifth imaginary line substantially coincides with a fourth imaginary straight line (124L) in a plan perspective view; in the second worn state, the fourth imaginary straight line passes, in the plan view of the second wearable element, through a position where the first instep girth ratio is substantially identical with a second instep girth ratio, which is a ratio of the length of the second imaginary center line from the heel-side end to a length (H11) of a second imaginary center line, which is a straight line from a toe-side end to heel-side end of the second wearable element; and where a second instep girth angle (β2), which is an angle formed between the toe-side direction of the second imaginary center line and a foot's-inner-side direction of the fourth imaginary straight line with respect to the left-right direction of the second wearable element is substantially identical with the first instep girth angle”.

Ninth, the eighth configuration is characterized in that the ball girth bottom configuration, the ball girth first lateral configuration, and the ball girth second lateral configuration each assume a belt-like shape that has mutually-parallel long sides; and the instep girth bottom configuration, the instep girth first lateral configuration, and the instep second lateral configuration each assume a belt-like shape that has mutually-parallel long sides.

Tenth, the ninth configuration is characterized in that, in a developed state of the ball girth circumferential portion, a toe-side angle, which is formed between a direction of the long side of the ball girth bottom configuration and a direction of the long side of the ball girth first lateral configuration, ranges from 185 to 191 degrees; a toe-side angle, which is formed between a direction of the long side of the ball girth bottom configuration and a direction of the long side of the ball girth second lateral configuration, ranges from 151 to 157 degrees; a toe-side angle closer to the ball girth first lateral configuration, which is formed by a direction of a boundary (102-1) between the ball girth bottom configuration and the ball girth first lateral configuration with a direction of the long side of the ball girth first lateral configuration, ranges from 73 to 79 degrees; a toe-side angle closer to the ball girth second lateral configuration, which is formed by a direction of a boundary (102-2) between the ball girth bottom configuration and the ball girth second lateral configuration with a direction of the long side of the ball girth second lateral configuration, ranges from 67 to 73 degrees; in a developed state of the instep girth circumferential portion, a toe-side angle, which is formed between a direction of the long side of the instep girth bottom configuration and a direction of the long side of the instep girth first lateral configuration, ranges from 188 to 194 degrees; a toe-side angle, which is formed between a direction of the long side of the instep girth bottom configuration and a direction of the long side of the instep girth second lateral configuration, ranges from 172 to 178 degrees; a toe-side angle closer to the instep girth first lateral configuration, which is formed by a direction of a boundary (122-1) between the instep girth bottom configuration and the instep girth first lateral configuration with a direction of the long side of the instep girth first lateral configuration, ranges from 64 to 70 degrees; and a toe-side angle closer to the instep girth second lateral configuration, which is formed by a direction of a boundary (122-2) between the instep girth bottom configuration and the instep girth second lateral configuration with a direction of the long side of the instep girth second lateral configuration, ranges from 77 to 83 degrees.

As a result, the ball girth circumferential portion can be positioned accurately in the position of the ball girth. In addition, the instep girth circumferential portion can be positioned accurately in the position of the instep girth.

Eleventh, the fifth, seventh, eighth, ninth, or tenth configuration is characterized in that the first scale mark indicator and the second scale mark indicator exhibit unstretchability or stretch resistance in at least the direction of arrangement of scale marks.

Twelfth, any one of the first through eleventh configurations is characterized in that, in an instep-side area of the first cover with the first wearable element the foot inside, a first center indication portion (34a) is aligned, with respect to a direction of foot length from the toe-side end to heel-side end of the first wearable element, to a first imaginary center line (34L) that is a straight line from a toe-side end to heel-side end of the first wearable element in a plan view of the first wearable element; and

in a second cover instep of the second wearable element, a second center indication portion (90a) is aligned, with respect to a direction of foot length from the toe-side end to heel-side end of the second wearable element, to a second imaginary center line (90L) that is a straight line from a toe-side end to heel-side end of the second wearable element in a plan view of the second wearable element.

When the second wearable element is worn over the first wearable element with the foot inside, the two center indication lines are aligned to each other, so that the first wearable element 5 and the second wearable element 70 can be aligned to each other.

Thirteenth, any one of the first through twelfth configurations is characterized in that a first tab (110) that protrudes from one edge area of the ball girth circumferential portion to a toe or heel side is provided in an area adjoining the edge of the opening in the second cover, and a second tab (112) that protrudes from the other edge area of the ball girth circumferential portion to the toe or heel side is provided in an area adjoining the edge of the opening in the second cover;

the first tab and the area on the second cover where the first tab is provided each have a first hole (110-1, 76b-1) for inserting the first lace (116), and the second tab and the area on the second cover where the second tab is provided each have a second hole (112-1, 76b-1) for inserting the first lace (116);

a third tab (130) that protrudes from one edge area of the instep girth circumferential portion to a toe or heel side is provided in an area adjoining the edge of the opening in the second cover, and a fourth tab (132) that protrudes from the other edge area of the instep girth circumferential portion to the toe or heel side is provided in an area adjoining the edge of the opening in the second cover;

the third tab and the area on the second cover where the third tab is provided each have a third hole (130-1, 76c-1) for inserting the second lace (136), and the fourth tab and the area on the second cover where the fourth tab is provided each have a fourth hole (132-1, 76c-2) for inserting the second lace (136);

the first lace inserted into the first tab and the second tab and the second lace inserted into the third tab and the fourth tab are provided; and

the first lace adjusts the degree of fastening between the first tab and the second tab, and the second lace adjusts the degree of fastening between the third tab and the fourth tab.

As a result, the degree of fastening between the first tab and the second tab is adjusted by the first lace, so that the pair of first end sides can be prevented from being lifted up. In addition, the degree of fastening between the third tab and the fourth tab is adjusted by the second lace, so that the pair of second edges can be prevented from being lifted up.

In the thirteenth configuration, the foot size measurement tool can also have a first stopper (118) that is removably engaged with the first lace, and adjusts the degree of fastening of the first lace by fixing to the first lace while both ends of the first lace are inserted into the first stopper; and a second stopper (138) that is removably engaged with the second lace, and adjusts the degree of fastening of the second lace by fixing to the second lace while both ends of the second lace are inserted into the second stopper.

In the thirteenth configuration, the first tab and the second tab are formed so as to protrude toward the toe, and the third tab and the fourth tab are formed so as to protrude toward the heel.

Fourteenth, any one of the first through thirteenth configurations is characterized in that the instep of the second cover is provided with a stretchable elastic member (77, 77′) along the edge of the opening.

Therefore, the edge of the opening can be prevented from being lifted up, and hence the first end sides and the second end sides can be prevented from being lifted up. Therefore, the ball girth and the instep girth can be accurately measured.

Fifteenth, any one of the first through fourteenth configurations is characterized in that the ball girth circumferential portion exhibits unstretchability or stretch resistance at least longitudinally, and the instep circumferential portion exhibits unstretchability or stretch resistance at least longitudinally;

the first cover of the first wearable element exhibits stretchability at least in a direction orthogonal to the direction of a foot length that is a direction from the toe-side end to heel-side end of the first wearable element; and

the second cover of the second wearable element exhibits stretchability at least in a direction orthogonal to the direction of a foot length that is a direction from the toe-side end to heel-side end of the second wearable element.

Sixteenth, any one of the first through fifteenth configurations is characterized in that the bottom plate is formed from an inflexible material or a material that exhibits low flexibility to such an extent that the bottom plate is not deformed along the shape of the bottom of the foot when the foot wears the first wearable element.

Seventeenth, any one of the first through sixteenth configurations is characterized in that the first wearable element and the second wearable element are separately structured, and during use of the foot size measurement tool, the foot wears the first wearable element, and the second wearable element is worn over the first wearable element.

Eighteenth, any one of the first through sixteenth configurations is characterized in that the first wearable element is provided inside the second wearable element; the second cover sole is placed on a lower side of the bottom plate; and the first wearable element is secured to the second wearable element while the shoe opening of the first cover is visible through the shoe opening of the second cover when the foot size measurement tool is viewed in plan view.

Since the first wearable element is secured to the second wearable element, the foot can wear the foot size measurement tool in only one operation. Further, the first wearable element and the second wearable element do not need to be aligned to each other.

Nineteenth, a foot size measurement tool set is equipped with the plurality of foot size measurement size tools defined in accordance with the first through eighteenth configurations; the first wearable elements in the plurality of foot size measurement tools differ from each other in terms of a length from a toe-side end to heel-side end of the first wearable element (which can also mentioned as “when the first wearable element is viewed in plan view, the first wearable element in plurality of foot size measurement tools differ from each other in terms of a length (H1) of the first imaginary center line that is a straight line from the toe-side end to heel-side end of the first wearable element”), and

the second wearable elements in the plurality of foot size measurement tools differ from each other in terms of a length from a toe-side end to heel-side end of the second wearable element (which can also mentioned as “the second wearable element in plurality of foot size measurement tools differ from each other in terms of a length (H11) of the second imaginary center line that is a straight line from the toe-side end to heel-side end of the second wearable element”).

In the foot size measurement tool set of the nineteenth configuration, there are the plurality of first wearable elements that vary from each other in terms of the length of the first imaginary center line, and there are the plurality of second wearable elements that vary from each other in terms of the length of the second imaginary center line. The first wearable element and the second wearable element adapting to the length of the foot to be measured are selected, and the foot wearing the first and second wearable elements is subject to measurement. Thereby, the ball girth and the instep girth can be measured accurately.

Twentieth, a foot size measurement tool for measuring a foot size comprises:

a cover (12) and a bottom plate (60) that is secured to the cover and assumes a substantially-foot-like shape and plate-shape;

the cover is formed from a stretchable, flexible material, assuming a shape which covers at least areas of an instep, a toe, and a heel, that is the area except the bottom of the foot on the surface of the foot, and having a shoe opening for letting the foot in;

the bottom plate is secured to the cover along at least the circumference of the bottom plate such that the bottom plate is situated on the bottom of the foot while the foot wears the foot size measurement tool;

a ball girth indication portion (30) is provided on an exterior surface of the cover at a position corresponding to a ball girth of the foot when the foot wears the foot size measurement tool;

an instep girth indication portion (32) is provided on an exterior surface of the cover at a position corresponding to an instep girth of the foot when the foot wears the foot size measurement tool; and

space is created below a foot arch by the bottom plate while the foot with a foot arch wears the foot size measurement tool.

In accordance with the foot size measurement tool of the twentieth configuration, the ball girth and the instep girth can be obtained by letting the foot wear the foot size measurement tool and measuring a length of the ball girth indication portion and a length of the instep girth indication portion with a 3D measurement tool. The scale measuring section with scale marks does not need to be wound around the foot, thereby enabling easy measurement of the ball girth and the instep girth. Since the foot size measurement tool is equipped with the bottom plate, an instep girth can be measured with space formed blow the foot arch. Thus, shoes can be manufactured in consideration of the space below the foot arch.

The twentieth configuration can also be embodied as follows. Specifically, “A foot size measurement tool for measuring a foot size, comprising:

a cover (12) and a plate-shaped bottom plate (60) that is secured to the cover and assumes a substantially-foot-like shape and plate-shape;

the cover is formed from a stretchable, flexible material, assuming a shape which covers at least areas of an instep, a toe, and a heel, that is the area except the bottom of the foot on the surface of the foot, and having a shoe opening for letting the foot in;

the bottom plate is secured to the cover along at least the circumference of the bottom plate such that the bottom plate is situated on the bottom of the foot while the foot wears the foot size measurement tool;

a ball girth indication portion (30) is provided on an exterior surface of the cover at a position corresponding to a ball girth of the foot when the foot wears the foot size measurement tool;

an instep girth indication portion (32) is provided on an exterior surface of the cover at a position corresponding to an instep girth of the foot when the foot wears the foot size measurement tool.”

Twenty-first, the twentieth configuration is characterized in that the cover has a sole (14) that is an area located on the bottom of the foot when the foot wears the foot size measurement tool, and the cover as a whole assumes a bag shape into which the foot is slipped; the bottom plate is provided on an exterior surface of the sole;

the ball girth indication portion is placed at least from one end to the other end in a specific area of the cover along the ball girth;

the instep girth indication portion is placed at least from one end to the other end in a specific area of the cover along the instep girth; and

the specific area of the cover is an area on the cover except the sole. In the twenty-first configuration, the ball girth indication portion and the instep girth indication portion can also be formed on the bottom surfaces of the bottom plate. Further, in the twenty-first configuration, the ball girth indication portion and the instep girth indication portion can be formed on the bottom surface and side surfaces of the bottom plate. The ball girth indication portion can be formed into a loop shape from the ball girth indication portion formed in the cover and the ball girth indication portion formed on the bottom and side surfaces of the bottom plate. The instep girth indication portion can be formed into a loop shape from the instep girth indication portion formed in the cover and the instep girth indication portion formed on the bottom and side surfaces of the bottom plate.

Twenty-second, the twentieth configuration is characterized in that the cover has a sole (14) that is an area located on the bottom of the foot when the foot wears the foot size measurement tool, and the cover as a whole assumes a bag shape into which the foot is slipped;

the bottom plate is provided on an interior surface of the sole;

the ball girth indication portion is placed at least from one end to the other end along the ball girth in a specific area of the cover;

the instep girth indication portion is placed at least from one end to the other end along the instep girth in a specific area of the cover; and

the specific area of the cover is an upper area of the cover that is upper than the position which is above the bottom of the sole by the thickness of the bottom plate.

In the twenty-second configuration, the ball girth indication portion and the instep girth indication portion can also be formed on the bottom surface of the bottom plate. In addition, in the twenty-second configuration, the ball girth indication portion and the instep girth indication portion can be formed in an area of the cover except the specific area, and the ball girth indication portion and the instep girth indication each are formed in a loop shape.

In any one of the twentieth to twenty-second configurations, the cover, when the foot wears the foot size measurement tool, can also have the instep (16) that is an area located on the instep side of the foot, a toe (18) that is an area located on the toe of the foot, and a heel (20) that is an area located on the heel of the foot.

Twenty-third, the twentieth configuration is characterized in that the cover assumes a downwardly-opened shape, and a lower end of the cover is secured to the bottom plate along a circumference;

the ball girth indication portion is placed at least from one end to the other end of the cover along the ball girth; and

the instep girth indication portion is placed at least from one end to the other end of the cover along the instep girth.

Twenty-fourth, the twenty-first or twenty-third configuration is characterized in that the ball girth indication portion is placed at a position corresponding to a ball girth on a bottom surface of the bottom plate, and the instep girth indication portion is placed at a position corresponding to an instep girth on the bottom surface of the bottom plate.

Twenty-fifth, a foot size measurement tool for measuring a foot size, comprising:

a cover (12) and a plate-like bottom plate (60) that is secured to the cover and assumes shape of a substantially-foot-shaped form;

the cover is formed from a stretchable, flexible material, has a sole (14) that is an area located on bottom of a foot when the foot wears the foot size measurement tool, and as a whole assumes a bag shape into which the foot is slipped;

the bottom plate is provided on an interior surface of the sole;

a ball girth indication portion (30) is provided, on an exterior surface of the cover, at a position corresponding to a ball girth of the foot when the foot wears the foot size measurement tool, and the ball girth indication portion is placed at least from one end to the other end in a specific area of the cover along the ball girth;

an instep girth indication portion (32) is provided, on an exterior surface of the cover, at a position corresponding to an instep girth of the foot when the foot wears the foot size measurement tool, and the instep girth indication portion is placed at least from one end to the other end in a specific area of the cover along the instep girth;

the specific area of the cover is an upper area of the cover that is upper than the position which is above the bottom of the sole by the thickness of the bottom plate; and

space is created below a foot arch by the bottom plate while the foot with a foot arch wears the foot size measurement tool. In accordance with the foot size measurement tool of the twenty-fifth configuration, the ball girth and the instep girth can be obtained by letting the foot wear the foot size measurement tool and measuring a length of the ball girth indication portion and a length of the instep girth indication portion with a 3D measurement tool. The scale measuring section with scale marks does not need to be wound around the foot, thereby enabling easy measurement of the ball girth and the instep girth. Since the foot size measurement tool is equipped with the bottom plate, an instep girth can be measured with space formed blow the foot arch. Thus, shoes can be manufactured in consideration of the space below the foot arch.

Twenty-sixth, the twenty-fifth configuration is characterized in that the ball girth indication portion is provided in shape of a loop on the cover, and the instep girth indication portion is provided in shape of a loop on the cover.

Twenty-seventh, any one of the twentieth through twenty-sixth configurations is characterized in that the ball girth indication portion is a linear indication portion laid along the ball girth, and the instep girth indication portion is a linear indication laid along the instep girth.

Twenty-eighth, any one of the twentieth through twenty-seventh configurations is characterized in that, the cover has, when the foot wears the foot size measurement tool, an instep (16) that is an area located on the instep side of the foot, a toe (18) that is an area located on the toe side of the foot, and a heel (20) that is an area located on the heel side of the foot;

a ball girth indication portion is provided on a first imaginary line (31G) on the instep; the first imaginary line substantially coincides with a first imaginary curve (31L) as viewed in plan perspective view; in a worn state in which the wearable element is worn over the foot whose length adapts to a length from the toe-side end to heel-side end of the foot size measurement tool and in a plan view of the foot size measurement tool, a first imaginary straight line (30L) passes through a location where a ball girth ratio of a length (H2) of the imaginary center line from the heel-side end to a length (H1) of an imaginary center line (34L) which is a straight line from a toe-side end to heel-side end of the foot size measurement tool ranges from 61.5 to 71.5%; a ball girth angle (α1), which is formed between a toe-side direction of the imaginary center line and a foot's-inner-side direction of the imaginary straight line with respect to a left-right direction of the foot size measurement tool, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate viewed in a plan view, and is bowed toward the toe;

the instep girth indication portion is provided on a second imaginary line (33G) over the instep; the second imaginary line substantially coincides with a second imaginary curve (33L) as views in plan perspective view; and when the foot size measurement tool is viewed in plan view in a worn state, a second imaginary straight line (32L) passes through a location where an instep girth ratio of a length of the imaginary centerline from the heel-side end to the length (H1) of the imaginary center line ranges from 51.0 to 61.0%; an instep girth angle (α2), which is formed between the toe-side direction of the imaginary center line and a foot's-inner-side direction of the second imaginary straight line with respect to the left-right direction of the foot size measurement tool, ranges from 75.5 to 85.5 degrees for men and from 74.5 to 84.5 degrees for women; and a second imaginary curve (33L) interconnects two contact points (32P, 32Q) between a second imaginary straight line (32L) and the contour of the bottom plate as viewed in a plan view, and is bowed toward the toe.

Therefore, the ball girth ratio is that mentioned above, and the ball girth angle is that mentioned above. Hence, the ball girth can be measured accurately. Further, the instep girth ratio is that mentioned above, and the instep girth angle is that mentioned above. Hence, the instep girth can be measured accurately.

The twenty-eighth configuration can also be as below. In short, in accordance with the twenty-eight configuration, the description of “the cover has, when the foot wears the foot size measurement tool, an instep (16) that is an area located on the instep side of the foot, a toe (18) that is an area located on the toe side of the foot, and a heel (20) that is an area located on the heel side of the foot” can also be changed to a description of “the cover, when the foot wears the foot size measurement tool, has the sole (14) that is an area located on the bottom of the foot, an instep (16) that is an area located on the instep side of the foot, a toe (18) that is an area located on the toe side of the foot, and a heel (20) that is an area located on the heel side of the foot”. Further, the “bottom plate” in the description of “a ball girth indication portion is provided on a first imaginary line (30G) on the instep; the first imaginary line substantially coincides with a first imaginary curve (31L) as viewed in plan perspective view; in a worn state in which the wearable element is worn over the foot whose length adapts to a length from the toe-side end to heel-side end of the foot size measurement tool and in a plan view of the foot size measurement tool, a first imaginary straight line (30L) passes through a location where a ball girth ratio of a length (H2) of the imaginary center line from the heel-side end to a length (H1) of an imaginary center line (34L) which is a straight line from a toe-side end to heel-side end of the foot size measurement tool ranges from 61.5 to 71.5%; a ball girth angle (α1), which is formed between a toe-side direction of the imaginary center line and a foot's-inner-side direction of the imaginary straight line with respect to a left-right direction of the foot size measurement tool, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate viewed in a plan view, and is bowed toward the toe;” can also be changed to “sole”. Moreover, the “bottom plate” in the description of “the instep girth indication portion is provided on a second imaginary line (33G) over the instep; the second imaginary line substantially coincides with a second imaginary curve (33L) as views in plan perspective view; and when the foot size measurement tool is viewed in plan view in a worn state, a second imaginary straight line (32L) passes through a location where an instep girth ratio of a length of the imaginary centerline from the heel-side end to the length (H1) of the imaginary center line ranges from 51.0 to 61.0%; an instep girth angle (α2), which is formed between the toe-side direction of the imaginary center line and a foot's-inner-side direction of the second imaginary straight line with respect to the left-right direction of the foot size measurement tool, ranges from 75.5 to 85.5 degrees for men and from 74.5 to 84.5 degrees for women; and a second imaginary curve (33L) interconnects two contact points (32P, 32Q) between a second imaginary straight line (32L) and the contour of the bottom plate as viewed in a plan view, and is bowed toward the toe.” can also be changed to “sole.”

Twenty-ninth, any one of the twentieth through twenty-eighth configurations is characterized in that the cover exhibits stretchability at least in a direction orthogonal to a direction of a foot length that is a direction of the foot size measurement tool from a toe-side end to a heel-side end.

Thirtieth, any one of the twentieth through twenty-ninth configurations is characterized in that the bottom plate is formed from an inflexible material or a material that exhibits low flexibility to such an extent that the bottom plate is not deformed along the shape of the bottom of the foot when the foot size measurement tool wears the foot.

Thirty-first, any one of the first through thirtieth configurations is characterized in that the bottom plate assumes the shape of a flat plate.

Thirty-second, any one of the first through thirtieth configurations is characterized in that the bottom plate assumes a plate-like shape having a curve that adapts to a curved shape of an inner bottom of a shoe to be manufactured or a curved shape of a bottom surface of the shoe last.

In the thirty-second configuration, the bottom plate comprises the first configuration (60-1), the second configuration (60-2), and the third configuration (60-3). The first configuration, the second configuration, and the third configuration are continually provided in this sequence from the toe side to the heel side. The first configuration assumes a plate shape that is sloped downward from the toe side to the heel side. The second configuration assumes a plate shape that is sloped upward from the toe side to the heel side. The third configuration assumes a plate shape that is sloped downward from the toe side to the heel side. In the second worn state, the ball girth bottom configuration and the instep girth bottom configuration can also be situated below the area of the second structure.

Thirty-third, a foot size measurement tool set having a plurality of foot size measurement tools in accordance with any one of the twentieth through thirty-second configurations. The plurality foot size measurement tools differ from each other in terms of a length from a toe-side end to heel-side end of the foot size measurement tool (which can also be changed to a description of “the length (H1) of the imaginary center line that is a straight line from the toe-side end to heel-side end of the foot size measurement tool”).

The foot size measurement tool set of the thirty-third configuration is provided with a plurality of size measurement tools that differ in length from each other in terms of a length from a toe-side edge to heel-size edge of the foot size measurement tool. Hence, the foot size measurement tool adapting to the length of the foot to be measured is selected, and the foot size is measured with the foot wearing the selected foot size measurement tool. As a result, the ball girth and the instep girth can be measured accurately.

In accordance with the respective configurations, the direction of the view in the plan view and the plan perspective view is a direction in which the direction of the bottom of the foot is taken as the bottom surface side. The shoe opening side in the first and second wearable elements is directed to a direction of the upper surface side.

### Advantages of the Invention

In accordance with the foot size measurement tool according to claims 1 and 7 and their subordinate claims of the present invention, the length between the pair of first end sides and the length between the pair of second end sides are read with the foot wearing the first wearable element and the second wearable element that adapt to the length of the foot, and the ball girth and the instep girth can be obtained from the read value. As a result, the scale measuring section with the scale marks does not need to be wound around the foot, so that the ball girth and the instep girth can be easily measured.

Since the first wearable element is provided with the bottom plate, an instep girth can be measured with the space created below the foot arch. Shoes can be manufactured in consideration of the shoe last.

In accordance with the foot size measurement tool according to claims 20 and 25 and their subordinate claims of the present invention, the ball girth and the instep girth can be obtained by letting the foot wear the foot size measurement tool and measuring a length of the ball girth indication portion and a length of the instep girth indication portion with a 3D measurement tool. The scale measuring section with scale marks does not need to be wound around the foot, thereby enabling easy measurement of the ball girth and the instep girth.

Since the foot size measurement tool is provided with the bottom plate, an instep girth can be measured with the space created below the foot arch. Shoes can be manufactured in consideration of the shoe last.

### BRIEF DESCRIPTION OF THE DRAWINGS

FIG. 1 is a plan view of a first wearable element;

FIG. 2 is a top perspective view of the first wearable element;

FIG. 3 is a left-side view of the first wearable element;

FIG. 4 is a right-side view of the first wearable element;

FIG. 5 is a bottom perspective view of the first wearable element;

FIG. 6 is an explanatory view for describing the configuration of the first wearable element;

FIG. 7 is an explanatory view for describing the configuration of the first wearable element;

FIG. 8 is a left-side view showing another example of the first wearable element;

FIG. 9 is a left-side view showing the other example of the first wearable element;

FIG. 10 is a cross-sectional view showing the other example of the first wearable element;

FIG. 11 is a left-side view showing the other example of the first wearable element;

FIG. 12 is a plan view of a second wearable element;

FIG. 13 is an enlarged view of the principal portion of FIG. 10;

FIG. 14 is a perspective view of the second wearable element;

FIG. 15 is a bottom view of the second wearable element;

FIG. 16 is an explanatory view for describing the configuration of the second wearable element;

FIG. 17 is a plan view of a cover;

FIG. 18 is a view showing configuration of a circumferential portion of an opening of the second wearable element, wherein (a) is a plan view and an enlarged view of the principal portion, and (b) is a cross-sectional view taken along C-C in (a);

FIG. 19 is a view showing another configuration of the circumferential portion of the opening of the second wearable element, wherein (a) is a plan view and an enlarged view of the principal portion, and (b) is a cross-sectional view taken along D-D in (a);

FIG. 20 is a developed view showing a ball girth measurement section;

FIG. 21 is a developed view showing an instep girth measurement section;

FIG. 22 is a plan view showing the first wearable element worn over a foot;

FIG. 23 is a perspective view showing the first wearable element worn over the foot;

FIG. 24 is a cross-sectional view of the first wearable element, wherein (a) is a cross-sectional view taken along line A-A in FIG. 1, and (b) is a cross-sectional view taken along E-E in FIG. 22;

FIG. 25 is a plan view showing that the second wearable element is worn over the first wearable element with the foot inside;

FIG. 26 is a perspective view showing that the second wearable element is worn over the first wearable element with the foot inside;

FIG. 27 is a left-side view showing that the second wearable element is worn over the first wearable element with the foot inside;

FIG. 28 is a right-side view showing that the second wearable element is worn over the first wearable element with the foot inside;

FIG. 29 is a cross-sectional view of the second wearable element, wherein (a) is a cross-sectional view taken along line B-B in FIG. 12, and (b) is a cross-sectional view taken along F-F in FIG. 25;

FIG. 30 is an explanatory view showing a measurement method employed in a foot size measurement tool;

FIG. 31 is a plan view showing another example of the second wearable element;

FIG. 32 is a plan view showing the first wearable element in a first modification of the foot size measurement tool;

FIG. 33 is a top perspective view of the first wearable element in the first modification of the foot size measurement tool;

FIG. 34 is a plan view showing the second wearable element worn over the first wearable element with the foot inside, in relation to the first modification of the foot size measurement tool;

FIG. 35 is an enlarged view of the principal portion in FIG. 34;

FIG. 36 is a plan view showing a configuration in which the first wearable element is secured to the second wearable element;

FIG. 37 is a cross-sectional view showing the configuration in which the first wearable element is secured to the second wearable element;

FIG. 38 is a plan view showing a second modification of the foot size measurement tool;

FIG. 39 is a top perspective view of the second modification of the foot size measurement tool;

FIG. 40 is a bottom perspective view showing another example of the second modification of the foot size measurement tool;

FIG. 41 is a bottom perspective view showing still another example of the second modification of the foot size measurement tool; and

FIG. 42 is a left-side view showing yet another example of the second modification of the foot size measurement tool.

### EMBODIMENTS FOR IMPLEMENTING THE INVENTION

The present invention relates to a foot size measurement tool for measuring a ball girth and an instep girth, and aims to provide a foot size measurement tool that enables simple measurement of a ball girth and an instep girth without a necessity to measure a foot by wrapping the foot with a scale measuring section.

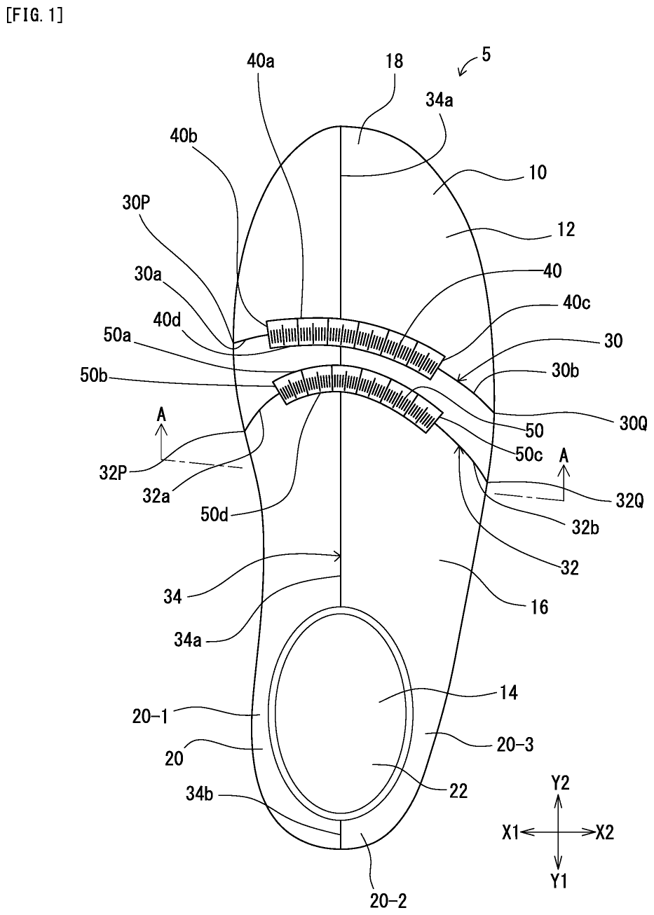

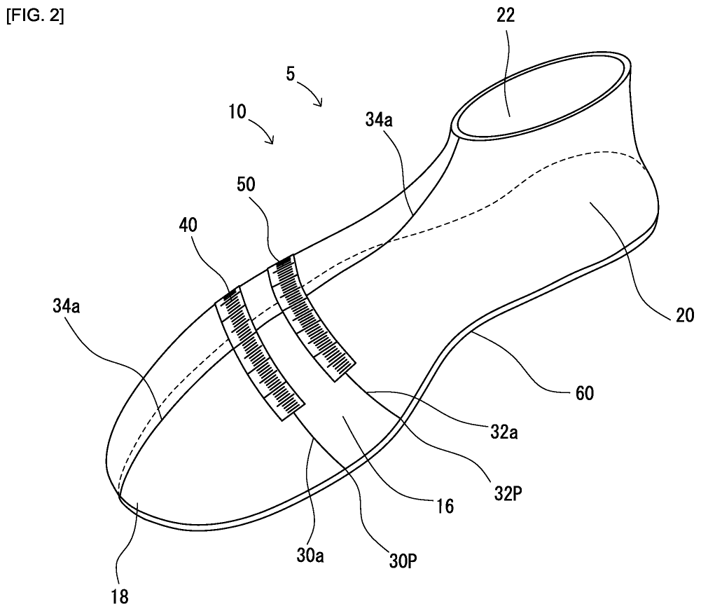

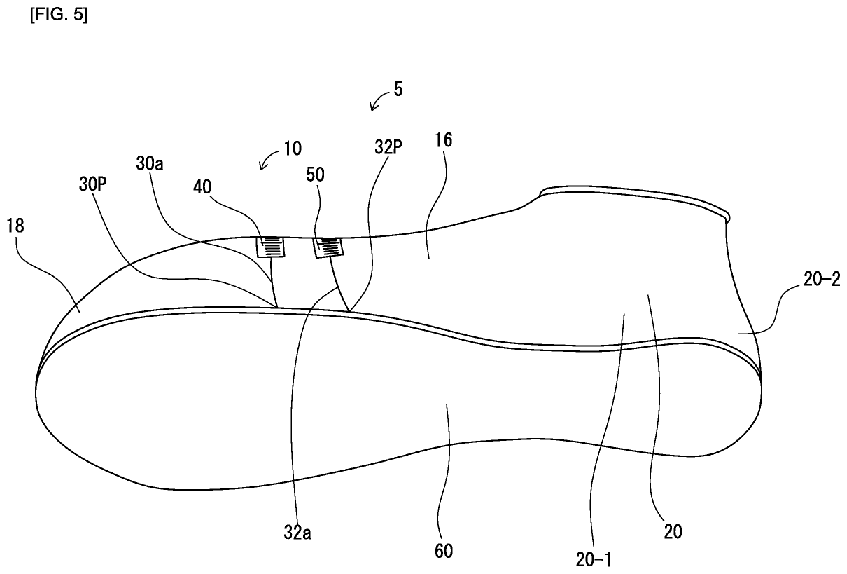

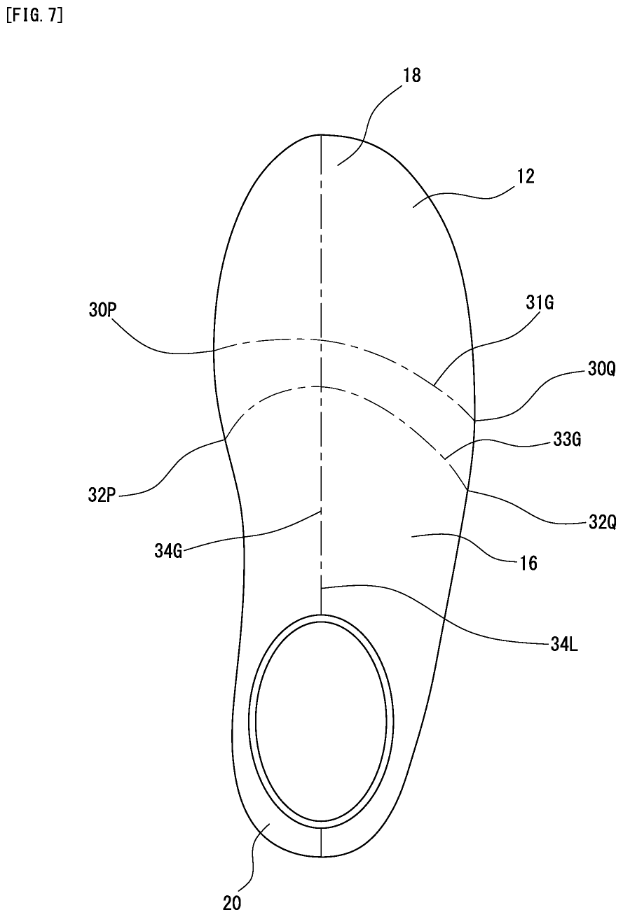

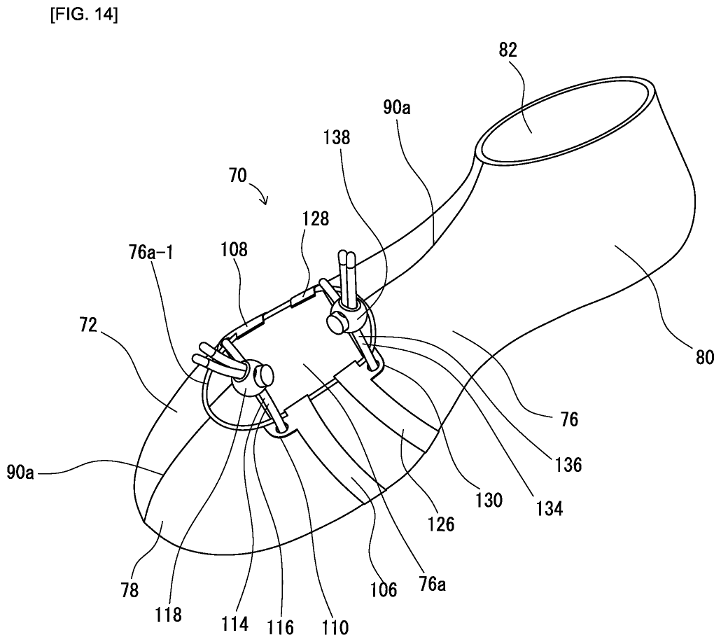

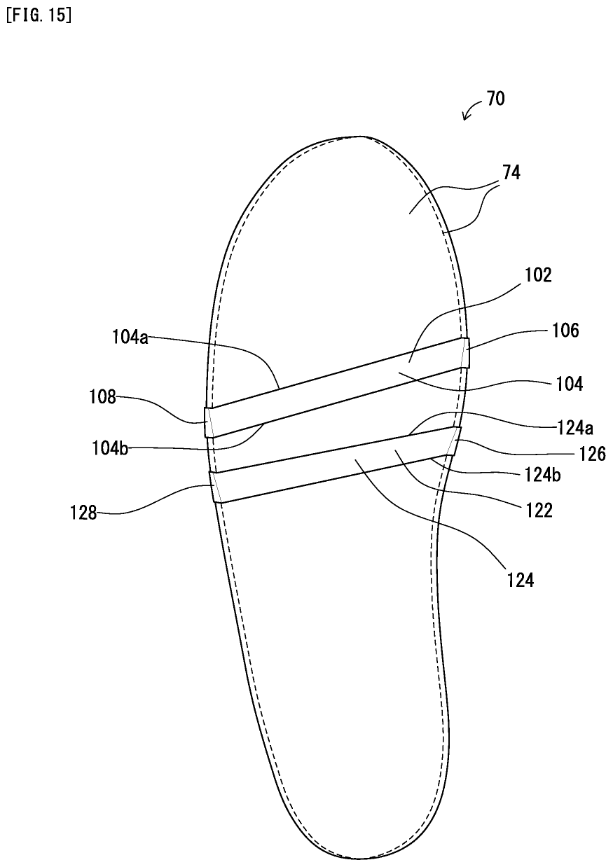

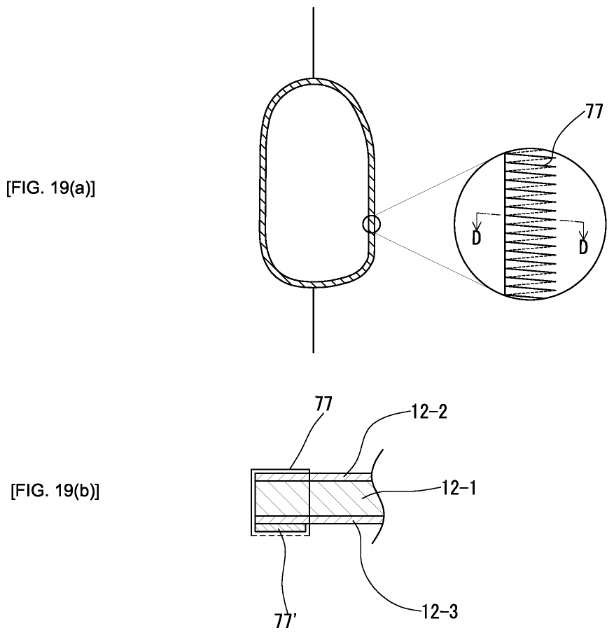

As configured in FIGS. 1 through 21, a foot size measurement tool 1 of the present invention has a first wearable element (may also be called a “first foot cover body” or a “first sock section”) 5 and a second wearable element (may also be called a “second foot cover body” or a “second sock section”) 70.

As configured in FIGS. 1 through 7, the first wearable element 5 has a wearable main body (may also be called a “cover body” or “sock body”) 10 and a bottom plate 60 secured to a bottom surface of the wearable main body 10.

The wearable main body 10 has a cover (may also be called a “foot cover” or “bag-shaped portion”) 12 and scale mark indicators 40 and 50 fixed on the cover 12.

The cover (first cover) 12 assumes the shape of a bag into which a foot slips (may also take the shape of a bag that covers foot) (or may also take the shape of socks or hoses). The cover 12 has a sole 14, an instep 16 which continually extends from the sole 14, a toe 18 which continually extends from the sole 14 and the instep 16, and a heel 20 which continually extends from the sole 14 and the instep 16. The cover 12 as a whole is integrally formed from an elastic and flexible material.

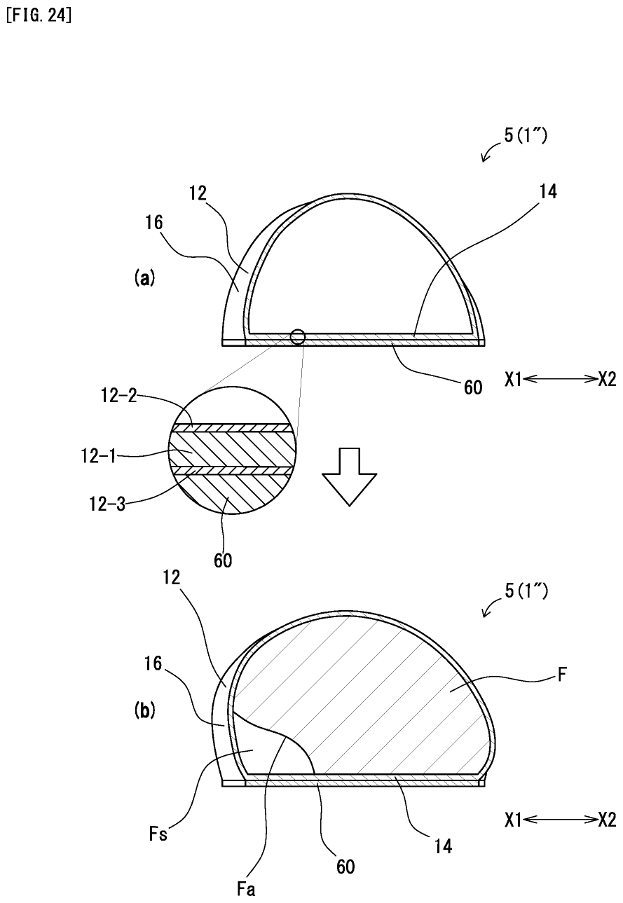

The elastic, flexible material forming the cover 12 is made of rubber, such as natural rubber and synthetic rubbers (for example, silicon rubber and chloroprene rubber), or a fabric material (a cloth (texture)) (e.g., a fabric material (a cloth (texture)) used for hoses), such as polyester, polyurethane, acryl, wool, and cotton. As to fabric material used for hoses, fabric type is primarily knitted (especially a round braid) in terms of the type of the cloth. As in the case of hoses, the cover is formed by combination of a plurality of materials; for instance, acrylic cotton blend, polyester cotton blend, and acrylic wool blend. A specific example of a material for the cover 12 is a three-layer, sheet-shaped member in which pieces of cloth 12-2 and 12-3 are fixed one on each side to a rubber sheet 12-1 with an adhesive (see FIG. 24A). The rubber sheet 12-1 is made of; for instance, chloroprene rubber. The pieces of cloth 12-2 and 12-3 are made of; for example, a polyethylene or nylon cloth.

As the stretching and contracting direction of fabric material, the fabric material can preferably stretch and contract in both vertical and horizontal directions, as a result, in 360-degree all directions. Since a ball girth and an instep girth are subjected to measurement, a material that stretches in only a horizontal direction (X1-X2 direction in FIG. 1) may be applicable. Specifically, all that is required of the cover 12 is to exhibit stretch and contraction in directions orthogonal to the foot length direction of the first wearable element 5 from toe to heel.

Where the cover 12 exhibits shape retention as in the case of a rubber cover, it assumes a shape, such as that shown in FIGS. 1 through 5, even when the first wearable element 5 is placed simply. However, when being made of a fabric material, the cover 12 does not exhibit shape retention. Hence, when the first wearable element 5 is placed simply, the fabric material of the cover 12 is folded into a lap, whereupon the cover 12 becomes to be flatly folded. FIGS. 1 through 5 show that the cover 12 is kept in shape without stretching. Specifically, FIGS. 1 through 5 show the case where the cover 12 does not stretch with a mold remaining inserted in the cover 12 and where the cover 12 retains its original shape without the fabric material of the cover 12 being folded into a lap. As the thick of the cover 12, the material constituting the cover 12 is as thick as the ordinary cloth used for hoses (for example, about a thickness of 1 through 3 mm) in the case of the fabric material, the cover is made of a material having a thickness of about 1 through 3 mm in the case of rubber. In both cases, the thinnest possible material is desirable to reduce measurement errors because a ball girth and an instep girth of a foot undergo measurement.

Below is a description of the cover 12 that is provided, particularly with a shape retained, by reference to FIGS. 1 through 7. The sole (a sole for use in the first cover) 14 makes up a bottom of the cover 12; has the same shape and size as those of the bottom plate 60; and assumes a substantially-foot-like shape (may also be said as a foot shape). In short, the sole 14 is an area situated on the sole side of the foot when the foot is kept in the first wearable element 5. The sole 14 assumes the shape of a flat plate because it is secured to an upper surface of the bottom plate 60.

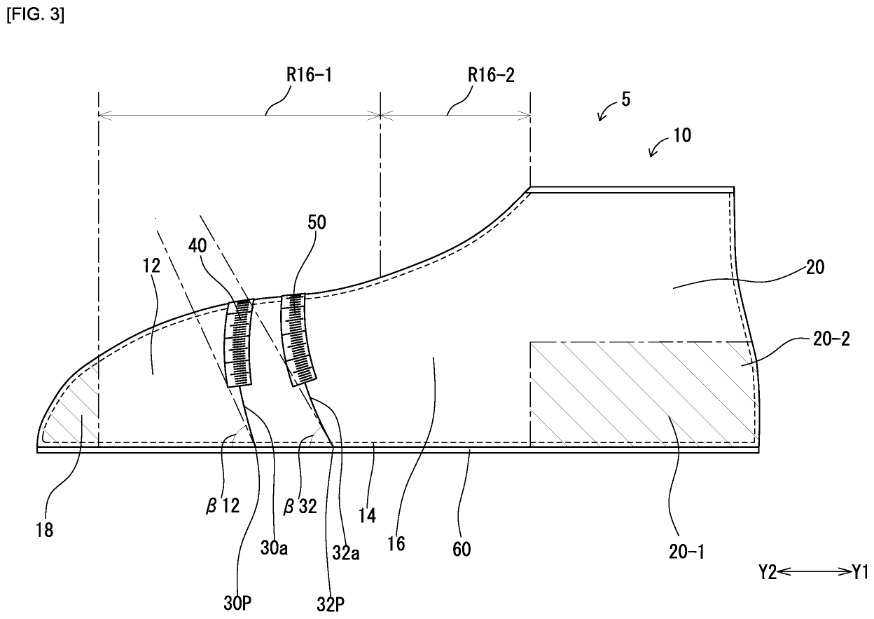

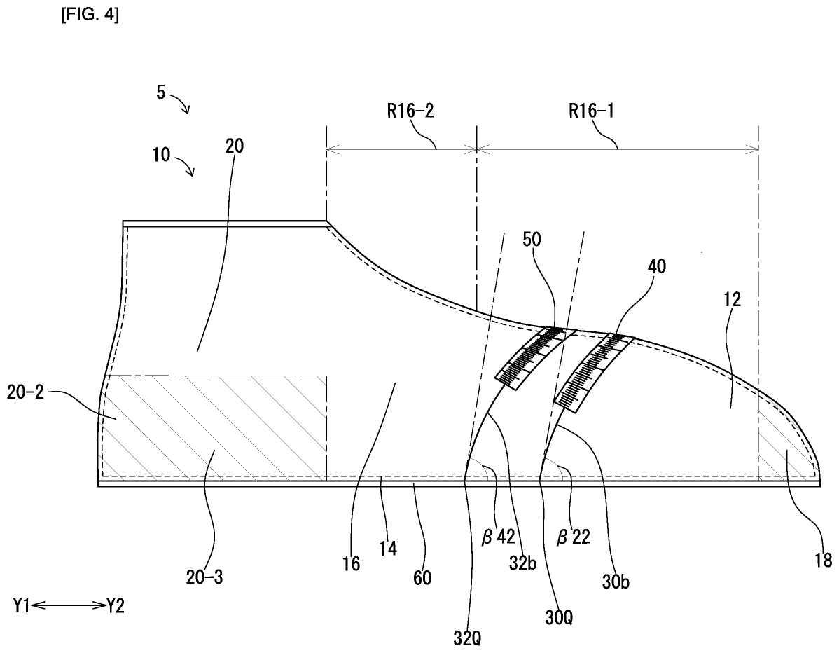

The instep (first instep) 16 assumes a substantially-arched shape that continually extends from a left edge (on X1 side) of the sole 14 and also from a right edge (on X2 side) of the sole 14 and that entirely assumes a bulge substantially at its center with respect to the left and right directions. A transverse cross-sectional shape of the arch assumes the shape of a substantially inverted U, and the transverse cross-sectional shape becomes higher with increasing distance from the left edge to the top of the instep 16. An angle of inclination from the horizontal direction (the direction of the sole 14) becomes smaller with increasing distance from the left edge to the top. Likewise, the transverse cross-sectional shape becomes higher with increasing distance from the right end to the top, and the angle of inclination from the horizontal direction becomes smaller with increasing distance from the right end to the top. As shown in FIGS. 3 and 4, the top of the instep 16 in left-right direction becomes, gradually higher with increasing distance from a leading edge to rear edge of the cover 12. As shown in FIGS. 3 and 4, when the cover 12 is viewed sideways, a curve formed by the top of the instep 16 assumes a mild upward slope in the horizontal direction from a leading edge to a midway position but a steeper upward slope from the midway position to the top. Specifically, an angle of inclination of a horizontal line tangent to the curve from the leading edge to rear edge of the instep 16 becomes smaller or substantially constant in a region R16-1 between the leading edge of the instep 16 and the midway position (the angle of inclination becomes smaller from the leading edge to the midway position of the region R16-1 and becomes substantially constant from the midway position). In a region R16-2 from the midway position toward the rear edge of the instep 16, the angle of inclination of the horizontal line tangent to the curve becomes greater from the leading edge toward the rear edge, and the slope becomes steeper. The instep 16 is the area where the instep 16 is situated on the instep side of the foot when the foot is kept in the first wearable element 5.

The toe (first toe) 18 continually extends from the leading edge of the sole 14 and also from the leading edge of the instep 16. A transverse cross-section of the toe 18 assumes a substantially-arched shape except a leading edge of the toe 18. The transverse cross-section assumes a smaller diameter with getting close to the leading edge of the toe 18. The leading edge of the toe 18 coincides with the leading edge of the sole 14. As shown in FIGS. 3 and 4, when the cover 12 is viewed sideways, a curved top of the toe 18 is sloped upward from the leading edge toward the rear edge of the toe 18. An angle of inclination of a horizontal line tangent to the curve becomes smaller from the leading edge toward the rear edge of the toe 18. The toe 18 is an area where the toe 18 is situated on the toe side of the foot when the foot is kept in the first wearable element 5.

The heel (first heel) 20 continually extends from the rear edge of the sole 14 as well as from the rear edge of the instep 16. In an area 20-1 on the left side of the heel 20, a lower portion of the area slightly bulges to the outside (X1 side). In an upward direction, an upper area located above the lower portion tilts much closer to the inside (i.e., X2 side). In an area 20-2 on the back side (Y1 side) of the heel 20, a lower portion slightly bulges to the outside (Y1 side). In an upward direction, an upper portion above the lower portion tilts much closer to the inside (i.e., Y2 side). In an area 20-3 on the right side of the heel 20, a lower portion of the area slightly bulges to the outside (X2 side). In an upward direction, an upper portion above the lower portion tilts much closer to the inside (i.e., X1 side). The heel 20 is an area situated on the heel side of the foot when the foot is kept in the first wearable element 5.

An opening 22 serving as a hole for slipping the foot into is provided at an upper end of the heel 20. When the foot is kept in the first wearable element 5, the foot is inserted by way of the opening 22. Specifically, the opening 22 is situated at an elevation above the cover 12. A vertical length of the heel 20 is as high as the opening 22 that is lower below an ankle when the foot is kept in the first wearable element 5.

The covering 12 has a ball girth indication line 30, an instep girth indication line 32, and a center indication line 34. The indication lines are an indication line in the form of a linear line (specifically, the form of a solid line) and provided in print or handwriting. Alternatively, an indication portion can also be provided, in lieu of the indication line, along the position of the indication line. For instance, the indication portion can also be formed from an embroidery thread or a multi-opening arrangement. In the case of the embroidery thread, a stretchable thread is used. In the case of the multi-opening arrangement, circular openings, for instance, are arranged along the positions of the indication lines.

The ball girth indication line (ball girth indication portion) 30 has a left ball girth indication line 30a originating from the left end of the instep 16 and a right ball girth indication line 30b originating from the right end of the instep 16. A left end point 30P which is a left-end point of a left ball girth indication line 30a and a right end point 30q which is a right-end point of a right ball indication line 30b are defined as below.

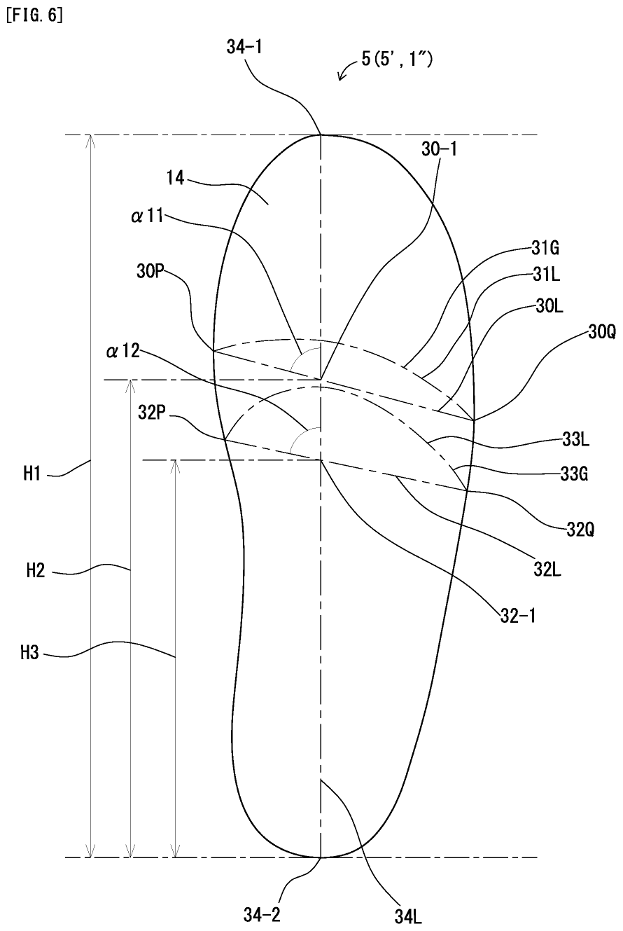

As shown in FIG. 6, a contact point between the first straight line 30L (a first imaginary line) inclined relative to a center line (a first imaginary center line or an imaginary center line) of the sole 14 and a left side of the sole 14 is a left end point 30P. A contact point between the first straight line 30L and a right side of the sole 14 is a right end point 30Q. The center line 34L is an imaginary straight line that connects a front end 34-1 (a toe-side edge) to a rear end 34-2 (a heel-side edge) of the sole 14 when the sole 14 is viewed from top (i.e., when the cover 12 is viewed from top) (the front end 34-1 is situated preferably at a position corresponding to the second toe). The center line 34L is a straight line, and a heightwise position of the center line 34L is situated in the sole 14 (particularly, an underside of the sole 14) (may also be situated in a top surface of the bottom plate 60). In the first straight line 30L, a distance from an intersection point 30-1 between the first straight line 30L and the center line 34L to the rear end 34-2 is length H2. A distance from the front end 34-1 of the center line 34L to the rear end 34-2 is length H1 (a length in a direction of foot length). A ratio of H2 to H1 (i.e., a ball girth ratio) is 61.5 to 71.5% (preferably 66.5%). In relation to an inclination angle (a ball girth angle) of the first straight line 30L relative to the center line 34L, a toe-side direction of the center line 34L forms an angle α11 with a foot-inside direction of the first straight line 30L. For men, the angle α11 ranges from 69.0 to 79.0 degrees (preferably 74.0 degree). For women, the angle α11 ranges from 68.0 to 78.0 degrees (preferably 73.0 degree). In a word, the first wearable element 5 includes men's wearable element and women's wearable element.

With respect to the direction of a plan view or plan perspective view of the first wearable element 5, the bottom plate 60 and the sole 14 are on a bottom side, and the opening 22 is on an upper surface side. A direction of the sole side of the foot corresponds to the direction of an underside.

The contact points between the first straight line 30L and the side of the sole 14 are taken as the left end point 30P and the right end point 30Q. Alternatively, contact points between the first straight line 30L and respective sides of the bottom plate 60 may also be taken as the left end point 30P and the right end point 30Q. Specifically, the center line 34L may be a connection between a front end of the bottom plate 60 (a toe-side edge (preferably a position corresponding to the second toe) and a rear end (a heel-side edge) (in this case, the front end of the center line 34L acts as a front-end position of the bottom plate 60, and a rear end of the center line 34L acts as a rear-end position of the bottom plate 60). The contact points between the first straight line 30L and sides of the bottom plate 60, which are viewed from top, may also be taken as the left end point 30P and the right end point 30Q. Specifically, sides of the sole 14 and the sides of the bottom plate 60, which are viewed from top, are substantially identical (may also be said to be identical) with each other. When defining the first straight line 30L, the left end point 30P and the right end point 30Q, the bottom plate 60 may also be taken in place of the sole 14. A contour of the bottom plate 60 in FIG. 6 may also be taken as a contour of the sole 14.

The left ball girth indication line 30a and the right ball girth indication line 30b are provided on a curve (first imaginary line) 31G that connects the left end point 30P to the right end point 30Q and that is bowed (may also bulged) to the front side (the toe-side) as viewed from the top of the cover 12 and assumes the shape of a substantially circular arc (may also assume a substantially elliptic arc). The curve 31G assumes the shape of a substantially circular arc as viewed from the top of the first wearable element 5. When viewed from the top of the first wearable element 5, the curve 31G coincides with (may substantially coincide with) a curve (a first imaginary line or an imaginary line) 31L (the curve 31L lies in the same plane where the first straight line 30L and the center line 34L are situated). The curve 31L is a substantially-circular-arc-shaped curve (may also assume the shape of a circular arc, an elliptic arc, or a substantially elliptic arc) that connects the left end point 30P to the right end point 30Q and that is bowed (may also bulged) to the front side (the toe-side). Specifically, the curve 31L is a curve viewed from top. The curve connects two contact points (corresponding to the left end point 30P and the right end point 30Q) formed between the first straight line 30L and the contour of the sole 14 in a plan view, and is bowed to the toe-side. In short, when viewed from top, the curve 31G assumes the shape of a substantially circular arc. However, in reality, the curve 31G is curved on and along the surface of the instep 16. When viewed from the top of the cover 12, the left ball girth indication line 30a and the right ball girth indication line 30b assume the shape of a substantially circular arc. When viewed from the top of the cover 12, the right ball girth indication line 30b lies in a continuation of the substantially-circular-arc left ball girth indication line 30a. Incidentally, the front end 34-1 of the sole 14 is situated at a position corresponding substantially to the second toe of the foot, and the rear end 34-2 is situated at a position corresponding to the rear end of the heel.

In a second worn state (which will be described later), the left ball girth indication line 30a is situated at a position corresponding to a left belt-like portion 106, and the right ball girth indication line 30b is situated at a position corresponding to a right belt-like portion 108. An angle of tangent of the left ball girth indication line 30a at a lower end of the left ball girth indication line 30a to an upper surface of the bottom plate 60 is angle 1312. An angle of tangent of the right ball girth indication line 30b at a lower end of the right ball girth indication line 30b to an upper surface of the bottom plate 60 is angle β22. The angles β12 and β22 will be described later.

The ball girth indication line 30 has the left ball girth indication line 30a and the right ball girth indication line 30b. The ball girth indication line 30 may also be formed along the curve 31G continually from the left end point 30P to the right end point 30Q. In this case, the ball girth indication line 30 is hidden behind a scale mark indicator 40 in an area where the scale mark indicator 40 is provided.

The instep girth indication line (instep girth indicator) 32 has a left instep girth indication line 32a originating from the left end of the instep 16 and a right instep girth indication line 32b originating from the right end of the instep 16. A left end point 32P which is the left end of the left instep girth indication line 32a, and a right end point 32Q which is the right end of the right instep girth indication line 32b, are determined as below.

A contact point between a second straight line (a second imaginary line) 32L inclined relative to the center line 34L of the sole 14 and the left side of the sole 14 is a left end point 32P. A contact point between the second straight line 32L and the right side of the sole 14 is a right end point 32Q. In the second straight line 32L, a distance from an intersection point 32-1 between the second straight line 32L and the center line 34L to the rear end 34-2 is length H3. A distance from the front end 34-1 of the center line 34L to the rear end 34-2 is length H1. A ratio of length H3 to length H1 (i.e., an instep girth ratio) ranges from 51.0 to 61.0% (preferably 56.0%). In relation to an inclination angle (an instep girth angle) of the second straight line 32L relative to the center line 34L, a toe-side direction of the center line 34L forms angle α12 with a foot-inside direction of the second straight line 32L. For men, the angle α12 ranges from 75.5 to 85.5 degrees (preferably 80.5 degree). For women, the angle α12 ranges from 74.5 to 84.5 degrees (preferably 79.5 degree). In a word, the first wearable element 5 includes men's wearable element and women's wearable element.

The contact points between the second straight line 32L and the side of the sole 14 are taken as the left end point 32P and the right end point 32Q. Alternatively the contact point between the second straight line 32L and the side of the bottom plate 60 may be taken as the left end point 32P and the right end point 32Q. Specifically, the center line 34L may be a connection between the front end of the bottom plate 60 (a toe-side edge (preferably a position corresponding to the second toe) and the rear end (the heel-side edge) (in this case, the front end of the center line 34L acts as the front-end position of the bottom plate 60, and the rear end of the center line 34L acts as the rear-end position of the bottom plate 60). The contact points between the second straight line 32L and sides of the bottom plate 60 may also be taken as the left end point 32P and the right end point 32Q. Specifically, the sides of the sole 14 and the sides of the bottom plate 60, which are viewed from top, are substantially identical (may also be said to be identical) with each other. When defining the second straight line 32L, the left end point 32P and the right end point 32Q, the bottom plate 60 may also be taken in place of the sole 14. The contour of the bottom plate 60 in FIG. 6 may also be taken as the contour of the sole 14.

The left ball girth indication line 32a and the right ball girth indication line 32b are provided on a curve (second imaginary line) 33G that connects the left end point 32P to the right end point 32Q and that is bowed (may also bulged) to the front side (the toe-side) as viewed from the top of the cover 12 and that assumes the shape of a substantially circular arc (may also assume a substantially elliptic arc). The curve 33G assumes the shape of a substantially circular arc as viewed from the top of the first wearable element 5. When viewed from the top of the first wearable element 5, the curve 33G coincides with (or may substantially coincide with) a curve (a second imaginary line or an imaginary line) 33L (the curve 33L lies in the same plane where the second straight line 32L and the center line 34L are situated). The curve 33L is a substantially-circular-arc-shaped curve (may also assume the shape of a circular arc, an elliptic arc, or a substantially elliptic arc) that connects the left end point 32P to the right end point 32Q and that is bowed (may also bulged) to the front side (the toe-side). Specifically, the curve 33L is a curve viewed from top. The curve connects two contact points (corresponding to the left end point 32P and the right end point 32Q) formed between the second straight line 32L and the contour of the sole 14 viewed from top, and is bowed to the toe-side. In short, when viewed from top, the curve 33G assumes the shape of a substantially circular arc. However, in reality, the curve 33G is curved, on and along the surface of the instep 16. The curve 33G is bulged toward the toe-side but swells forward to an extent to which the curve 33G does not contact the curve 31G. When viewed from the top of the cover 12, the left ball girth indication line 32a and the right ball girth indication line 32b assume the shape of a substantially circular arc. When viewed from the top of the cover 12, the right ball girth indication line 32b lies in a continuation of the substantially-circular-arc left ball girth indication line 32a.

The instep girth indication line 32 has the left instep girth indication line 32a and the right instep girth indication line 32b. The instep girth indication line 32 may also be formed along the curve 33G continually from the left end point 30P to the right end point 30Q. In this case, the instep girth indication line 32 is hidden behind a scale mark indicator 50 in an area where the scale mark indicator 50 is provided.

The center indication line (center indication portion) 34 has a center indication line (first center indication portion) 34a formed from the leading end of the cover 12 to the front end of the opening 22 and a center indication line 34b formed from the rear end of the cover 12 to the rear end of the opening 22. The center indication lines 34a and 34b are formed at positions corresponding to the center line 34L. To be more specific, the center indication lines 34a and 34b are placed on the curve 34G on the cover 12. When the cover 12 is viewed from top, the curve 34G overlaps the center line 34L. In reality, the curve 34G is a curve which extends along the surface of the cover 12. When viewed from top of the cover 12, the curve 34G assumes the shape of a straight line. The center indication line 34a is formed from the leading end of the toe 18 to the rear end of the instep 16 (the front end of the opening 22). The center indication line 34b is formed from the rear end of the heel 20 to the rear end of the opening 22.

The length H1 from the leading end 34-1 to the rear end 34-2 of the sole 14 acts as a length from the leading end to the rear end of the cover 12, as well as acting as a length from the leading end to the rear end of the first wearable element 5.

The scale mark indicator (first scale mark indicator) 40 assumes a straight belt shape (specifically, the shape of a narrowly-elongated rectangle) and is a sheet-like member with scale marks provided on its surface. The scale mark indicator is formed from a flexible but unstretchable or stretch-resistant material (may also be a nonelastic-unstretchable material or an elasticity-stretchability resistant material). Specifically, the scale mark indicator 40 exhibits flexibility so as to be fixed to the curved instep 16. Further, the scale mark indicator 40 shows a scale marks and hence preferably exhibits unstretchability. Even when the scale mark indicator 40 exhibits extremely low stretchability (stretchability has an error of, for example, 0.1 mm or thereabouts), the function of the scale mark has no special problem. Therefore, the scale mark indicator 40 can also exhibit stretch resistance. The unstretchable or stretch-resistant material provides, for instance, polyvinyl chlorides (e.g., polyvinyl chloride (PVC) and polyvinyl chloride with glass fiber).

The scale mark indicator 40 has a linear long side 40a, a linear short side 40b continually leading to one end of the long side 40a, a linear short side 40c continually leading to the other end of the long side 40a, and a linear long side 40d that continually extends from ends of the short sides 40b and 40c opposite to the long side 40a and that is formed in parallelism with the long side 40a (more specifically, the scale mark indicator 40 assumes a rectangular shape in a developed view). The left ball girth indication line 30a adjoins to the short side 40b, and the right ball girth indication line 30b adjoins to the short side 40c. More specifically, the left ball girth indication line 30a adjoins to a midpoint of the short side 40b from one end to the other end (specifically, a position equidistant from one end to the other end). The right ball girth indication line 30b adjoins to a midpoint of the short side 40c from one end to the other end (specifically, a position equidistant from one end to the other end). The ball girth indication line 30 can be said to adjoin to the widthwise center in the scale mark indicator 40. Scale marks on the scale mark indicator 40 are provided along long sides 40a and 40d, and a straight line with scale marks is formed at right angles to the long sides 40a and 40b.

Specifically, the scale mark indicator 40 is laid on the curve (the curve on the instep 16 or the imaginary line laid along the surface of the instep 16) (the second imaginary line) 31G on the instep 16. The first straight line 30L is an imaginary line that crosses the center line 34L at the intersection point 30-1.

The first ball girth ratio and the point of the first ball girth angle can comply to a state (called a first worn state) where the foot fitting in length to the height H1 of the center line 34L is kept in the first wearable element 5 and also to a second worn state (which will be described later). In the first worn state and the second worn state, the scale mark indicator 40 is provided on the curve (the first imaginary line) 31G on the instep 16. In the plan perspective view of the first wearable element 5, the curve 31G coincides with (may also substantially coincide with) the curve 31L. The length of the center line 34L from its leading end to its rear end achieved in the first worn state is identical with the length of the center line 34L from its leading end to its rear end achieved when the foot is not kept in the first wearable element 5. The length of the center line 34L from its leading end to its rear end achieved in the first worn state corresponds to the length of the first imaginary center line that is a straight line from the toe-side end to the heel-side end of the first wearable element 5 in the first worn state.

Wearing the first wearable element 5 over the foot having a foot length corresponding to the length H1 means a case where the foot length of the foot is identical with or analogous to the length H1. If the length H1 adapts to a plurality of foot lengths, the above meaning signifies a case where the first wearable element 5 most analogous to the foot length of the foot is worn over the foot. For example, given that the length H1 is set in 5 mm increments and that the first wearable element 5 has a length H1 of 250 mm, the feet whose lengths range from 247.5 mm to 252.5 mm can be said to wear the first wearable element 5.

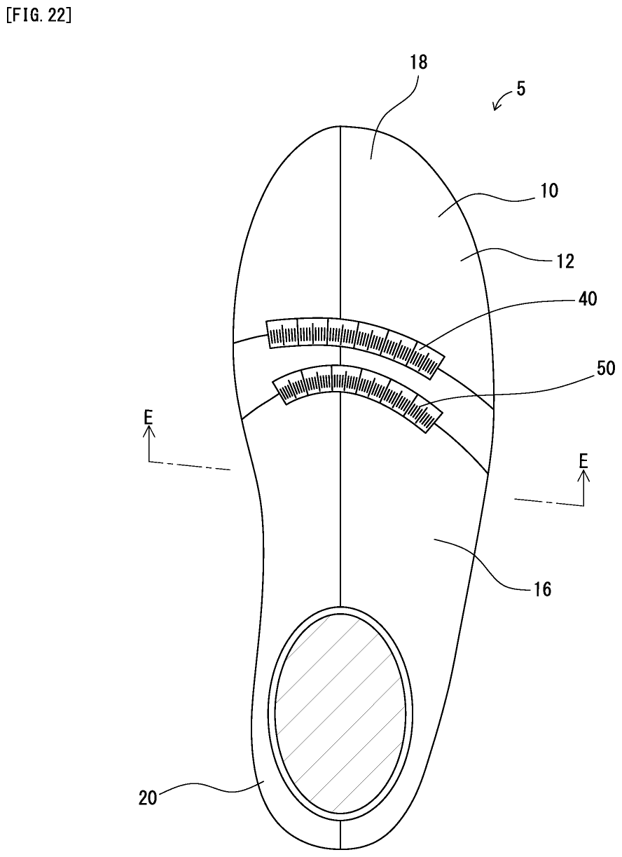

As above, the scale mark indicator 40 is situated at a position on the exterior of the cover 12 where the scale mark indicator 40 corresponds to the foot ball girth on the instep side when the foot is kept in the first wearable element 5. The scale mark indicator 40 itself assumes the shape of a narrowly elongated rectangular shape. However, when viewed from top, the scale mark indicator 40 is bowed toward the toe while being secured to the cover 12 (see FIGS. 1 and 22).

The scale mark indicator (second scale mark indicator) 50 assumes a straight belt-like shape (specifically, the shape of a narrowly-elongated rectangle and is) and is a sheet-like member with scale marks provided on its surface. As in the case with the scale mark indicator 40, the scale mark indicator 50 is formed from a flexible and unstretchable or stretch-resistant material (may also be a nonelastic-unstretchable material or an elasticity-stretchability resistant material). The unstretchable or stretch-resistant material provides, for instance, polyvinyl chlorides (e.g., polyvinyl chloride (PVC) and glass fiber polyvinyl chloride).

The scale mark indicator 50 has a linear long side 50a, a linear short side 50b continually leading to one end of the long side 50a, a linear short side 50c continually leading to the other end of the long side 50a, and a linear long side 50d that continually extends from ends of the short sides 50b and 50c opposite to the long side 50c and that is formed in parallelism with the long side 50a (more specifically, the scale mark indicator 50 assumes a rectangular shape in a developed view). The left instep girth indication line 32a adjoins to the short side 50b, and the right instep girth indication line 32b adjoins to the short side 50c. More specifically, the left instep girth indication line 32a adjoins to a midpoint of the short side 50b from one end to the other end (specifically, a position equidistant from one end to the other end). The right instep girth indication line 32b adjoins to a midpoint of the short side 50c from one end to the other end (specifically, a position equidistant from one end to the other end). The instep girth indication line 32 can be said to adjoin to the widthwise center in the scale mark indicator 50. Scale marks on the scale mark indicator 50 are provided along long sides 50a and 50d, and a straight line with scale marks is formed at right angles to the long sides 50a and 50b.

Specifically, the scale mark indicator 50 is laid on the curve (the curve on the instep 16 or the imaginary line laid along the surface of the instep 16) (the second imaginary line) 33G on the instep 16. The second straight line 32L is an imaginary line that crosses the center line 34L at the intersection point 32-1.

The first instep girth ratio and the point of the first instep girth instep angle can comply to the first worn state and the second worn state. In the first worn state, the scale mark indicator 50 is provided on the curve (the second imaginary line) 33G on the instep 16. In the plan perspective view of the first wearable element 5, the curve 33G coincides with (may also substantially coincide with) the curve 33L.

As above, the scale mark indicator 50 is situated at a position on the exterior of the cover 12 where the scale mark indicator 50 corresponds to the foot instep girth on the instep side when the foot is kept in the first wearable element 5. The scale mark indicator 50 itself assumes the shape of a narrowly elongated rectangular shape. However, when viewed from top, the scale mark indicator 50 is bowed toward the toe while being secured to the cover 12 (see FIGS. 1 and 22).

The scale mark indicators 40 and 50 are secured to the surface of the instep 16 in the cover 12 by applying an adhesive to or sewing on the cover 12. On the occasion of sewing, it is preferable to sew circumferentially hems of the scale mark indicators 40 and 50.

The scale mark indicators 40 and 50 are formed from an unstretchable or stretch-resistant material. A material can fulfil the function of a scale mark as long as the material exhibits unstretchability or stretch resistance in at least the direction where the scale mark is arranged (i.e., the direction of the long sides 40a, 40d, 50a, and 50d). Hence, any material can be used so long as it exhibits unstretchability or stretch resistance in at least the direction where the scale mark is arranged. Incidentally, if the scale mark indicators 40 and 50 are formed from a material that stretches in only one direction (e.g., a longitudinal direction), the other direction (e.g., a lateral direction) of the material is oriented in the longitudinal direction of the scale mark indicators 40 and 50.

The bottom plate 60 assumes a shape of a flat plate and a substantially-foot-like shape (may also foot-shape). The bottom plate 60 is formed from a material having not flexibility (i.e., an inflexible material, or may also be a material exhibiting a low degree of flexibility) as well as from a material having not stretchability (i.e., an unstretchable material, or may also be a stretch-resistant material). For instance, an inflexible, unstretchable material provides rigid plastic, and a less-flexible, stretch-resistant material provides a hard felt. In normal times, when a material exhibits inflexibility and low flexibility, the material can be said to be unstretchable or stretch-resistant, and hence inflexibility or low flexibility would suffice. To be more specific, in order to ensure space below the arch when the foot is kept in the first wearable element 5, all that is required of the bottom plate 60 is to exhibit inflexibility or exhibit low flexibility to such an extent that the bottom plate 60 does not become deformed along the shape of the bottom of the foot when the foot is kept in the first wearable element 5. In a word, where the bottom plate 60 exhibits flexibility to such an extent that the bottom plate 60 becomes deformed along the shape of the bottom of the foot when the foot is kept in the first wearable element 5, space is not left below the arch. Hence, such flexibility is not appropriate. Since the bottom plate 60 assumes the shape of a flat plate, the thickness of the bottom plate 60 is uniform (may also be substantially uniform).

The length of the bottom plate 60 from its leading end to rear end comes in a variety of types according to a foot length. For example, the foot length is set in 5 mm increments. A substantially-foot-shaped geometry of the bottom plate 60 is created by use of a CAD to be employed in creating the shoe last (shoe last made of plastic) used when making shoes and can be said to be equivalent to a contour achieved when the shoe last corresponding to the shoe length is viewed in plan. Since the bottom plate 60 assumes the shape of a flat plate, the upper surface and lower surface of the bottom plate 60 also assume the shape of a flat surface. The upper and lower surfaces are parallel to each other.

The bottom plate 60 is secured to a lower surface of the sole 14 of the cover 12. Specifically, the bottom plate 60 is bonded to the lower surface of the sole 14 with an adhesive (see FIG. 24(a)). When the bottom plate 60 is secured to the sole 14 with the adhesive, at least the circumference of the bottom plate 60 is bonded to the sole 14. However, it is preferable to bond the entirety of the bottom plate 60 to the sole 14. Moreover, the bottom plate 60 and the sole 14 can also be secured together by sewing. In this case, the bottom plate 60 is secured to the sole 14 by circumferentially sewing at least the circumference of the bottom plate 60. In short, the bottom plate 60 is to be secured to the cover 12 at least along the circumference of the bottom plate 60. As a result of the bottom plate 60 being provided, space is ensured at a position between the sole 14 bonded to the bottom plate 60 and the foot arch when the foot having an arch is kept in the first wearable element 5. In a word, space is left below the foot arch by means of the bottom plate 60. The minimum thickness of the bottom plate 60 is preferable. The bottom plate 60 is preferably thick to such an extent that it which would not be deformed when the foot is kept in the first wearable element 5.

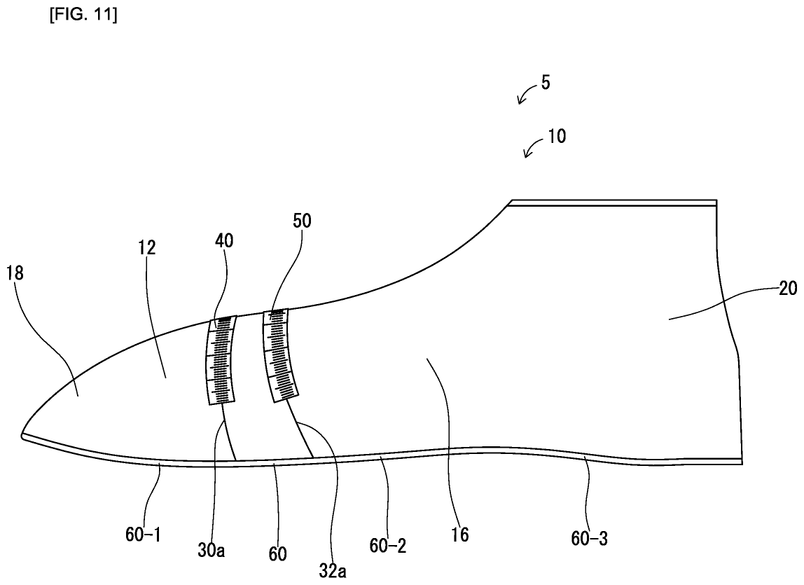

Although the bottom plate 60 assumes the shape of a flat plate, the upper and lower surfaces of the bottom plate 60 may also assume a curved shape in accordance with a surface geometry (i.e., a curved surface shape) of an inner bottom surface of the shoe to be manufactured or a surface geometry (i.e., a curved surface shape) of the bottom surface of a shoe last used when making shoed. The bottom plate 60 assumes the shape of a plate whose upper and lower surface assume the curved surface shape (i.e., a plate whose curved surfaces adapt to a curved surface shape). Even when the bottom plate 60 assumes the shape of a plate having a curved surface shape, the thickness of the bottom plate 60 is made uniform (may also be substantially uniform). An example of such a bottom plate 60 is provided in FIG. 11. The bottom plate 60 shown in FIG. 11 is formed from a uniform thickness (may also be a substantially uniform thickness). The bottom plate 60 has a first configuration 60-1 that is sloped downwards with increasing distance from the toe-side to the heel side; a second configuration 60-2 that continually extends from the heel side of the first configuration 60-1 and that is sloped upwards with increasing distance from the toe-side to the heel side; and a third configuration 60-3 that continually extends from the heel side of the second configuration 60-2 and that is sloped downwards with increasing distance from the toe-side to the heel side. The first configuration 60-1 is a plate that is sloped downwards with increasing distance from the toe-side to the heel side. The second configuration 60-2 is a plate that is sloped upwards with increasing distance from the toe-side to the heel side. The third configuration 60-3 is a plate that is sloped downwards with increasing distance from the toe-side to the heel side. In the configuration shown in FIG. 11, a position on the sole-of-foot side of the ball girth and a position on the sole-of-foot side of the instep girth exist in an area of the second configuration 60-2. In the plan perspective view of the first wearable element 5, the first straight line 30L and the second straight line 32L can be said to exist in the area of the second configuration 60-2. More specifically, in the second worn state, a bottom belt-like portion 104 and a bottom belt-like portion 124 are situated below the area of the second configuration 60-2. The ball girth and the instep girth can be accurately measured according to a shoe to be manufactured as a result of the bottom plate 60 being formed into such a curved surface shape.

Although the bottom plate 60 is secured to the lower surface of the sole 14, the bottom plate 60 can also be placed inside the cover 12 and fixed to the upper surface of the sole 14 by means of bonding, sewing, or others. For instance, the bottom plate 60 is bonded to the upper surface of the sole 14 with an adhesive. When the bottom plate 60 is secured to the sole 14 with an adhesive, at least the circumference of the bottom plate 60 is bonded to the sole 14. However, it is preferable to secure the entirety of the bottom plate 60 adhesively to the sole 14. The bottom plate 60 and the sole 14 can also be fixed by sewing. However, in this case, the bottom plate 60 is secured to the sole 14 by circumferentially sewing at least the circumference of the bottom plate 60. In short, the bottom plate 60 is to be secured to the cover 12 at least along the circumference of the bottom plate 60. As mentioned above, even when the bottom plate 60 is provided inside the cover 12, space is left between the sole 14 bonded to the bottom plate 60 and the foot arch as a result of placement of the bottom plate 60.

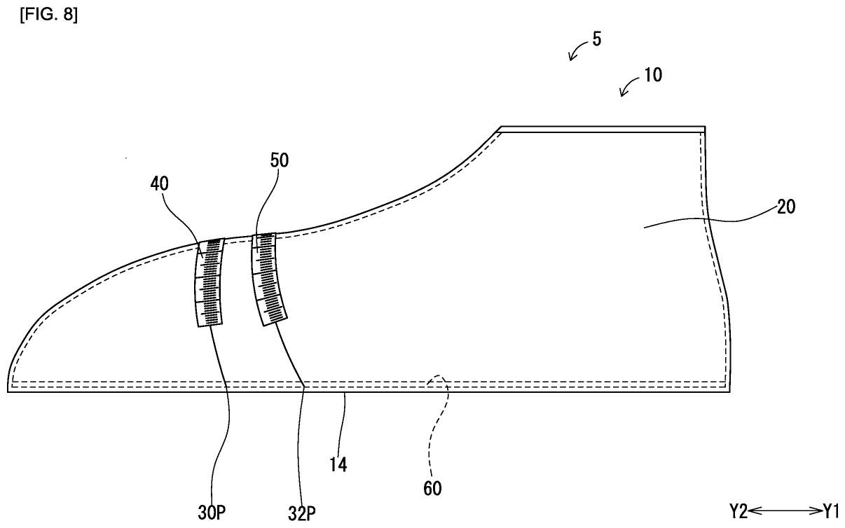

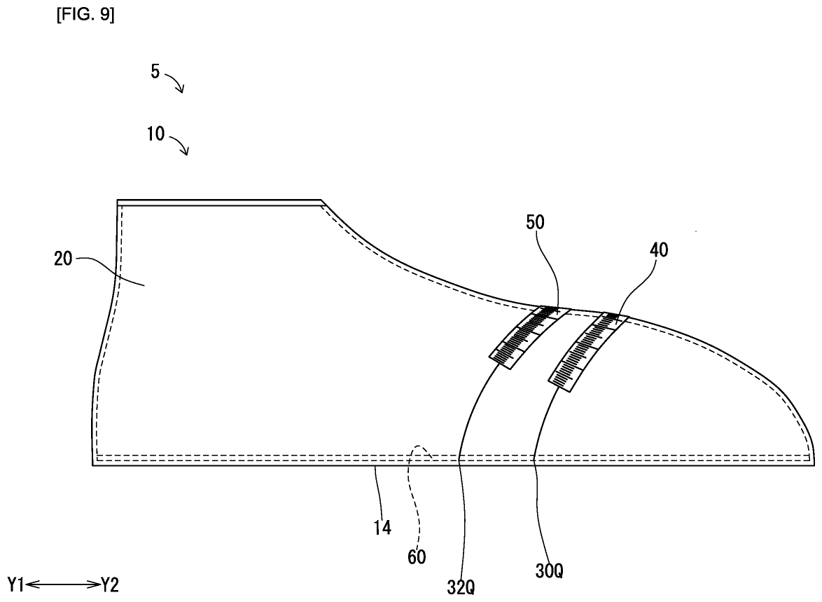

An example of the configuration where the bottom plate 60 is provided inside the cover 12 is shown in FIGS. 8 and 9, and the bottom plate 60 is secured to the upper surface of the sole 14. The left end point 30P at the lower end of the ball girth indication line 30a, the right end point 30Q at the lower end of the ball girth indication line 30b, the left end point 32P at the lower end of the instep girth indication line 32a, and the right end point 32Q at the lower end of the instep girth indication line 32b exist in the positions elevated above the bottom surface of the sole 14 by the height corresponding to the thickness of the bottom plate 60. Specifically, the left end points 30P and 32P and the right end points 30Q and 32Q are placed in positions appropriate to the case of the bottom plate 60 being provided outside the cover 12 (i.e., the situation shown in FIGS. 3 and 4). The heightwise length of the left end points 30P and 32P above the bottom surface of the sole 14 and the heightwise length of the right end points 30Q and 32Q above the bottom surface of the sole 14 are equal to the thickness of the bottom plate 60. Incidentally, as in the case of the bottom plate 60 being provided outside the cover 12, the left end point 30P and the right end point 30Q are points where the first straight line 30L is tangent to the contour of the cover 12 in plan view (the contour may also be the contour of the bottom plate 60) located at heights of the left end point and the right end point. The left end point 32P and the right end point 32Q are points where the contour of the cover 12 (the contour may also be the contour of the bottom plate 60) is tangent to the second straight 32L.

The left end points 30P and 32P and the right end points 30Q and 32Q are in positions that are elevated above the bottom surface of the sole 14 by the height equivalent to the thickness of the bottom plate 60. In the heightwise direction, the left end points 30P and 32P and the right end points 30Q and 32Q may also be situations on the bottom surface of the sole 14.

The first wearable element 5 is provided in different types according to the length in the direction of foot length (i.e., a length H1 from the leading end to rear end of the cover 12) and in; for instance, 5 mm increments. In a word, the first wearable element 5 is provided in different types according to the foot length and; for instance, 5 mm increments.

The first wearable element 5 shown in FIGS. 1 through 7 is for the right foot. A left-foot first wearable element is structurally analogous to the first wearable element 5 shown in FIGS. 1 through 7 except that the left-foot first wearable element is symmetric (in a word, longitudinal direction (symmetric via the central plane in Y1-Y2 direction)) with respect to the first wearable element 5 shown in FIGS. 1 through 7.

In the above description, the cover 12 assumes the shape of a bag and also has the sole 14, the instep 16, the toe 18, and the heel 20. However, the sole 14 can also be omitted, and the lower end of the instep 16, the toe 18, and the lower end of the heel 20 might be secured to and along the circumference (which may also be an edge) of the bottom plate 60.

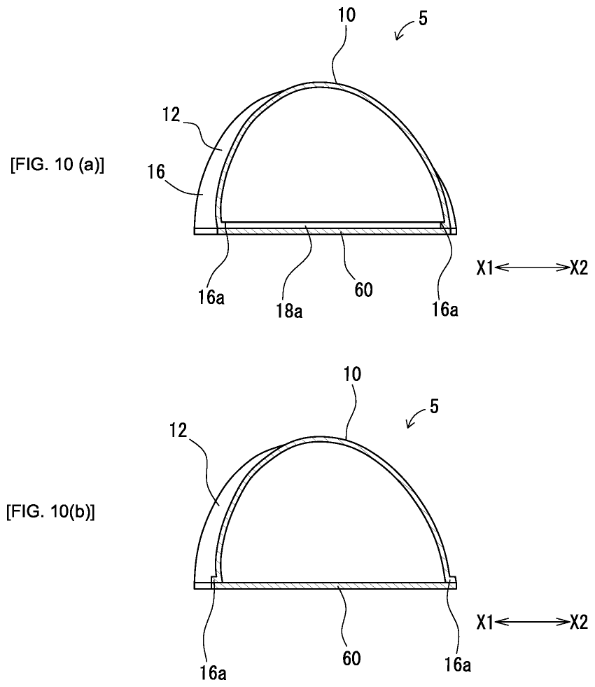

In this case, a means of securing the cover 12 to the bottom plate 60 is to fold the lower end of the cover 12 (i.e., the lower end of the instep 16, the toe 18, and the heel 20) inside and fix an inner fold-over end to the bottom plate 60 by bonding or sewing. A cross section achieved under the method is shown in FIG. 10(a). In FIG. 10(a), a fold-over portion 16a in the lower end area of the instep 16 and a fold-over portion 18a in the lower end area of the toe 18 are secured to the bottom plate 60 while being internally folded.

In the description, the lower end of the cover 12 is folded inside and secured to the bottom plate 60. However, the lower end of the cover 12 can also be folded outside and secured to the bottom plate 60. In more detail, the lower end of the cover 12 (i.e., the lower end of the instep 16, the toe 18, and the heel 20) is folded outside, and an outer fold-over portion is secured to the bottom plate 60 by bonding or sewing. A cross section achieved under the method is shown in FIG. 10(b). In FIG. 10(b), a fold-over portion 16a in the lower end area of the instep 16 is secured to the bottom plate 60 while being folded outside.

Where the configuration of the sole 14 is omitted, the first straight line 30L, the left end point 30P, and the right end point 30Q are determined, as mentioned above, with reference to the bottom plate 60 in lieu of the sole 14. The contour of the sole 14 in FIG. 6 is handled as the contour of the bottom plate 60. Likewise, the second straight line 32, the left end point 32P, and the right end point 32Q are determined with reference to the bottom plate 60 in place of the sole 14. The contour of the sole 14 in FIG. 6 is handled as the contour of the bottom plate 60.

The instep 16, the toe 18, and the heel 20 are disposed in the area of the cover 12 except the sole 14. However, they are not limited to the area. The toe 18 may be omitted, or a lower portion of the heel 20 may be omitted (in short, hatched areas in FIGS. 3 and 4 may also be omitted). Since the ball girth and the instep are subjected to measurement, the minimum requirement is to place the cover 12 in the area where the ball girth and the instep are situated. A shoe opening is necessary to let the foot easily slip into a second wearable element 70 while wearing the first wearable element 5 as well as to prevent the foot from moving much back and forth with respect to the first wearable element 5. As a result, the minimum requirement for the cover 12 is to have at least the instep 16, the opening 22 acting as the shoe opening, and an area around the opening 22 in the upper portion of the heel 20 (upper portion located above the lower portion of the heel 20). In a word, all that is required of the cover 12 is to be shaped to cover at least instep and have a shoe opening above for letting the foot in. Where the toe 18 and the lower portion of the heel 20 are omitted, the lower end of the instep 16 is to lead continually to the heel 14. Even if the toe 18 and the portion of the heel 20 are omitted and if the foot moves back and forth with respect to the first wearable element 5, the foot is fixed in the back-front direction while being kept in the second wearable element 70, posing no obstacle to shoe fitting.

Where the toe 18 and the lower portion of the heel 20 are omitted, an area of the sole 14 in front of the tip of the instep 14 and another area of the sole 14 behind the rear end of the instep 14 can also be omitted. As in the case of the sole 14 being omitted, the first straight line 30L, the left end point 30P, and the right end point 30Q are determined with reference to the bottom plate 60 in lieu of the sole 14. The second straight line 32L, the left end point 32P, and the right end point 32Q are determined with reference to the bottom plate 60 in place of the sole 14.

When the toe 18 and the lower portion of the heel 20 and the configuration of the sole 14 are omitted, the lower end of the instep 16 is secured to the bottom plate 60. In this case, since the sole 14 is omitted, the first straight line 30L, the left end point 30P, and the right end point 30Q are determined with reference to the bottom plate 60 in lieu of the sole 14. The second straight line 32L, the left end point 32P, and the right end point 32Q are determined with reference to the bottom plate 60 in lieu of the sole 14.

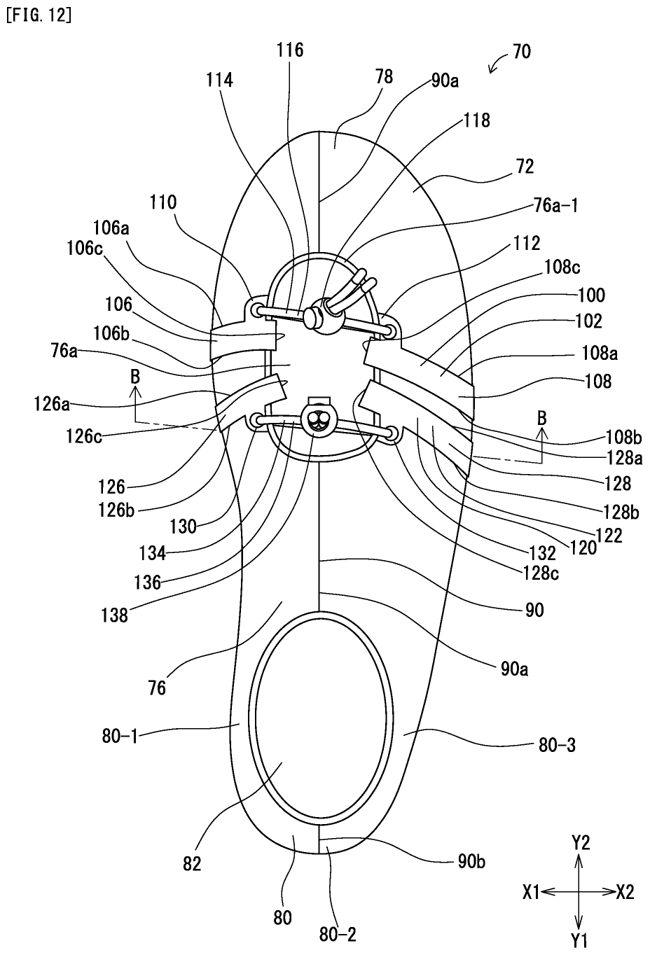

As illustrated in FIGS. 12 through 21, the second wearable element 70 is made up of a cover (which may also be a foot cover or bag-shaped portion) 72, a ball girth measurement portion 100 and an instep girth measurement portion 120 which are provided in the cover 72, a fastening portion 114 disposed at the cover 72 and the ball girth measurement portion 100, and a fastening portion 134 disposed at the cover 72 and the instep girth measurement portion 120.

The cover 72 assumes the shape of a bag into which a foot slips (may also take the shape of a bag that covers foot) (to be exact, a bag-shaped thing into which the foot with the first wearable element 5 outside is slipped) (may also take the shape of socks or hoses). The cover 72 has a sole 74, an instep 76 which continually extends from the sole 74, a toe 78 which continually extends from the sole 74 and the instep 76, and a heel 80 which continually extends from the sole 74 and the instep 76. The cover 72 as a whole is integrally formed from an elastic and flexible material.

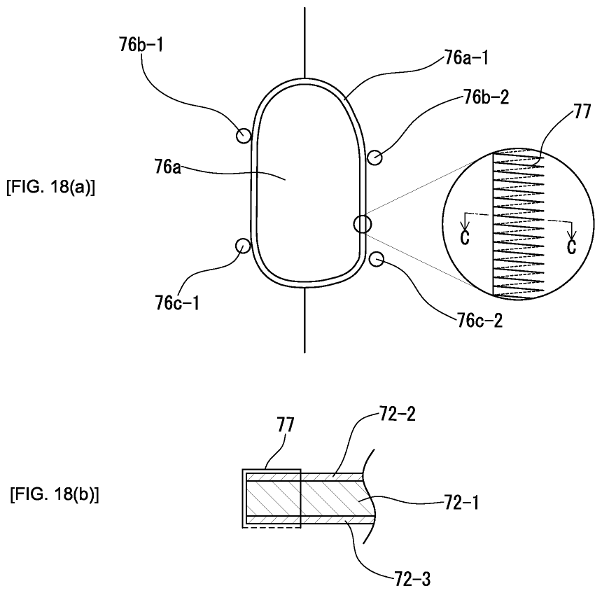

As in the case of the cover 12, the elastic, flexible material forming the cover 72 is made of rubber, such as natural rubber and synthetic rubbers (for example, silicon rubber and chloroprene rubber), or a fabric material (a cloth (texture)) (e.g., a fabric material (a cloth (texture)) used for hoses), such as polyester, polyurethane, acryl, wool, and cotton. As to the fabric material used for hoses, fabric type is primarily knitting (especially a round braid) in terms of the type of the cloth. As in the case of hoses, the cover is formed by combination of a plurality of materials; for instance, acrylic cotton blend, polyester cotton blend, and acrylic wool blend. A specific example of a material for the cover 72 is a three-layer, sheet-shaped member (see FIG. 18) in which pieces of cloth 72-2 and 72-3 are fixed, one on each side, to a rubber sheet 72-1 with an adhesive. The rubber sheet 72-1 is made of; for instance, chloroprene rubber. The pieces of cloth 72-2 and 72-3 are made of; for example, a polyethylene or nylon cloth. As the stretching and contracting direction of fabric material, since the foot kept in the first wearable element 5 wears the cover 72, the fabric material can preferably stretch and contract in both vertical and horizontal directions, as a result, in 360-degree all directions. Alternatively, another material that stretches in only a lateral direction (i.e., X1-X2 direction in FIG. 12) may also be applicable (all that is required of the cover 72 is to exhibit stretch and contraction in directions orthogonal to the foot length direction of the second wearable element 70 from its toe-side end to heel-side end). In this case, since the foot kept in the first wearable element 5 slips into the second wearable element 70, the cover 72 must be slightly longer than the first element wearable 5 with respect to the direction of the foot length.

Where the cover 72 exhibits shape retention as in the case of a rubber cover, it assumes a shape, such as that shown in FIGS. 12 through 15, even when the second wearable element 7 is placed simply. However, when being made of a fabric material, the cover 72 does not exhibit shape retention. Hence, when the second wearable element 72 is placed simply, the fabric material of the cover 72 is folded into a lap, whereupon the cover 72 becomes to be flatly folded. FIGS. 12 through 15 show that the cover 72 is kept in shape without stretching. Specifically, FIGS. 12 through 15 show the case where the cover 72 does not stretch with the mold remaining inserted in the cover 72 and where the cover 72 retains its original shape without the fabric material of the cover 72 being folded into a lap. As the thick of the cover 12, the material constituting the cover 72 is as thick as the ordinary cloth used for hoses (for example, about a thickness of 1 through 3 mm) in the case of the fabric material, the cover is made of a material having a thickness of about 1 through 3 mm in the case of rubber. In both cases, the thinnest possible material is desirable to reduce measurement errors because a ball girth and an instep girth of a foot are subjected to measurement.

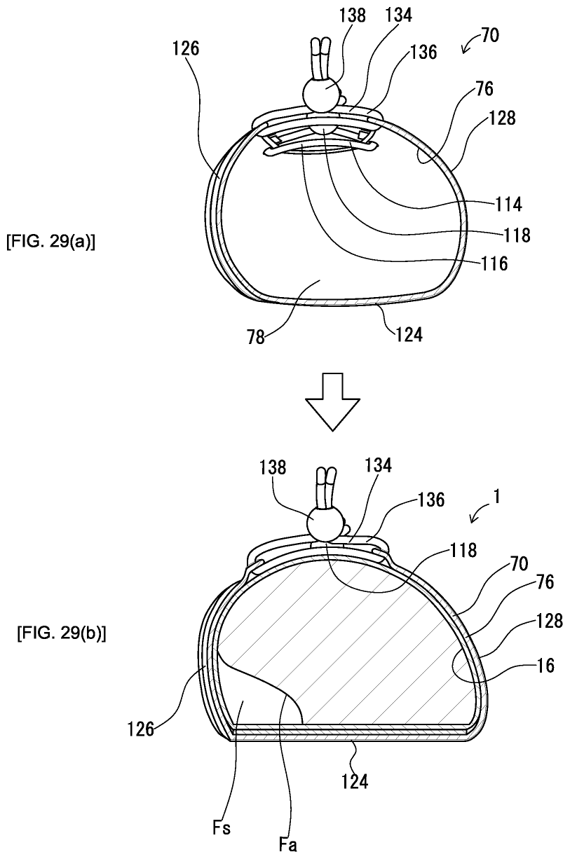

Below is a description of the cover 72 that is provided, particularly with a shape retained, by reference to FIGS. 12 through 21. The sole (a sole for use in the second cover) 74 makes up a bottom of the cover 72, and assumes a substantially-foot-like shape (may also be said as a foot shape) when viewed from the bottom. Incidentally, unlike the sole 14 of the first wearable element 5, the sole 74 is not fixed to the bottom plate 60 and hence does not assume the shape of a flat plate. As shown in FIG. 29(a), an area around the center of the sole 74 assumes the shape of a substantially flat plate in the lateral direction (direction X1-X2). However, in edge areas on both sides of the sole 74, the sole 74 is gently sloped upward with increasing proximity to the outside. In short, the sole 74 includes the areas sloped on both sides thereof. When the foot wearing the first wearable element 5 is kept in the second wearable element 70, the lower area of the bottom plate 60 can be said to contact the sole 74. The sole 74 can also be formed in the shape of a flat plate with the cover 72 retaining the shape.

The instep (second instep) 76 assumes a substantially-arched shape that continually extends from a left edge (on X1 side) of the sole 74 and also from a right edge (on X2 side) of the sole 74 and that entirely assumes a bulge at its substantial center with respect to the left and right directions. A transverse cross-sectional shape of the arch assumes the shape of a substantially inverted U, and the transverse cross-sectional shape becomes higher with increasing distance from the left edge to the top of the instep 76. An angle of inclination from the left-right direction (the direction of the sole 14) becomes smaller with increasing distance from the left edge to the top. Likewise, the transverse cross-sectional shape becomes higher with increasing distance from the right end to the top, and the angle of inclination from the horizontal direction becomes smaller with increasing distance from the right end to the top. Further, the top of the instep 76 becomes horizontally, gradually higher from the leading edge of the cover 72 to the front end of the opening 76a with increasing distance from the leading edge to rear edge of the instep 76 (i.e., a slope becomes gradually higher in the horizontal direction), and the angle of inclination becomes greater from the rear edge of the opening 76a to the opening 82. In a word, when viewed in side elevation, the angle of tangent of a curve formed by the top of the instep 76 with respect to the horizontal direction becomes gradually smaller with increasing distance from the leading edge of the cover 72 to the front end of the opening 76a. However, the angle becomes greater toward the rear edge from the rear edge of the opening 76a to the opening 82. The instep 76 is an area situated on the instep side of the foot when the foot is kept in the second wearable element 70 (including where the foot wearing the first wearable element 5 is kept in the second wearable element 70).

The opening 76a is provided in the instep 76. The opening 76a is formed in a substantially-oblong shape (which can also be formed in a substantially-rectangular shape) that is narrowly extended in a front-back direction from a vicinity of the front edge of the instep 76 to a position slightly behind an intermediate position of the instep 76. In a horizontal direction, the opening 76a is provided in a position corresponding to the top of the instep 76. Specifically, in a plan view, the opening 76a is provided at a position where an essentially identical width exists on each side of an extension of a center indication line 90a. When the second wearable element 70 is worn over the foot wearing the first wearable element 5, the scale mark indicators 40 and 50 are uncovered through the opening 76a to enable reading of a scale mark. The opening 76a is placed at a position where at least part of the scale mark indicators 40 and at least part of the scale mark indicators 50 become uncovered when the foot wearing the first wearable element 5 wears the second wearable element 70. A circumferential portion 76a-1 of the opening 76 is circumferentially formed along a side of the opening 76a. As shown in FIG. 18, the circumferential portion 76a-1 is formed by being reinforced by overcasting (e.g., whipstitching) a sewing thread 77. The sewing thread 77 constituting the circumferential portion 76a-1 is formed from a stretchable sewing thread, such as a rubber thread. The sewing thread forming the circumferential portion 76a-1 expands and contracts when the size and shape of the opening 76a changes according to the size and shape of the foot that slips into the second wearable element 70. Hence, the sewing thread 77 would not constitute a hinderance when the size and shape of the opening 76a changes. In FIGS. 12, 13, 14, and 15, the circumferential portion 76a-1 is depicted in a simplified form by parallel double lines.

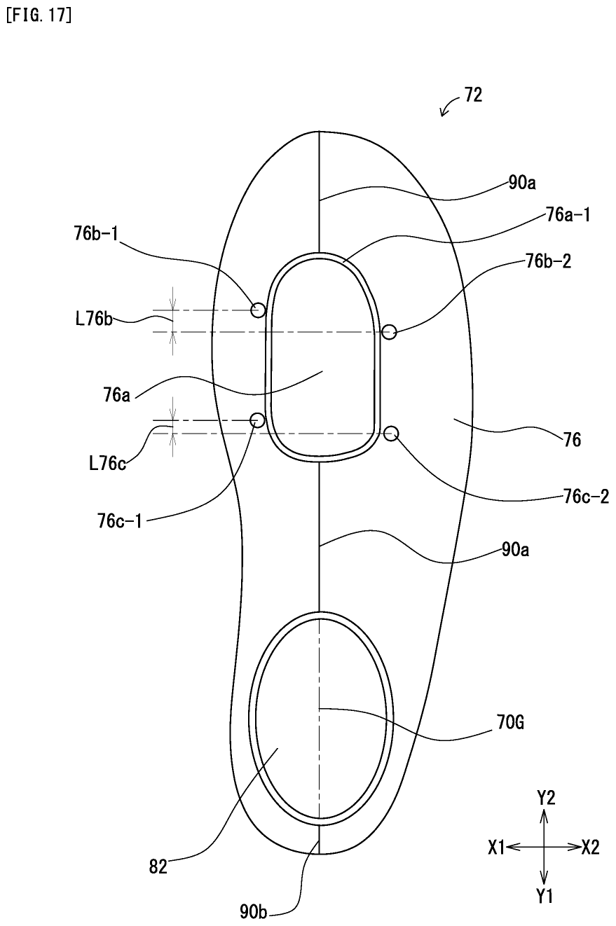

As shown in FIG. 17, the instep 76 has two holes 76b-1 and 76b-2 for letting a lace 116 (which will be described later) pass through and two holes 76c-1 and 76c-2 for letting a lace 136 (which will be described later) pass through. The holes 76b-1 and 76c-1 are provided at positions on the left side of the opening 76a and in the vicinity of the left edge of the opening 76a. The holes 76b-2 and 76c-2 are provided at positions on the left side of the opening 76a and in the vicinity of the left edge of the opening 76a. The hole 76b-1 is provided at a position on the front side of the hole 76b-2 in the front-back direction (in Y2 direction), and the hole 76c-1 is provided at a position on the front side of the hole 76c-2 in the front-back direction. The hole 76b-1 and the hole 76c-1 are placed at (or substantially) the same position with respect to the horizontal direction. The hole 76b-2 and the hole 76c-2 are placed at (substantially) the same position with respect to the horizontal direction. A length L76b between the holes 76b-1 and 76b-2 in the front-back direction is made longer than a length L76c between the holes 76c-1 and 76c-2 in the front-back direction.

A toe (second toe) 78 continually extends from the leading end of the sole 74 as well as from a leading end of the instep 76. A transverse cross-section of the toe 78 assumes a substantially-arch shape except a leading end of the toe 78. A diameter of the transverse cross-section becomes smaller with getting close to the leading end of the toe 78. The leading end of the toe 78 coincides with the leading end of the sole 74. In short, when the cover 72 is viewed sideways, a curve formed by the top of the toe 78 is sloped upward from the leading end to rear end of the toe 78. An angle of tangent of the curve with respect to the horizontal direction becomes gradually smaller with increasing distance from the leading end to rear end of the toe 78. When the foot is kept in the second wearable element 70 (including where the foot wearing the first wearable element 5 is slipped into the second wearable element 70), the toe 78 is situated at the toe of the foot.

The heel (second heel) 80 continually extends from the rear end of the sole 74 as well as from the rear end of the instep 76. A lower area of the heel 80 assumes the shape of a slight outward bulge that continually leads from the upper end of the sole 74, with respect to three directions, namely, a left side, a rear side, and a right side. In a left-side area 80-1 of the heel 80, a lower area of the heel 80 is slightly bulged outwards (in X1 direction). An upper area located above the lower area is sloped inwards (i.e., in X2 direction) with increasing elevation. In an area 80-2 on the rear side (in Y1 direction) of the heel 80, a lower area is slightly bulged to the outside (in Y1 direction). An upper area located above the lower area is sloped inwards with increasing elevation (i.e., in Y2 direction). In a right-side area 80-3 of the heel 80, a lower area is slightly bulged to the outside (in X2 direction). An upper area located above the lower area is sloped inwards (i.e., in X1 direction) with increasing elevation. When the foot is kept in the second wearable element 70 (when the foot wearing the first wearable element 5 is kept in the second wearable element 70), the heel 80 is situated on the heel side of the foot.

The opening 82 serving as a shoe opening is provided at an upper end of the heel 20. When the foot is slipped into the second wearable element 70, the foot wearing the first wearable element 5 is slipped into the opening 82. When the foot is kept in the second wearable element 70, a heightwise length of the heel 80 is made such that the opening 82 is lower than the ankle and becomes substantially identical with the height of the opening 22 of the first wearable element 5.

The cover 72 has a center indication line (center display portion) 90. The center indication line 90 is a linear (to be specific, the form of a solid line) indication line. The center indication line 90 is provided in print or handwriting. Alternatively, an indication portion can also be provided, in place of the indication line, along the position of the center indication line 90. For instance, the center indication portion can also be made with embroidery thread or by a multi-opening arrangement. In the case of the embroidery thread, stretchable thread is used. In the case of the multi-opening arrangement, circular openings, for instance, are arranged along the position of the center indication line 90.

The center indication line 90 has a center indication line (a second center indication portion) 90a formed from the leading end of the cover 72 to the front end of the opening 82, and a center indication line 90b formed from the rear end of the cover 72 to the rear end of the opening 82. The center indication lines 90a and 90b are placed at a position corresponding to the center line (a second imaginary center line) 90L. The center line 90L is an imaginary line that connects a leading end 74-1 (a toe-side end) to a rear end 74-2 (a heel-side end) of the sole 74 when the sole 74 is viewed in plan (i.e., when the cover 72 is viewed in plan). The center indication lines 90a and 90b are laid on the curve 90G on the cover 72. The curve 90G overlaps with the center line 90L when the cover 72 is viewed in plan. The curve 90G assumes the shape of a straight line when the cover 12 is viewed in plan. The center line 90L is an imaginary straight line that connects the leading end 74-1 (the toe-side end) to the rear end 74-2 (the heel-side end) of the sole 74 when the sole 74 is viewed in plan (the leading end 74-1 is preferably situated at a position corresponding to the second toe). The center indication line 90a is formed from the leading end of the toe 78 to the rear end of the heel 76 (a front end position of the opening 82), and the center indication line 90b is formed from the rear end of the heel 80 to the rear end of the opening 82.

A length H11 (a length in the direction of the foot length) from the leading end 74-1 to the rear end 74-2 of the sole 74 corresponds to a length from a leading end to rear end of the cover 72 as well as to a length from the leading end to rear end of the second wearable element 70. The center line 90L is a straight line, and a heightwise position of the center line 90L is arbitrary. For instance, in the case of the second wearable element 70 in a second worn state, the heightwise position can be considered to situate at a position on the bottom surface of the sole 76.

The ball girth measurement portion 100 is fixed to an exterior surface of the cover 72, and has a belt-like portion 102 and tabs 110 and 112 which continually extend from the belt-like portion 102. The ball girth measurement portion 100 is a sheet-shaped member, and is formed from a flexible, unstretchable or stretch-resistant material (may also be a nonelastic-unstretchable material or an elasticity-stretchability resistant material) as in the case with the scale mark indicators 40 and 50. The unstretchable or stretch-resistant material provides, for instance, polyvinyl chlorides (e.g., polyvinyl chloride (PVC) and glass fiber polyvinyl chloride). The ball girth measurement portion 100 is secured to the exterior surface of the cover 72 by bonding, sewing, or others. In the case of bonding, the belt-like portion 102 and the tabs 110 and 112 are bonded to the exterior surface of the cover 72. In the case of sewing, the ball girth measurement portion 100 is circumferentially sewed along the hem of the ball girth measurement portion 100 by a sewing thread, an area projecting from the opening 76a is sewed along a hem of the opening 76a. In the case of sewing, the tabs 110 and 112 are sewed along the hems of the tabs 110 and 112 except portions of the hems adjoining the belt-like portion 102.

The belt-like portion (a circumferential portion for ball girth or a ball girth measurement member) 102 as a whole assumes a belt-like shape (can also be narrowly elongated) (in other words, the belt-like portion 102 is formed in the shape of a belt stretched from a short side 106c (which will be described later) to a short side 108c). The belt-like portion 102 has a bottom belt-like portion 104 secured to an exterior surface of the sole 74 of the cover 72; a left belt-like portion 106 that continually extends from the left end of the bottom belt-like portion 104 and that is secured to the exterior surface of a left-side area of the instep 76; and the right belt-like portion 108 that continually extends from the right end of the bottom belt-like portion 104 and that is secured to the exterior surface of a right-side area of the sole 76. The left belt-like portion 106 is bendable against the bottom belt-like portion 104 by way of the polygonal line 102-1, while the right belt-like portion 108 is bendable against the bottom belt-like portion 104 by way of the polygonal line 102-2. The bottom belt-like portion 104, the left belt-like portion 106, and the right belt-like portion 108 each assume a belt-like shape; more specifically, a trapezoidal shape.

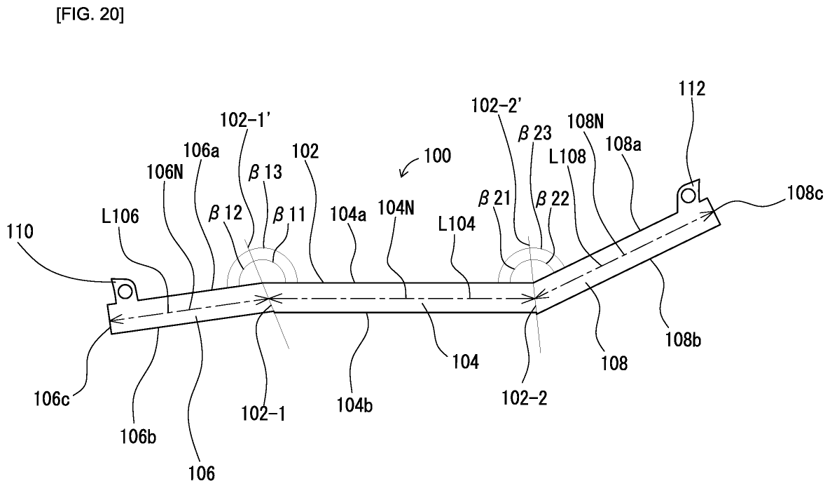

The bottom belt-like portion (a bottom configuration for ball girth) 104 assumes a belt-like shape. As shown in FIG. 20, the bottom belt-like portion 104 is formed by being enclosed by a pair of straight long sides 104a and 104b and straight polygonal lines 102-1 and 102-2. The pair of long sides 104a and 104b are parallel to each other.

The bottom belt-like portion 104 is laid on a line (an imaginary line on the sole 74 or an imaginary line laid along the surface of the sole 74) (a third imaginary line) 104G. When the foot whose length corresponds to the length H1 of the center line 34L is kept in the first wearable element 5 and when the foot wearing the first wearable element 5 is kept in the second wearable element 70 having the length H11 corresponding to the length H1 (which is taken as a second worn state), the line 104G (or may substantially) coincides with a first straight line (a third imaginary straight line) 104L in plan perspective view. The first straight line 104L is an imaginary straight line that crosses the center line 90L at an intersection point 104-1. In the plan view of the second wearable element 70 in the second worn state, the first straight line 104L passes through a position where a ratio of H12 to H11 (a second ball girth ratio) is 61.5 to 71.5% (preferably 66.5%), wherein H11 is a length of the center line 90L between the leading end 74-1 and the rear end 74-2, and H12 is a length of the center line 90L between the intersection point 104-1 which is intersection point of the first straight line 104L and the center line 90L and rear end 74-2. An angle of inclination formed between the first straight line 104L and the center line 90L; namely, angle (a second ball girth angle) an, which is formed between the toe-side direction of the center line 90L and the inner direction with respect to the foot position of the first straight line 104L (the inner direction in left-right direction), ranges from 69.0 to 79.0 (preferably 74.0) for men and from 68.0 to 78.0 (preferably 73.0) for women. In a word, the second wearable element 7 includes men's wearable element and women's wearable element. Since the sole 74 assumes the shape of a flat plate, the line 104G can be said to assume the shape of a straight line in the second worn state. The leading end 74-1 of the center line 90L is located at a position substantially corresponding to the second toe of the foot, and the rear end 74-2 is located at a position corresponding to the rear end of the heel. In the second worn state, the first straight line 104L (or may substantially) coincides with the first straight line 30L in plan perspective view. As a result, as viewed in plan perspective view in the second worn state, the line 104G (or may substantially) coincides with the first straight line 30L.

With respect to the direction of a plan view or a plan perspective view of the second wearable element 70, the sole 74 is on a bottom side, and the opening 82 is on an upper surface side. A direction of the sole of the foot corresponds to the direction of an underside.

The foot whose length adapts to the length H1 is kept in the first wearable element 5, and the second wearable element 70 whose length H11 adapts to the length H1 is worn over the first wearable element 5. This means that the foot length is equal or analogous to the lengths H1 and H11. When the lengths H1 and H11 adapting to a plurality of foot lengths are provided, the foot is kept in the first wearable element 5 whose length H1 is most analogous to the foot length and in the second wearable element 70 whose length H11 is most analogous to the foot length. For example, given that the lengths H1 and H11 are set in 5 mm increments and that the first wearable element 5 has the lengths H1 and H11 of 2500 mm, the feet whose lengths range from 247.5 mm to 252.5 mm can be said to wear the first wearable element 5.

The ratio of the length H12 to the length H11 is (may also substantially) identical with the ratio of the length H2 to the length H1 of the first wearable element 5. The angle α21 is (may also substantially) identical with the angle α11. As a result, the scale mark indicator 40 is interposed between the left belt-like portion 106 and the right belt-like portion 108. The scale mark indicator 40, the left belt-like portion 106, and the right belt-like portion 108 are oriented in substantially the same direction.

In the second worn state, the bottom belt-like portion 104 is laid in a plan view along the first straight line 104L at a position where the first straight line 104L is aligned to the center line of the bottom belt-like portion 104 (the first straight line 104L can also be laid at a position where the first straight line 104L (can also substantially) coincides with the center line 104N of the bottom belt-like portion 104). The long sides 104a and 104b are (can also be substantially) parallel to the first straight line 104L. A length between the long side 104a and the first straight line 104L is (can also be substantially) identical with a length between the long side 104b and the first straight line 104L. The first straight line 104L can also be located at another position where it is out of alignment with the center line of the bottom belt-like portion 104. However, since the bottom belt-like portion 104 is laid on a line 104G, the line 104G is situated between the long side 104a and the long side 104b in at least the plan view.

The longitudinal length of the bottom belt-like portion 104 is a length from one end (the end tangent to the first straight line 104L) of the sole 74 to the other end (the end tangent to the first straight line 104L) of the same. In the second worn state, the bottom belt-like portion 104 is situated below the first wearable element 5.

Even when the second wearable element 70 is not worn over the foot wearing the first wearable element 5 and is in its original shape, the bottom belt-like portion 104 is laid on the line (the third imaginary line) 104G on the sole 74, and, as viewed in plan perspective view, the line 104G (can also substantially) coincides with the first straight line (the third imaginary straight line) 104L. In short, when the sole 74 is in a curved shape, the line 104G assumes the shape of a curve. The line 104G does not always precisely coincide with the first straight line (third imaginary straight line) 104L in the plan perspective view but substantially coincides with the same.

The left belt-like portion (a first lateral configuration for ball girth) 106 assumes a belt-like shape. As shown in FIG. 20, the left belt-like portion 106 is formed by being enclosed by a pair of straight long sides 106a and 106b, the polygonal line 102-1, and a linear short side (a first end side) 106c. The pair of long sides 106a and 106b are formed in parallel with each other, and the short side 106c is formed, at right angles (which may also be substantially right angles), from the long sides 106a and 106b.

In a developed state of the belt-like portion 102, angle θ11 formed between the long side 104a and a toe-side extension 102-1′ of the polygonal line 102-1 ranges from 109 to 115 degrees (preferably 112 degrees). Angle β12 formed between the long side 106a and the toe-side extension 102-1′ of the polygonal line 102-1 ranges from 73 to 79 degrees (preferably 76 degrees). As a result, in a developed state of the belt-like portion 102, angle (toe-side angle) β13 formed between the long side 104a and the long side 106a ranges from 185 to 191 degrees (preferably 188 degrees). To be more specific, in the developed state of the belt-like portion 102, the toe-side angle formed between the longitudinal direction of the bottom belt-like portion 104 and the longitudinal direction of the left belt-like portion 106 ranges from 185 to 191 degrees (preferably 188 degrees).

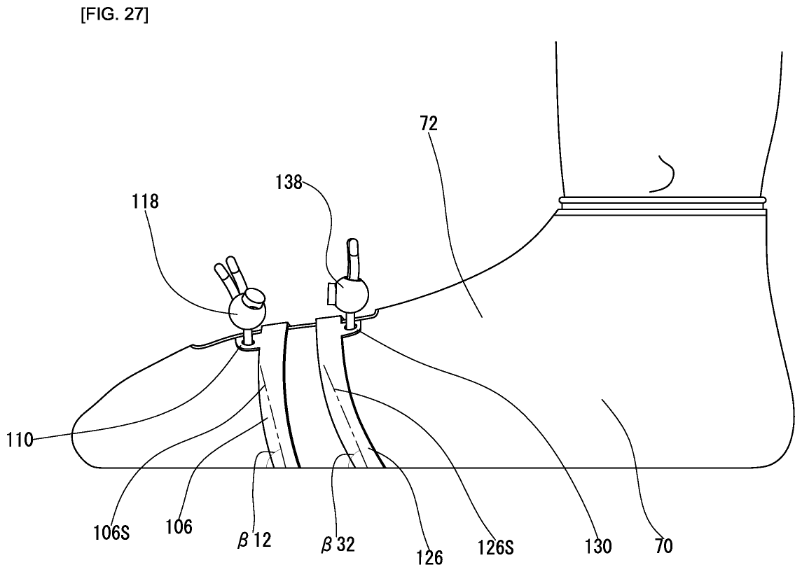

With the above configuration, the left belt-like portion (an inner lateral configuration for ball girth) 106 serves as a lateral ball girth configuration on the inside of the second wearable element 70 with respect to its left-right direction. In the left belt-like portion 106, the angle β12, which is formed between a tangential line 106S of a center line 106N and the polygonal line 102-1 at a contact point between the center line 106N passing through the center of the left belt-like portion 106 and the polygonal line 102-1, ranges from 73 to 79 degrees (preferably 76 degrees) (see FIG. 27).

The right belt-like portion (a second lateral configuration for ball girth) 108 assumes a belt-like shape. As shown in FIG. 20, the right belt-like portion 108 is formed by being enclosed by a pair of straight long sides 108a and 108b, the polygonal line 102-2, and a linear short side (a first end side) 108c. The pair of long sides 108a and 108b are formed in parallel with each other, and the short side 108c is formed, at right angles (which may also be substantially right angles), from the long sides 108a and 108b.

In a developed state of the belt-like portion 102, angle β21 formed between the long side 104a and a toe-side extension 102-2′ of the polygonal line 102-2 ranges from 81 to 87 degrees (preferably 84 degrees). Angle β22 formed between the long side 108a and the toe-side extension 102-2′ of the broken line 102-2 ranges from 67 to 73 degrees (preferably 70 degrees). As a result, in a developed state of the belt-like portion 102, the angle (toe-side angle) β23 formed between the long side 104a and the long side 108a ranges from 151 to 157 degrees (preferably 154 degrees). To be more specific, in the developed state of the belt-like portion 102, the toe-side angle, which is formed between the longitudinal direction of the bottom belt-like portion 104 and the longitudinal direction of the left belt-like portion 106 ranges, from 151 to 157 degrees (preferably 154 degrees).

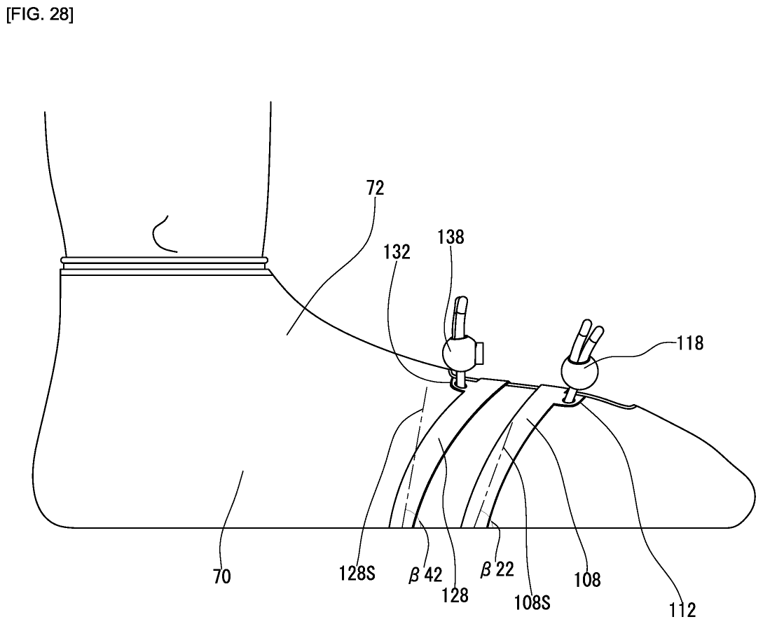

With the above configuration, in the right belt-like portion (an outer lateral configuration for ball girth) 108 that is the lateral configuration for ball girth located on the outside of the second wearable element 70 with respect to its left-right direction, the angle β22, which is formed between a tangential line 108S of the center line 108N and the polygonal line 102-2 at a contact point between the center line 108N passing through the center of the right belt-like portion 108 and the polygonal line 102-2, ranges from 67 to 73 degrees (preferably 70 degrees) (see FIG. 28).

As above, in the developed state of the belt-like portion 102, the toe-side angle (i.e., angle β13), which is formed between the longitudinal direction of the bottom belt-like portion 104 and the longitudinal direction of the left belt-like portion 106, ranges from 185 to 191 degrees. The toe-side angle (i.e., angle β23), which is formed between the longitudinal direction of the bottom belt-like portion 104 and the longitudinal direction of the right belt-like portion 108, ranges from 151 to 157 degrees. The toe-side angle (i.e., angle β12) closer to the left belt-like portion 106, which is formed by the direction of a boundary line 102-1 between the bottom belt-like portion 104 and the left belt-like portion 106 with the direction of a longitudinal side (specifically, the long side 106b) of the left belt-like portion 106, ranges from 73 to 79 degrees. The toe-side angle (i.e., angle β22) closer to the right belt-like portion 108, which is formed by the direction of a boundary line 102-2 between the bottom belt-like portion 104 and the right belt-like portion 108 with the direction of a longitudinal side (specifically, the long side 108b) of the right belt-like portion 108, ranges from 67 to 73 degrees. The belt-like portion 102 can be precisely positioned at the location of the ball girth. The foregoing angles are found through trial and error by the applicants.

As shown in FIG. 12, the short side 106c located at the end of the left belt-like portion 106 and the short side 108c located at the end of the right belt-like portion 108 are opposed to each other. When the plan view of the first wearable element 5 with the cover 12 unstretched is superimposed on the plan view of the second wearable element 70 with the cover 72 unstretched, the long side 106a, the long side 40a, and the long side 108a are substantially in line with each other; and also the long side 106b, the long side 40d, and the long side 108b are substantially in line with each other.

When viewed in plan view, the end of the left belt-like portion 106 closer to the short side 106c is formed so as to protrude toward the inside of the opening 76a beyond an edge (left-side edge) of the opening 76a. The short side 106c is situated in an area of the opening 76a as viewed in plan view. Likewise, as viewed in plan view, the end of the right belt-like portion 108 closer to the short side 108c is formed so as to protrude toward the inside of the opening 76a beyond an edge (right-side edge) of the opening 76a. As viewed in plan view, the short side 108c is situated in the area of the opening 76a. Further, the short side 106c and the short side 108c are spaced from each other. Specifically, even when the foot is not held in the second wearable element 70, the short side 106c and the short side 108c are spaced from each other (when the foot is kept in the second wearable element 70, the short side 106c and the short side 108c are spaced from each other). Incidentally, the short side 106c and the short side 108c can also be arranged in contact with each other with the foot not being worn over the second wearable element 70 and the short side 106c and the short side 108c may also be arranged so as to be spaced from each other with the foot worn over the second wearable element 70.

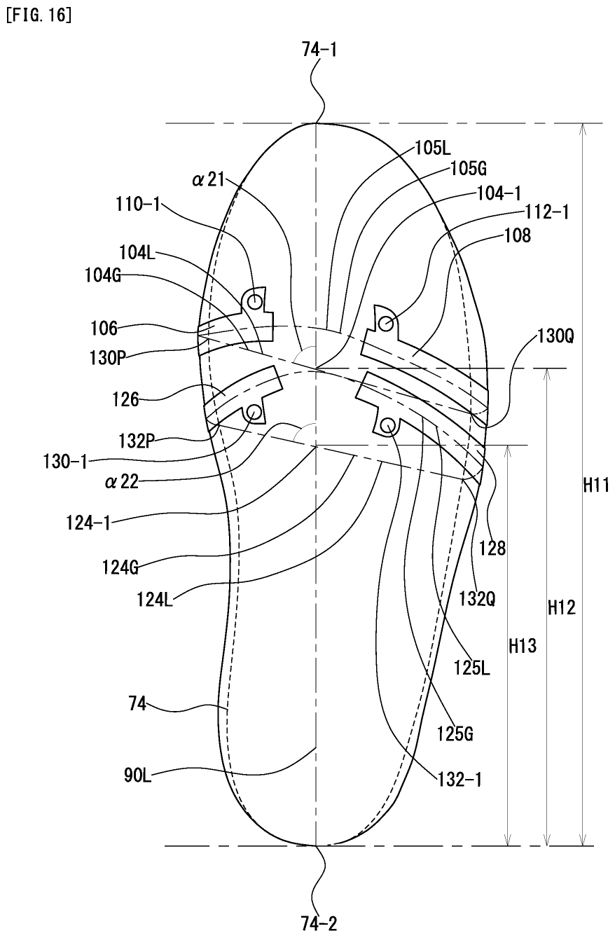

As shown in FIG. 16, the left belt-like portion 106 and the right belt-like portion 108 are, in the second worn state, laid on a curve (an imaginary line on the instep 76) (a fourth imaginary line) 105G on the instep 76. In the plan view of the second wearable element 70, the curve 105G can be said to (may also substantially) coincide with a curve (third imaginary curve) 105L (the curve 105L is flush with the first straight line 104L and the center line 90L) that interconnects two contact points 130P and 130Q between the first straight line 104L and the contour of the sole 74 and that is curved toward the toe as viewed in plan perspective view. In the second worn state, the curve 105L (may also substantially) coincide with the curve 31L as viewed in plan perspective view. The curve 105L is a substantially circular-arc (may also be a circular-arc, elliptic arc, or substantially elliptic-arc) curve bowed toward the front. As a result, as viewed in plan perspective view in the second worn state, the curve 105G (may also substantially) coincides with the curve 31L. The center line 106N between the long sides 106a and 106b (may also substantially) coincides with the curve 105G, and the center line 108N between the long sides 108a and 108b (may also substantially) coincides with the curve 105G. Incidentally, the center line 106N between the long sides 106a and 106b and the center line 108N between the long sides 108a and 108b can also substantially be out of alignment with the curve 105G. Since the left belt-like portion 106 and the right belt-like portion 108 are provided on the curve 105G, the curve 105G is to be, as viewed at least in plan view, situated between the long sides 106a and 106b as well as between the long sides 108a and 108b.

As shown in FIG. 12, when the second wearable element 70 is viewed in plan view, the left belt-like portion 106 and the right belt-like portion 108 are bowed as viewed in plan view toward the toe. In FIG. 12, the long side 108a exists on the extension line (on the extension line in a curved shape of the long side 106a in the plan view) of the long side 106a (the long side 108a can substantially coincide with the extension of the long side 106a). Further, the long side 108b exists on the extension line (on the extension line in a curved shape of the long side 106b) of the long side 106b (the long side 108b can also coincide with the extension of the long side 106b).

Even when the second wearable element 70 is not worn over the foot wearing the first wearable element 5 and is in its original shape, the left belt-like portion 106 and the right belt-like portion 108 are on the curve (the imaginary line on the instep 76) (a fourth imaginary line) 105G on the instep 76. As viewed in plan perspective view, the curve 105G substantially coincides with the first straight line (the third imaginary straight line) 104L. In short, when the sole 74 assumes a curved shape, the line 104G is in a curved shape. As a result, the curve 105G does not always precisely coincide with the first straight line (the third imaginary line) 104L in the perspective view but substantially coincide with the same.

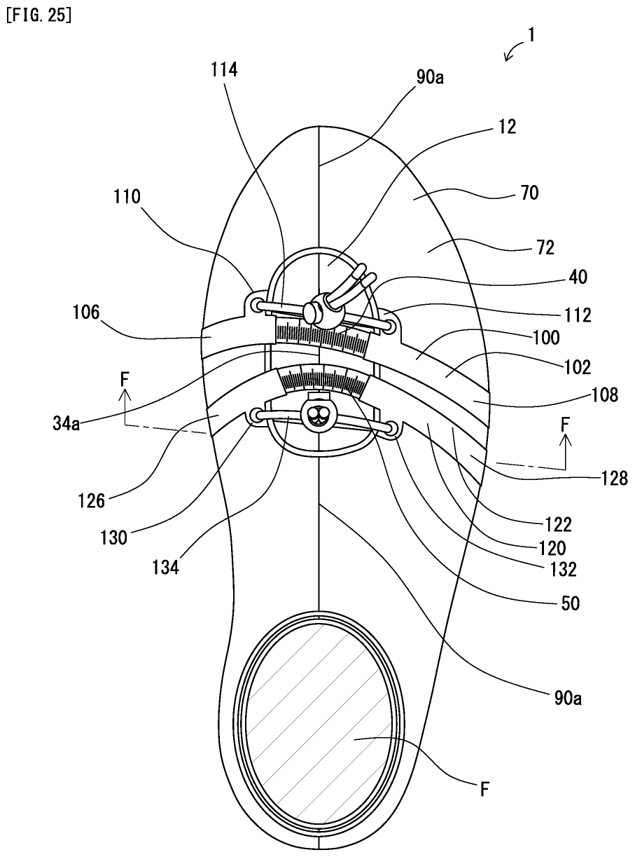

The belt-like portion 102 is configured as above. Therefore, when the first size measuring tool 1 is viewed in plan in the second worn state, the scale mark indicator 40 is interposed between the left belt-like portion 106 and the right belt-like portion 108 as shown in FIG. 25. The scale mark indicator 40, the left belt-like portion 106, and the right belt-like portion 108 are provided in line with the same curve. In short, the longitudinal direction of the scale mark indicator 40 (can also substantially) coincides with the longitudinal direction of the left belt-like portion 106 and the longitudinal direction of the right belt-like portion 108.

As above, the belt-like portion 102 is circumferentially formed in the position on the cover 72 corresponding to the ball girth of the foot that is achieved when the foot is kept in the second wearable element 70. The belt-like portion 102 is narrowly elongated from an area on one side of left and right sides of the instep 76 to an area on the other side of the instep 76, by way of the sole 74 which is the area located on the bottom of the foot when the foot is kept in the second wearable element 70. The pair of short sides 106c and 108c, which are located at respective ends on both sides of the belt-like portion 102 with respect to its longitudinal direction, protrude from the edge of the opening 76a toward the opening 76a. In short, the belt-like portion 102 is circumferentially disposed in the position corresponding to the ball girth, and both ends of the belt-like portion 102 are spaced from each other with respect to the longitudinal direction.

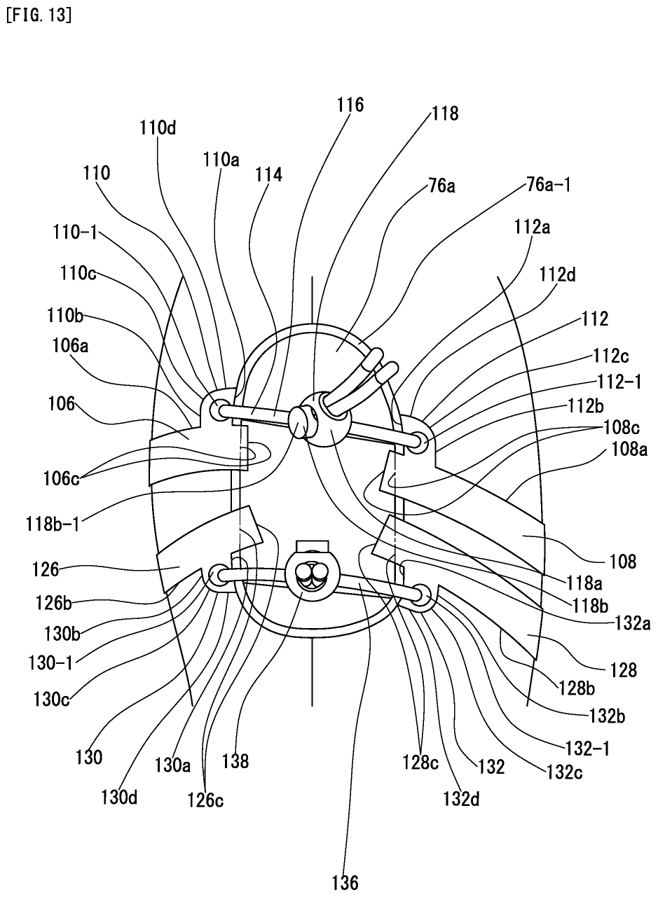

The tab (first tab) 110 continually extends from the long side 106a of the left belt-like portion 106 and adjoins the left-side edge of the opening 76a. In short, the tab 110 protrudes from the left belt-like portion 106 to opposite side of the left belt-like portion 126 (i.e., toward the toe). As shown in FIG. 13, the tab 110 continually extends from the long side 106a, and has a substantially-linear edge 110a stretching along the edge of the opening 76a; a linear (may also substantially-linear) edge 110b continually extending from the long side 106a and (may also substantially) parallel to the edge 110a; a substantially circular-arc edge 110c continually extending from the edge of the edge 110b; and a substantially-linear edge 110d that is interposed between the end of the edge 110c and the end of the edge 110a and that forms an obtuse angle with the direction of the edge 110b. As mentioned above, the tab 110 is secured to the instep 76 by bonding, adhesion, or the like. A hole 110-1 is provided at a position on the tab 110 corresponding to the hole 76b-1 and can let the lace 116 pass through the tab 110 and the instep 76.

The tab (second tab) 112 continually extends from the long side 108a of the right belt-like portion 108 and adjoins the right-side edge of the opening 76a. In short, the tab 112 protrudes from a side of the right belt-like portion 108 to opposite side of the right belt-like portion 128 (i.e., toward the toe). The tab 112 continually extends from the long side 108a, and has a substantially-circular-arc edge 112a stretching along the edge of the opening 76a; a substantially linear edge 112b continually extending from the edge 112a and substantially parallel to the edge 112a; a substantially circular-arc edge 112c continually extending from the edge of the edge 112b; and a substantially-linear edge 112d that is interposed between the end of the edge 112c and the end of the edge 112a and that forms an obtuse angle with the direction of the edge 112b. The tab 112 is secured to the instep 76 by bonding, adhesion, or the like. A hole 112-1 is provided at a position on the tab 112 corresponding to the hole 76b-2 and can let the lace 116 pass through the tab 112 and the instep 76.

The bottom belt-like portion 104, the left belt-like portion 106, and the right belt-like portion 108 are provided on the exterior surface of the cover 72. Hence, the line 104G and the curve 105G can be said to be positioned outside the cover 72.

The tabs 110 and 112 protrude toward the toe side of the belt-like portion 102. The tab 110 can also be configured to protrude toward the heel side of the left belt-like portion 106, and the tab 112 can also be configured to protrude toward the heel side of the right belt-like portion 108. The left belt-like portion 126 adjoins the left belt-like portion 106, and the right belt-like portion 128 adjoins the right belt-like portion 108. Therefore, it is preferable to configure the tabs so as to protrude toward the toe side. In a word, the tabs 110 and 112 protrude the toe-side of the belt-like portion 102 and hence does not hinder the left belt-like portion 126 or the right belt-like portion 128.

The fastening portion 114 has the lace (first lace) 116 and a stopper (a first stopper) 118 for fixing the fastened state by the lace 116. The lace 116 is made up of one lace-shaped member. The lace 116 passes through the hole of the tab 110 and the hole 76b-1 as well as through the hole of the tab 112 and the hole 76b-2. As a result of both ends of the lace 116 passing through the stopper 118, the stopper 118 engages with the lace 116. The stopper 118 is a conventionally-used stopper, and has a main body 118a having a hole for insertion of both sides of the lace 116 in a bundled state and a slide portion 118b provided in the main body 118a. The slide portion 118b is for locking the lace 116 inserted into the hole. If a pushing portion 118b-1 (apart protruding from the main body 118a) provided in a slide portion 118b is pushed, the diameter of the hole is made greater so that the bundled lace 116 can move in an inserted state. If pushing action of the pushing portion 118b-1 is released, the diameter of the hole will be made smaller so that the lace 116 can be fastened. A spring mechanism drives the slide portion 118b into the hole of the main body 118a in such a direction that the diameter of the hole becomes smaller. The degree of fastening of the lace 116 can be controlled by adjusting the length of an end-side portion of the lace 116 protruding from the stopper 118.

The lace 116 may also be an unstretchable or stretch-resistant lace material, or alternatively a stretchable lace material. In the case of the stretchable lace material, the short sides 106c and 108c can be prevented from be lifted up without forcefully fastening the lace 116.

The instep girth measurement portion 120 is secured to the exterior surface of the cover 72, and the instep girth measurement portion 120 has a belt-like portion 122 and tabs 130 and 132 continually extending from the belt-like portion 122. The instep girth measurement portion 120 is a sheet shaped member and is formed from a flexible, unstretchable or stretch-resistant material (may also be a nonelastic-unstretchable material or an elasticity-stretchability resistant material) as in the case with the scale mark indicators 40 and 50 and the ball girth measurement portion 100. The unstretchable or stretch-resistant material provides, for instance, polyvinyl chlorides (e.g., polyvinyl chloride (PVC) and glass fiber polyvinyl chloride). The instep girth measurement portion 120 is secured to the exterior surface of the cover 72 by bonding, sewing, or others. In the case of bonding, the belt-like portion 122 and the tabs 130 and 132 are bonded to the exterior surface of the cover 72. In the case of sewing, the instep girth measurement portion 120 is sewed along the hem of the instep girth measurement portion 120 by a sewing thread. The area protruding from the opening 76a is sewed along the edge of the opening 76a. In the case of sewing, the tabs 130 and 132 are sewed along the hems of the tabs 130 and 132 except the hems adjoining the belt-like portion 122. As above, the scale mark indicators 40 and 50, the ball girth measurement portion 100, and the instep girth measurement portion 120 are formed from the same material.

The belt-like portion (a circumferential portion for instep girth or an instep girth measurement member) 122 as a whole assumes a belt shape (can also be narrowly elongated) (in other words, the belt-like portion 122 is formed in a belt shape from the short side 126c (which will be described later) to the short side 128c). The belt-like portion 122 has the bottom belt-like portion 124 secured to a bottom-side surface of the sole 74 of the cover 72; the left belt-like portion 126 that continually extends from the left end of the bottom belt-like portion 124 and that is secured to the exterior surface of a left-side area of the instep 76; and the right belt-like portion 128 that continually extends from the right end of the bottom belt-like portion 124 and is secured to an exterior surface of a right-side area of the instep 76. The left belt-like portion 126 is bendable against the bottom belt-like portion 124 by way of the polygonal line 122-1, and the right belt-like portion 128 is bendable against the bottom belt-like portion 124 by way of the polygonal line 122-2. The bottom belt-like portion 124, the left belt-like portion 126, and the right belt-like portion 128 each assume a belt-like shape; more specifically, a trapezoidal shape.

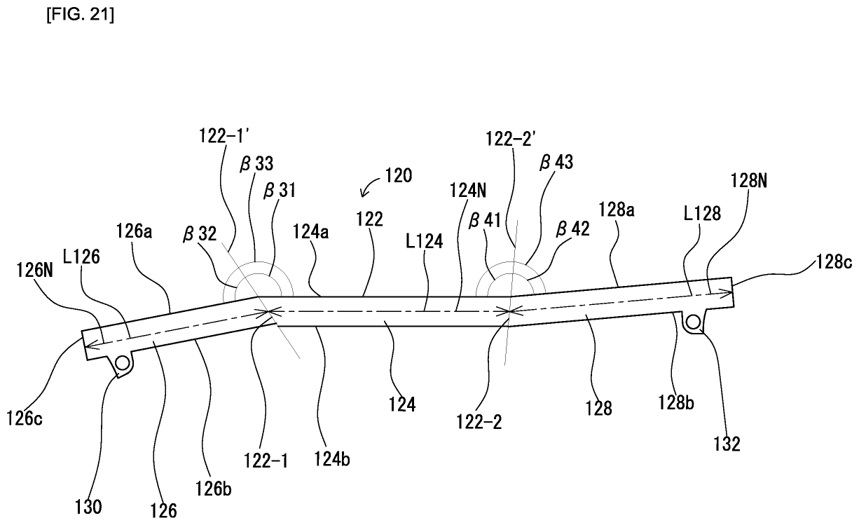

The bottom belt-like portion (bottom configuration for an instep girth) 124 assumes a belt-like shape. As shown in FIG. 21, the bottom belt-like portion 124 is formed by being enclosed by a pair of linear long sides 124a and 124b and straight polygonal lines 122-1 and 122-2. The pair of long sides 124a and 124b are parallel to each other.

The bottom belt-like portion 124 is laid on a line (an imaginary line laid on the sole 74 or an imaginary line laid along the surface of the sole 74) (a fifth imaginary line) 124G. In the state where the foot is kept in the second wearable element 70 (in particular the second worn state), the line 124G (may also substantially) coincides with a second straight line (a fourth imaginary line) 124L as viewed in plan perspective view. The second straight line 124L is an imaginary straight line that crosses the center line 90L at an intersection point 124-1. When the second wearable element 70 is viewed in perspective view in the second worn state, the second straight line 124L passes through a position where a ratio of length H13 to length H11 (a second instep ratio) ranges from 51.0 to 61.0% (preferably 56.0%), wherein the length H11 is a length of the center line 74L between the leading end 74-1 and the rear end 74-2 of the center line 74L, and the length H13 is a length between the intersection point 104-1, which is intersection point of the second straight line 124L and the center line 90L, and the rear end 74-2. An angle of inclination between the second straight line 124L and the center line 90L; namely, the angle (second instep angle) α22, which is formed between the toe-side direction of the center line 90L and the inner direction with respect to the foot position of the second straight line 124L (the inner direction in left-right direction), ranges from 75.5 to 85.5 degrees (preferably 80.5 degrees) for men and from 74.5 to 84.5 degrees (preferably 79.5 degrees) for women. In a word, the second wearable element 70 includes men's wearable element and women's wearable element. The line 124G can be said to be linear in the second worn state because the sole 74 assumes the shape of a flat plate. Moreover, in the second worn state, the second straight line 124L substantially coincides (may coincide) with the second straight line 32L as viewed in plan perspective view. As a result, the line 124G substantially coincides (may coincide) with the second straight line 32L as viewed in plan perspective view in the second worn state.

The ratio of the length H13 to the length H11 is (may also substantially) identical with the ratio of the length H3 to the length H1 in the first wearable element 5. The angle α22 is (substantially) identical with the angle α12. Thus, the scale mark indicator 50 is interposed between the left belt-like portion 126 and the right belt-like portion 128. The scale mark indicator 50, the left belt-like portion 126, and the right belt-like portion 128 are oriented in substantially the same direction.

In the second worn state, as viewed in plan view, the bottom belt-like portion 124 is laid in a plan view along the second straight line 124L at a position where the second straight line 124L comes to the center line of the bottom belt-like portion 124 along the second straight line 124L (the second straight line 124L can also be laid at a position where the second straight line 124L (may also substantially) coincides with the center line 124N of the bottom belt-like portion 124). Namely, the long sides 124a and 124b are (may also substantially) parallel to the second straight line 124L. A length between the long side 124a and the second straight line 124L is (can also be substantially) identical with the length between the long side 124b and the second straight line 124L. The second straight line 124L can also be located at another position where it is out of alignment with the center line of the bottom belt-like portion 124. However, since the bottom belt-like portion 124 is laid on the line 124G, the line 124G is situated between the long side 124a and the long side 124b as viewed in at least plan view.

The longitudinal length of the bottom belt-like portion 124 is a length from one end (an end tangent to the second straight line 124L) of the sole 74 to the other end (an end tangent to the second straight line 124L) of the sole 74. In the second worn state, the bottom belt-like portion 124 is situated below the first wearable element 5.

Even when the second wearable element 70 is not worn over the foot wearing the first wearable element 5 and is in its original shape, the bottom belt-like portion 124 is laid on the line (the fifth imaginary line) 124G on the sole 74, and the line 124G (can also substantially) coincides with the second straight line (the fourth imaginary straight line) 124L as viewed in plan perspective view. In short, when the sole 74 is in a curved shape, the line 124G assumes the shape of a curve. As viewed in plan perspective view, the line 124G does not always precisely coincide with the second straight line (fourth imaginary straight line) 124L, but substantially coincides with the same.

The left belt-like portion (a first lateral configuration for instep girth) 126 assumes a belt-like shape. As shown in FIG. 21, the left belt-like portion 126 is formed by being enclosed by a pair of straight long sides 126a and 126b, the polygonal line 122-1, and a linear short side (a first end side) 126c. The pair of long sides 126a and 126b are formed in parallel with each other, and the short side 126c is formed, at right angles (which may also be substantially right angles), from the long sides 126a and 126b.

In a developed state of the belt-like portion 122, angle β31 formed between the long side 124a and a toe-side extension 122-1′ of the polygonal line 122-1 ranges from 121 to 127 degrees (preferably 124 degrees). Angle β32 formed between the long side 126a and the toe-side extension 122-1′ of the polygonal line 122-1 ranges from 64 to 70 degrees (preferably 67 degrees). As a result, in a developed state of the belt-like portion 122, angle (toe-side angle) β33 formed between the long side 124a and the long side 126a ranges from 188 to 194 degrees (preferably 191 degrees). To be more specific, in the developed state of the belt-like portion 122, the toe-side angle formed between the longitudinal direction of the bottom belt-like portion 124 and the longitudinal direction of the left belt-like portion 126 ranges from 188 to 194 degrees (preferably 191 degrees).

With the above configuration, in the left belt-like portion (an inner lateral configuration for instep girth) 126 that is the lateral configuration for instep girth located on the inside of the second wearable element 70 with respect to its left-right direction, the angle β32, which is formed between a tangential line 126S of a center line 126N and the polygonal line 122-1 at a contact point between the center line 126N passing through the center of the left belt-like portion 126 and the polygonal line 122-1, ranges from 64 to 70 degrees (preferably 67 degrees) (see FIG. 27).

The right belt-like portion (a second lateral configuration for instep girth) 128 assumes a belt-like shape. As shown in FIG. 21, the right belt-like portion 128 is formed by being enclosed by a pair of straight long sides 128a and 128b, the polygonal line 122-2, and a linear short side (a first end side) 128c. The pair of long sides 128a and 128b are formed in parallel with each other, and the short side 128c is formed, at right angles (which may also be substantially right angles), from the long sides 128a and 128b.

In a developed state of the belt-like portion 122, angle β41 formed between the long side 124a and a toe-side extension 122-2′ of the polygonal line 122-2 ranges from 92 to 98 degrees (preferably 95 degrees). Angle β42 formed between the long side 128a and the toe-side extension 122-2′ of the broken line 122-2 ranges from 77 to 83 degrees (preferably 80 degrees). As a result, in a developed state of the belt-like portion 122, angle (toe-side angle) β43 formed between the long side 124a and the long side 128a ranges from 173 to 178 degrees (preferably 175 degrees). To be more specific, in the developed state of the belt-like portion 122, the toe-side angle, which is formed between the longitudinal direction of the bottom belt-like portion 124 and the longitudinal direction of the left belt-like portion 126, ranges from 173 to 178 degrees (preferably 175 degrees).

With the above configuration, in the right belt-like portion (an outer lateral configuration for instep girth) 128 that is the lateral configuration for instep girth located outside the second wearable element 70 with respect to its side-to-side direction, the angle β42, which is formed between a tangential line 128S of the center line 128N and the polygonal line 122-2 at a contact point between the center line 128N passing through the center of the right belt-like portion 128 and the polygonal line 122-2, ranges from 77 to 83 degrees (preferably 80 degrees) (see FIG. 28).

As above, in the developed state of the belt-like portion 122, the toe-side angle (i.e., angle β33), which is formed between the longitudinal direction of the bottom belt-like portion 124 and the longitudinal direction of the left belt-like portion 126, ranges from 188 to 194 degrees. The toe-side angle (i.e., angle β43), which is formed between the longitudinal direction of the bottom belt-like portion 124 and the longitudinal direction of the right belt-like portion 128, ranges from 172 to 178 degrees. The toe-side angle (i.e., angle β32) on the side of the left belt-like portion 126, which is formed by the direction of a boundary line 122-1 between the bottom belt-like portion 124 and the left belt-like portion 126 with the direction of the longitudinal side (to be specific, the long side 126b) of the left belt-like portion 126, ranges from 64 to 70 degrees. The toe-side angle (i.e., angle β42) on the side of the right belt-like portion 128, which is formed by the direction of a boundary line 122-2 between the bottom belt-like portion 124 and the right belt-like portion 128 with the longitudinal direction of the long side (to be specific, the long side 128b) of the right belt-like portion 128, ranges from 77 to 83 degrees. The belt-like portion 122 can be precisely positioned at the location of the instep girth. The foregoing angles are found through trial and error by the applicants.

As shown in FIG. 11, when the lower surface of the bottom plate 60 of the first wearable element 5 assumes a curved shape, the bottom belt-like portion 104 and 124 are sloped in conformity with the curved shape of the lower surface of the bottom plate 60 in the second worn state. Hence, when the bottom belt-like portion 104 and 124 are sloped relative to the horizontal plane (the horizontal plane on which the foot size measurement tool 1 is mounted), angles of the tangential lines 106S, 108S, 126S and 128S relative to the horizontal plane will be different from those mentioned above. The angle of the tangential line 106S relative to the polygonal line 102-1, the angle of the tangential line 108S relative to the broken line 102-2, the angle of the tangential line 126S relative to the broken line 122-1, and the angle of the tangential line 128S relative to the broken line 122-2 are analogous to those mentioned above. As in the case of the configures shown in FIGS. 3 through 5 where the bottom plate 60 assumes the shape of a flat plate, the belt-like portion 102 can be precisely positioned on the location of the ball girth, and the belt-like portion 122 can be precisely positioned on the location of the instep girth.

As shown in FIG. 12, the short side 126c located at the end of the left belt-like portion 126 and the short side 128c located at the end of the right belt-like portion 128 are opposed to each other. When the plan view of the first wearable element 5 with the cover 12 unstretched is superimposed on the plan view of the second wearable element 70 with the cover 72 unstretched, the long side 126a, the long side 50a, and the long side 128a are substantially in line with each other; and also the long side 126b, the long side 50d, and the long side 128b are substantially in line with each other.

As viewed in plan view, the end of the left belt-like portion 126 closer to the short side 126c is formed so as to protrude toward the inside of the opening 76a beyond the edge (left-side edge) of the opening 76a. As viewed in plan view, the short side 126c is situated in the area of the opening 76a. Likewise, as viewed in plan view, the end of the right belt-like portion 128 closer to the short side 128c is formed so as to protrude toward the inside of the opening 76a beyond the edge (right-side edge) of the opening 76a. As viewed in plan view, the short side 128c is situated in the area of the opening 76a. The short side 126c and the short side 128c are spaced from each other. Specifically, even when the foot is not kept in the second wearable element 70, the short side 126c and the short side 128c are spaced from each other (when the foot is kept in the second wearable element 70, the short side 126c and the short side 128c are naturally spaced from each other). Alternatively, the short side 126c and the short side 128c can also be arranged in contact with each other with the foot not being worn over the second wearable element 70 and the short side 126c and the short side 128c can also be spaced from each other with the foot worn over the second wearable element 70.

As shown in FIG. 16, the left belt-like portion 126 and the right belt-like portion 128 are, in the second worn state, laid on a curve (the imaginary line on the instep 76) (a sixth imaginary line) 125G on the instep 76. When the second wearable element 70 is viewed in plan view, the curve 125G can be said to (may also substantially) coincide with a curve (fourth imaginary curve) 125L (the curve 125L is flush with the second straight line 124L) that interconnects two contact points 132P and 132Q between the second straight line 124L and the contour of the sole 74 and that is curved toward the toe as viewed in plan perspective view. In the second worn state, the curve 125L (may also substantially) coincides with the curve 33L as viewed in plan perspective view. The curve 125L is a substantially-circular-arc (may also be a circular arc, elliptic arc, or substantially-elliptic-arc) curve bowed toward the front. As a result, as viewed in plan perspective view in the second worn state, the curve 125G (may also substantially) coincides with the curve 33L. The center line 126N between the long sides 126a and 126b (may also substantially) coincides with the curve 125G, and the center line 128N between the long sides 128a and 128b (may also substantially) coincides with the curve 125G. Incidentally, the center line 126N between the long sides 126a and 126b and the center line 128N between the long sides 128a and 128b may also be substantially out of alignment with the curve 125G. Since the left belt-like portion 126 and the right belt-like portion 128 are provided on the curve 125G, the curve 125G is to be, as viewed in at least plan view, situated between the long sides 126a and 126b as well as between the long sides 128a and 128b.

As shown in FIG. 12, when the second wearable element 70 is viewed in plan view, the left belt-like portion 106 and the right belt-like portion 108 are bowed toward the toe. In FIG. 12, the long side 128a exists on the extension line (on the extension line in the curved shape of the long side 126a) of the long side 126a (the long side 128a can substantially coincide with the extension of the long side 126a). Further, the long side 128b exists on the extension line (on the extension line in the curved shape of the long side 126b) of the long side 126b (the long side 128b can also coincide with the extension of the long side 126b).

Since the bottom belt-like portion 124, the left belt-like portion 126, and the right belt-like portion 128 are provided on the exterior surface of the cover 72. The line 124G and the cover 125G can be said to be positioned outside the cover 72.

Even when the second wearable element 70 is not worn over the foot wearing the first wearable element 5 and is in its original shape, the left belt-like portion 126 and the right belt-like portion 128 are on the curve (the imaginary line on the instep 76) (a sixth imaginary line) 125G on the instep 76. As viewed in plan perspective view, the curve 125G substantially coincides with the curve 125L. In short, when the sole 74 assumes a curved shape, the line 124G is in a curved shape. As a result, as viewed in plan perspective view, the curve 125G does not always precisely coincide with the curve 125L, but substantially coincides with the same.

The short sides 106c, 108c, 126c, and 128c are formed so as to protrude to the inside of the opening 76a. However, the short sides can also not protrude to the inside of the opening 76a. As illustrated by a dot-dashed line as shown in FIG. 13, the short sides can also be formed along the edge of the opening 76a. In a word, the short sides can also be formed to coincide with the edge of the opening 76a. Even in this case, scale marks between the short sides 106c and 108c can be measured, and scale marks between the short sides 126c and 128c can be measured. Still, the short sides protruding to the inside of the opening 76a will make positions of the short sides relative to the scale marks more visible easily. Hence, it becomes possible to implement measurement accurately.

Since the belt-like portion 122 is formed as mentioned above, when the foot size measurement tool 1 is viewed in plan in the second worn state, as shown in FIG. 25 the scale mark indicator 50 is interposed between the left belt-like portion 126 and the right belt-like portion 128, and the scale mark indicator 50, the left belt-like portion 126, and the right belt-like indicator 128 are provided in line with the same curve. More specifically, the longitudinal direction of the scale mark indicator 50 (can also substantially) coincides with the longitudinal direction of the left belt-like portion 60 and the longitudinal direction of the right belt-like portion 108.

As above, the belt-like portion 122 is circumferentially formed in the position on the cover 72 corresponding to the instep girth of the foot that is achieved when the foot is kept in the second wearable element 70. The belt-like portion 122 is narrowly elongated from an area on one side of left and right sides of the instep 76 to an area on the other side of the instep 76, by way of the sole. The pair of short sides 126c and 128c, which are located at the respective ends on both sides of the belt-like portion 122 with respect to its longitudinal direction, protrudes from the edge of the opening 76a toward the opening 76a. In short, the belt-like portion 122 is circumferentially disposed in the position corresponding to the instep girth, and both ends of the belt-like portion 122 are spaced from each other with respect to the longitudinal direction.

When the ball girth measurement portion 100 and the instep girth measurement portion 120 are manufactured, a sheet-like member is made of the material that forms the ball girth measurement portion 100, in conformity with a developed shape shown in FIG. 20. A sheet-like member is made of the material that forms the instep girth measurement portion 120, in conformity with a develop shape shown in FIG. 21. When the sheet-like member is made in conformity with the developed shape, a sheet-like member having a developed shape is made with a punching die by die-cutting, thereby enhancing the accuracy of longitudinal length of the belt-like portions 102 and 122.

Although the belt-like portions 102 and 122 are in belt shape, they may also assume the shape of a narrowly-elongated belt. Specifically, the circumferential portion for ball girth and the circumferential portion for instep girth may also assume a belt shape. The belt-like member can also be formed from an unstretchable or stretch-resistant material (can also be a nonelastic, unstretchable material or an elasticity-stretchability resistant material). In short, all that is required of the belt-like portions 102 and 122 is to be formed from a narrowly elongated member.

The tab (a third tab) 130 continually extends from the long side 126b of the left belt-like portion 126 and adjoins the left side of the opening 76a. In short, the tab 130 protrudes from the left belt-like portion 126 to opposite side of the left belt-like portion 106. As shown in FIG. 13, the tab 130 continually extends from the long side portion 126b. The tab 130 has a substantially-linear edge 130a extending along the edge of the opening 76a; a substantially-linear edge 130b that continually extends from the long side 126b and that is substantially at a right angle to the long side 126b; a substantially-arc edge 130c continually extends from the end of the edge 130b; and a substantially-linear side 130d that is interposed between an end of the edge 130c and an end of the edge 130a and that is formed in a left-right direction. The tab 130 is secured to the instep 76 by bonding, sewing, or the like. The tab 130 has a hole 130-1 formed in a position corresponding to the hole 76c-1, enabling the lace 136 to pass through the tab 130 and the instep 76.

The tab (a fourth tab) 132 continually extends from the long side 128b of the right belt-like portion 128 and adjoins the right-side edge of the opening 76a. In short, the tab 132 protrudes from the right belt-like portion 128 to opposite side of the right belt-like portion 108 (i.e., toward the heel side). The tab 132 continually extends from the long side portion 128b. The tab 132 has a substantially-arc edge 132a extending along the edge of the opening 76a; a substantially-linear edge 132b continually extending from the long side 128b and that is formed in a substantially-linear shape with respect to the front-to-back direction; a substantially-arc edge 132c formed in a substantially-arc shape from the end of the edge 132b; and a substantially-linear edge 132d that is interposed between an end of the edge 132c and an end of the edge 132a and that is sloped in a substantially-linear shape with respect to the left-right direction in such a way that the left side of the side 132d becomes closer to the front side. The tab 132 is secured to the instep 76 by bonding, sewing, or the like. The tab 132 has a hole 132-1 formed in a position corresponding to the hole 76c-2, enabling the lace 136 to pass through the tab 132 and the instep 76.

The tabs 130 and 132 protrude toward the heel side of the belt-like portion 122. Still, the tab 130 can also be configured to protrude toward the toe side of the left belt-like portion 126, and the tab 132 can also be configured to protrude toward the toe side of the right belt-like portion 128. The left belt-like portion 106 adjoins the left belt-like portion 126, and the right belt-like portion 108 adjoins the right belt-like portion 128. Therefore, it is preferable to configure the tabs so as to protrude toward the heel side. In a word, the tabs 130 and 132 protrude the heel-side of the belt-like portion 122 and hence do not hinder the left belt-like portion 106 or the right belt-like portion 108.

The fastening portion 134 has the lace (second lace) 136 and a stopper (a second stopper) 138 for fixing the fastened state by the lace 136. The lace 136 is analogous in configuration to the lace 116. The stopper 138 is analogous in configuration to the stopper 118, and hence detailed descriptions of the stopper 138 will be omitted. The degree of fastening of the lace 136 can be controlled adjusting by controlling the length of an end-side portion of the lace 136 protruding from the stopper 138.

The lace 136 can be an unstretchable or stretch-resistant lace material, yet the lace may also be a stretchable lace material (e.g., a rubber lace material). In the case of a stretchable lace material, the short sides 126c and 128c can be prevented from being lifted up without fastening the lace 136.

The ball girth measurement portion 100 and the instep girth measurement portion 120 are made from an unstretchable or stretch-resistant material, yet all that is required of them is to exhibit unstretchability or stretch resistance with respect to the longitudinal direction of the belt-like portions 102 and 122. In a word, in the ball girth measurement portion 100, the bottom belt-like portion 104, the left belt-like portion 106, and the right belt-like portion 108 exhibit unstretchability or stretch resistance in their longitudinal directions. In the instep girth measurement portion 120, the bottom belt-like portion 124, the left belt-like portion 126, and the right belt-like portion 128 exhibit unstretchability or stretch resistance with respect to their longitudinal directions.

The longitudinal direction of the bottom belt-like portion 104 is a direction between its end close to the left belt-like portion 106 and its other end close to the right belt-like portion 108. The longitudinal direction of the left belt-like portion 106 is a direction between its end close to the bottom belt-like portion 104 and its other end opposite the end close to the bottom belt-like portion 104. The longitudinal direction of the right belt-like portion 108 is a direction between its end close to the bottom belt-like portion 104 and its other end opposite the end close to the bottom belt-like portion 104. The longitudinal direction of the bottom belt-like portion 124 is a direction between its end close to the left belt-like portion 126 and its other end close to the right belt-like portion 128. The longitudinal direction of the left belt-like portion 126 is a direction between its end close to the bottom belt-like portion 124 and its other end opposite the end close to the bottom belt-like portion 124. The longitudinal direction of the right belt-like portion 128 is a direction between its end close to the bottom belt-like portion 124 and its other end opposite the end close to the bottom belt-like portion 124.

In the case that the ball girth measurement portion 100 and the instep girth measurement portion 120 are made of material which stretches in one direction (e.g., the longitudinal direction), the other direction (e.g., the transverse direction) is taken as the longitudinal direction of the bottom belt-like portion 104, that of the left belt-like portion 106, that of the right belt-like portion 108, the bottom belt-like portion 124, that of the left belt-like portion 126, and that of the right belt-like portion 128.

In the case of the material that stretches in only one direction, the material does not stretch in the longitudinal direction. Hence, the bottom belt-like portion 104, the left belt-like portion 106, and the right belt-like portion 108 in the belt-like portion 102 are formed separately from each other and secured to the cover 72. The bottom belt-like portion 124, the left belt-like portion 126, and the right belt-like portion 128 in the belt-like portion 122 are formed separately from each other and secured to the cover 72. Even when the bottom belt-like portion 104, the left belt-like portion 106, and the right belt-like portion 108 are formed separately from each other, adjacent belt-like portions must be tied together by sewing, or the like, so as to prevent creation of clearance among the three adjacent belt-like portions; i.e., the bottom belt-like portion 104, the left belt-like portion 106, and the right belt-like portion 108, which would otherwise occur when the wearable main body 10 stretches. Likewise, even when the bottom belt-like portion 124, the left belt-like portion 126, and the right belt-like portion 128 are formed separately from each other, adjacent belt-like portions must be tied together by sewing, or the like, so as to prevent creation of a crevice among the three adjacent belt-like portions; i.e., the bottom belt-like portion 124, the left belt-like portion 126, and the right belt-like portion 128, which would otherwise occur when the cover 72 is stretched.

If the respective portions of the belt-like portion 102 are formed separately from each other, the accuracy of measurement would be deteriorated. It is preferable to form the ball girth measurement portion 100 and the instep girth measurement portion 120 from a material that is unstretchable or stretch-resistant in any of the longitudinal and transverse directions (in 360-all directions).

The fastening portion 114 has the lace 116 and the stopper 118 and the fastening portion 134 has the lace 136 and the stopper 138. Although two tabs can also be fastened together by means of only the laces 116 and 136 without use of the stoppers 118 and 138.

Although the ball girth measurement portion 100 and the instep girth measurement portion 120 are secured to the exterior surface of the cover 72, they can also be secured to an interior surface of the cover 72.

In the ball girth measurement portion 100, the bottom belt-like portion 104 is secured to the interior surface of the sole 74. The left belt-like portion 106 is secured to the interior surface of the left-side area of the instep 76. The right belt-like portion 108 is secured to the interior surface of the right-side area of the instep 76. As is the case of the ball girth measurement portion 100 being provided on the exterior surface of the cover 72, even in this case, the bottom belt-like portion 104 is provided on the line 104G; the left belt-like portion 106 and the right belt-like portion 108 are provided on the line 105G; the line 104G (may also substantially) coincides with the first straight line 104L, as viewed in plan perspective view in the second worn state; and the curve 105G (may also substantially) coincides with the curve 105L as viewed in plan perspective view in the second worn state. The ball girth measurement portion 100 can be said to be secured to an undersurface of the area where the ball girth measurement portion 100 is secured to the cover 72 in the case that the ball girth measurement portion 100 is provided on the exterior surface of the cover 72. Since the bottom belt-like portion 104, the left belt-like portion 106, and the right belt-like portion 108 are provided on the interior surface of the cover 72, the line 104G and the curve 105G can be said to be situated on the inside of the cover 72. Since the ball girth measurement portion 100 is secured to the interior surface of the cover 72, the bottom belt-like portion 104, the left belt-like portion 106, and the right belt-like portion 108 become shorter by the thickness of the cover 72. Even in this case, as viewed in plan view, the end of the left belt-like portion 106 closer to the short side 106c is formed so as to protrude toward the inside of the opening 76a beyond the edge (left edge) of the opening 76a. As viewed in plan view, the short side 106c is situated in the area of the opening 76a. Likewise, as viewed in plan view, the end of the right belt-like portion 108 closer to the short side 108c is formed so as to protrude toward the inside of the opening 76a beyond edge (right edge) of the opening 76a. As viewed in plan view, the short side 108c is situated in the area of the opening 76a.

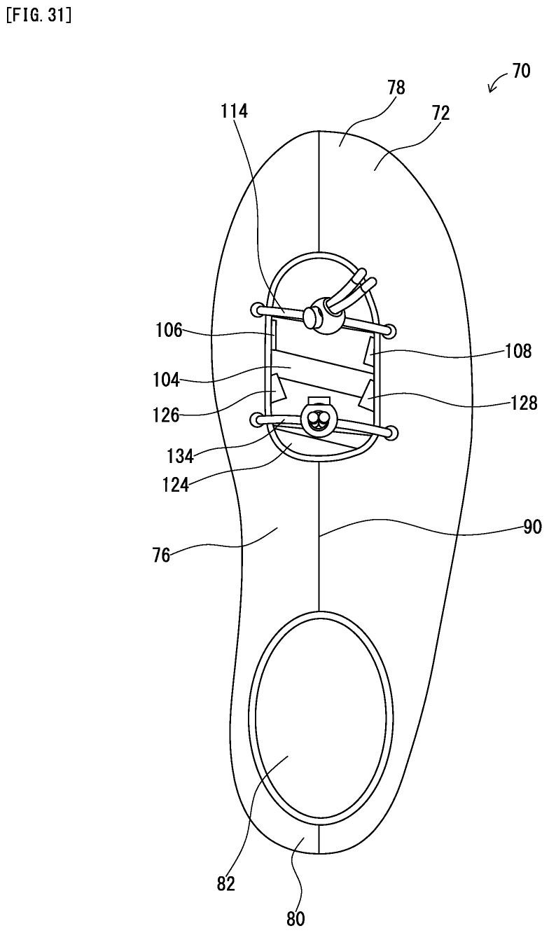

A configuration, such as that shown in FIG. 31, is achieved when the ball girth measurement portion 100 and the instep girth measurement portion 120 are provided on the interior surface of the cover 72. The second ball girth ratio, the second instep girth ratio, the second ball girth angle, and the second instep girth angle are the same as those achieved when the ball girth measurement portion 100 and the instep girth measurement portion 120 are provided on the interior surface of the cover 72.

When the instep girth measurement portion 120 is secured to the interior surface of the cover 72, in relation to the instep girth measurement portion 120 the bottom belt-like portion 124 is secured to the interior surface of the sole 74; the left belt-like portion 126 is secured to the interior surface of the left-side area of the instep 76; and the right belt-like portion 108 is secured to the interior surface of the right-side area of the instep 76. As is the case of the instep girth measurement portion 120 being provided on the exterior surface of the cover 72, even in this case the bottom belt-like portion 124 is provided on the line 124G; the left belt-like portion 126 and the right belt-like portion 128 are provided on the line 125G; the line 124G (may also substantially) coincides with the second straight line 124L; and as viewed in plan perspective view in the second worn state, the curve 125G (may also substantially) coincides with the curve 125L. The instep girth measurement portion 120 can be said to be secured to an undersurface of the area where the instep girth measurement portion 120 is secured to the cover 72 in the case that the instep girth measurement portion 120 is provided on the exterior surface of the cover 72. Since the bottom belt-like portion 124, the left belt-like portion 126, and the right belt-like portion 128 are provided on the interior surface of the cover 72, the line 124G and the curve 125G can be said to be situated on the inside of the cover 72. Since the instep girth measurement portion 120 is secured to the interior surface of the cover 72, the bottom belt-like portion 124, the left belt-like portion 126, and the right belt-like portion 128 become shorter by the thickness of the cover 72. Even in this case, as viewed in plan view, the end of the left belt-like portion 126 closer to the short side 126c is formed so as to protrude toward the inside of the opening 76a beyond the edge (left edge) of the opening 76a. As viewed in plan view, the short side 126c is situated in the area of the opening 76a. Likewise, as viewed in plan view, the end of the right belt-like portion 128 closer to the short side 128c is formed so as to protrude toward the inside of the opening 76a beyond the edge (right edge) of the opening 76a. As viewed in plan view, the short side 128c is situated in the area of the opening 76a.

The second wearable element 70 is provided in different types according to its length in the direction of foot length (i.e., the length H11 from the leading end to rear end of the cover 72) and provided in; for instance, 5 mm increments. In a word, the second wearable element 70 is provided in different types according to its length; for instance, 5 mm increments.

As to the length (length H11) of the second wearable element 70 corresponding to the first wearable element 5 which have a certain length in direction of foot length, the first wearable element 5 and the second wearable element 70 are equal in length with respect to the direction of foot length. However, the second wearable element 70 covers the outside of the first wearable element 5, and hence, with respect to the direction of foot length, the length (length H11) of the second wearable element 70 is made slightly longer than the length (length H1) of the first wearable element 5.

The second wearable element 70 in FIGS. 12 through 21 is for right foot. However, the left-foot second wearable element is structurally identical with the right-foot second wearable element 70 shown in FIGS. 12 through 21 except that it is symmetrical with the right-foot second wearable element 70 (relative to the front-back direction (in a word, longitudinal direction (symmetrical via the central plane in Y1-Y2 direction)).

The foot size measurement tool set includes a plurality of foot size measurement tools, and the plural foot size measurement tools (the length of the first wearable element 5 and that of the second wearable element 70 with respect to the direction of foot length) each are configured in different lengths with respect to the direction of foot length. For instance, when the foot size measurement tool set includes a foot size measurement tool 1A, a foot size measurement tool 1B, and a foot size measurement tool 1_{c}, the first wearable element 5 and the second wearable element 70 in the foot size measurement tool 1A adapt to a foot length L1 mm; the first wearable element 5 and the second wearable element 70 in the foot size measurement tool 1B adapt to a foot length L2 mm; and the first wearable element 5 and the second wearable element 70 in the foot size measurement tool 1c adapt to a foot length L3 mm, wherein the foot length L1, the foot length L2, and the foot length L3 differ in length from each other. The first wearable element 5 and the second wearable element 70 in one foot size measurement tool 1 included in the foot size measurement tool set adapt to the same foot length.

The ball girth measurement portion 100 can also be taken as a ball girth measurement unit 100; the belt-like portion 102 can also be taken as a ball girth measurement portion 102; the instep girth measurement portion 120 can also be taken as an instep girth measurement unit 120; and the belt-like portion 122 can also be taken as an instep girth measurement portion 122.

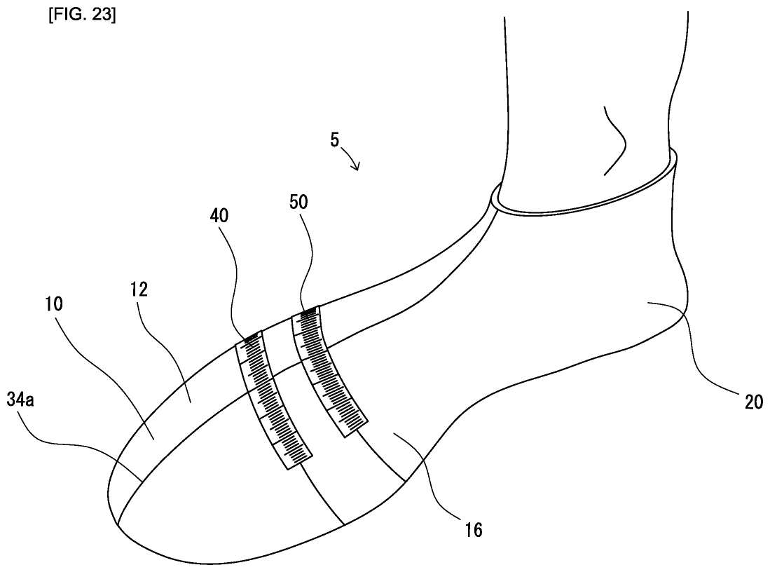

A method of using the foot size measurement tool having the foregoing configuration will now be described. To begin with, the foot to be subject to foot size measurement is slipped into the first wearable element. Specifically, a foot size measurement tool set including a plurality of foot size measurement tools is prepared, wherein the first wearable element 5 and the second wearable element 70 differ in foot size from each other with respect to the direction of foot length. Select, from the foot size measurement tool set, the foot size measurement tool 1 adapting to the length of the foot to be measured. Let a foot wear the first wearable element 5 of the selected foot size measurement tool 1 like wearing sock. FIGS. 22 and 23 show that a foot F is kept in the first wearable element 5. FIG. 24(a) is transverse cross section of the first wearable element 5 in which the foot F is not kept in contrast, FIG. 24(b) is transverse cross section of the first wearable element 5 with the foot F kept in. The cover 12 stretches in conformity with the outer shape of the foot F, closely adhering to the surface of the foot F (since the sole 14 is secured to the bottom plate 60, the sole 14 will not closely adhere to the bottom of the foot). For reference, in order to facilitate positioning of the second wearable element 70, it is preferable to adjust the degree of stretching of the cover 12 such that the center indication line 34a takes the center position of the instep of the foot F with the foot F kept in the first wearable element 5 (specifically, the center indication line 34a is located on the line connecting the second shoe and the rear end of the heel).

Space Fs is set below a foot arch Fa of the foot F. More specifically, since the sole 14 of the cover 12 is bonded to the bottom plate 60, the sole 14 is not closely adhered to the bottom surface of the foot F, so that the space Fs is created below the foot arch Fa. The space Fs can reproduce the space to be created between the foot arch Fa, which is present when the foot wears the shoe while remaining in contact with a footbed of the shoe, and the footbed.

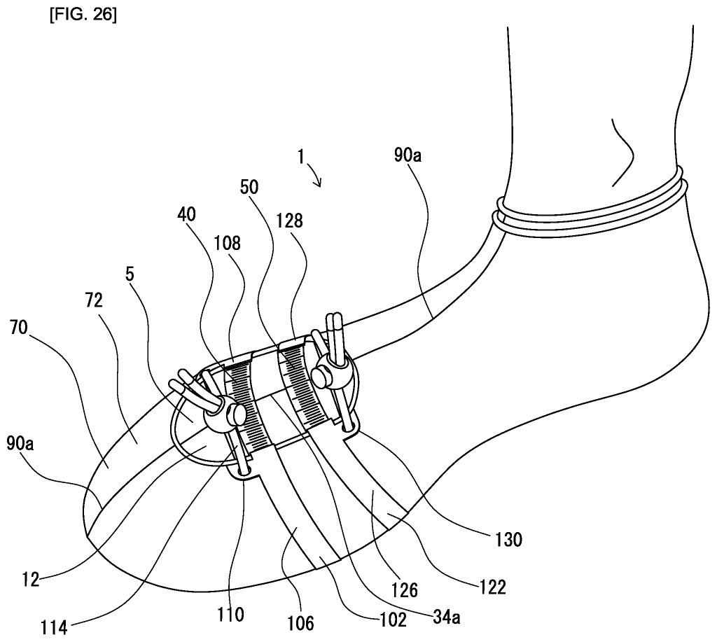

When the first wearable element 5 is worn over the foot F, the foot F wearing the first wearable element 5 is slipped into the second wearable element 70 (the second wearable element 70 adapting to the foot length). The foot wears the second wearable element 70 so as to cover the first wearable element 5. FIGS. 25 through 28 show the foot kept in the second wearable element 70. Moreover, FIG. 29(a) shows transverse cross section of the second wearable element 70 with the foot F kept in. FIG. 29(b) shows transverse cross section of the second wearable element 70 in which the foot F wears the first wearable element 5, and the cover 72 closely adheres to the first wearable element 5 in conformance with the outer shape of the first wearable element 5. For reference, the degree of stretching of the cover 72 is adjusted such that the center indication line 90a of the second wearable element 70 is situated at the center position of the foot (the center indication line 90a is located on a line connecting the second toe and the rear end of the heel). Thereby, as shown in FIG. 25, the center indication line 34a of the first wearable element 5 and the center indication line 90a of the second wearable element 70 coincides with each other. The first wearable element 5 and the second wearable element 70 can thereby be aligned to each other.

The degree of fastening of the second wearable element 70 can be adjusted by the fastening portions 114 and 134. Accordingly, the short sides 106c and 108c can be prevented from being lifted up by fastening action of the fastening portion 114, so that the ball girth can be accurately measured. Likewise, the short sides 126c and 128c can be prevented from being lifted up by fastening action of the fastening portion 134, so that the instep girth can be accurately measured. The degree of fastening of the fastening portions 114 and 134 should be the level of strength at which the short sides 106c, 108c, 126c, and 128c are not lifted up.

The areas of the instep 76 on both sides of the opening 76 are sloped much downward with increasing distance from the opening 76a, and hence the edge of the opening 76a is apt to be lifted up. When the edge of the opening 76a is lifted upward, the side portions 106c, 108c, 126c, and 128c are also lifted upward (to be specific, leading edges of the left belt-like portion 106, the right belt-like portion 108, the left belt-like portion 126, and the right belt-like portion 128, which are close to the short sides, are obliquely lifted up), so that it is impossible to measure the ball girth or the instep girth accurately. As mentioned above, however, the ball girth and the instep girth can be accurately measured by preventing the short sides 106c, 108c, 126c, and 128c from being lifted up.

The degree of fastening of the second wearable element 70 can be preferably adjusted by controlling the position of the fastening 118 relative to the lace 116 with the fastening portion 114 and the position of the fastening 138 relative to the lace 136 with the fastening portion 134. When the fastening portions 114 and 134 are tightly fastened, the length between the short side 106c of the left belt-like portion 106 and the short side 108c of the right belt-like portion 108 becomes shorter, and the length between the short side 126c of the left belt-like portion 126 and the short side 128c of the right belt-like portion 128 becomes shorter. A measurement length (which will be described later) of the scale mark indicator 40 and a measurement length (which will be described later) of the scale mark indicator 50 become shorter. Compared with the ball girth and the instep girth being loosely fastened, the ball girth and the instep girth to be measured become shorter. To maintain objectivity of the ball girth and the instep girth, it is preferable to fasten the short sides 106c, 108c, 126c, and 128c to such an extent that they are not lifted upward.

The circumferential portion 76a-1 of the opening 76 is formed by a stretchable sewing thread 77. Hence, the sewing thread 77 can prevent the circumferential portion 76-1 from being lifted up. Since the short sides 106c, 108c, 126c, and 128c can thereby be prevented from being lifted up, the ball girth and the instep girth can be accurately measured. The sewing thread 77 acts as a stretchable, elastic member.

Another conceivable method to prevent the edge of the opening 76a from being lifted up is to lay an elastic member 77′, which exhibits stretchability and flexibility, along the circumferential portion 76a-1. The elastic member 77′ assumes the shape of a looped plate along the circumferential portion 76a-1; is bonded to a position on the lower surface of the instep 76 stretching along the edge of the opening 76a (i.e., a hem of the opening 76a); and is fixed to the instep 76 by also the sewing thread 77 that forms the circumferential portion 76a-1. The elastic member 77′ is formed from an elastic member that exhibits stretchability and flexibility, such as rubber. As a result of the elastic member 77′ being provided, the edge of the opening 76a can be prevented from being lifted up. Thereby, the short sides 106c, 108c, 126c, and 128c can be prevented from being lifted up, so that the ball girth and the instep girth can be measured accurately. For information, since the elastic member 77′ exhibits stretchability and flexibility, the changing of size and shape of the opening 76a is not hindered.

The sole 74 is positioned below the bottom plate 60 with the foot in the second wearable element 70, and a part of the first wearable element 5 emerges from the opening 76a and becomes visible from above. Specifically, the instep 16 and the scale mark indictors 40 and 50 are visible from above. When the foot size measurement tool 1 is viewed from above opposite the sole 74 of the second wearable element 70 (in short, when the foot size measurement tool 1 is viewed in plan), the scale mark indicator 40 is interposed between the pair of short sides 106c and 108c, and the scale mark indicator 50 is interposed between the pair of short sides 126c and 128c. As viewed in plan view in the second worn state, the scale mark indicator 40 is visually recognized at the position between the pair of short sides 106c and 108c, and the scale mark indicator 50 is visually recognized at the position between the pair of short sides 126c and 128c.

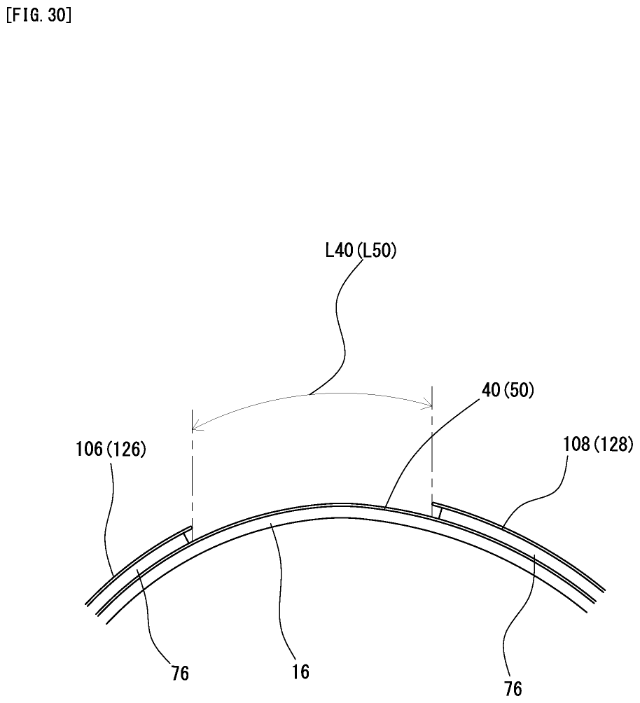

As viewed in plan view, the scale mark indicator 40 is situated between the left belt-like portion 106 and the right belt-like portion 108 (i.e., the scale mark indicator 40 is situated between the short sides 106c and 108c in the opening 76a). Therefore, a scale mark length (a “measurement length of the scale mark indicator 40”) L40 (see FIG. 30) between the short side 106c of the left belt-like portion 106 and the short side 108c of the right belt-like portion 108 is measured with the scale mark indicator 40, whereby the length between the short side 106c and the short side 108c can be obtained. The short sides 106c and 108c are formed so as to protrude from the edge of the opening 76a toward the opening 76a, and are situated in an area of the opening 76a as viewed in plan view. Hence, the short sides 106c and 108c overlay the scale mark indicator 40 as viewed in plan view, so that the scale mark of the scale mark indicator 40 can be accurately read.

In particular, the longitudinal direction of the scale mark indicator 40 (may also substantially) coincides with the longitudinal direction of the left belt-like portion 106 and the longitudinal direction of the right belt-like portion 108. The short side 106c forms a right angle with the long sides 106a and 106b, and the short side 108c forms a (may also substantially) right angle with the short sides 108a and 108b, so that a scale mark can be accurately read.

As viewed in plan view, the scale mark indicator 50 is situated between the left belt-like portion 126 and the right belt-like portion 128 (in other word, the scale mark indicator 50 is situated between the short sides 126c and 128c in the opening 76a). Therefore, a scale length L50 (see FIG. 30) (a measurement length of the scale mark indicator 50) between the short side 126c of the left belt-like portion 126 and the short side 128c of the right belt-like portion 128 is measured with the scale mark indicator 50, whereby the length between the short side 126c and the short side 128c can be obtained. The short sides 126c and 128c are formed so as to protrude from the edge of the opening 76a toward the opening 76a, and are situated in the area of the opening 76a in the plan view. Hence, the short sides 126c and 128c overlay the scale mark indicator 50 as viewed in plan view, so that the scale mark of the scale mark indicator 50 can be accurately read.

In particular, the longitudinal direction of the scale mark indicator 50 (may also substantially) coincides with the longitudinal direction of the left belt-like portion 126 and the longitudinal direction of the right belt-like portion 128. The short side 126c forms right angles with the long sides 126a and 126b, and the short side 128c forms (may also substantially) right angles with the long sides 128a and 128b, so that a scale mark can be accurately read.

The longitudinal length (the length of the belt-like portion 102) of the belt-like portion 102 is previously measured, and the measurement length of the scale mark indicator 40 is added to the length of the belt-like portion 102, so that the circumferential length in the position of the belt-like portion 102 can be obtained. The ball girth (i.e., the ball girth length) can be obtained by subtracting the length, which is twice the thickness of the bottom plate 60, from the circumferential length in the position of the belt-like portion 102. In a word, the bottom plate 60 is provided on the first wearable element 5, and the circumferential length obtained in the position of the belt-like portion 102 is a value including the length that is twice the thickness of the bottom plate 60. When the upper surface of the bottom plate 60 is regarded as an upper surface of the footbed of the shoe, an originally desirable ball girth length (in other words, a circumferential length in the position of the ball girth on the inner surface of the shoe to be manufactured) is a circumferential length of a pathway that runs through a position on the upper surface of the bottom plate 60. Hence, the length that is twice the thickness of the bottom plate 60 is subtracted from the circumferential length in the position of the belt-like portion 102.

In the first wearable element 5, even when the bottom plate 60 is provided on the inside of the sole 14, the circumferential length in the position of the belt-like portion 102 includes the length that is twice the thickness of the bottom plate 60. Therefore, the length that is twice the thickness of the bottom plate 60 is subtracted from the circumferential length in the position of the belt-like portion 102. When the cover 12 of the first wearable element 5 is not provided with the sole 14, the sole 14 of the cover 12 to be likened to a sock is not provided. Hence, the length that is twice the thickness of the bottom plate 60 is subtracted from the circumferential length in the position of the belt-like portion 102, and the length equal to the thickness of the cover 12 is added.

When the belt-like portion 102 is provided outside the cover 72, it is preferable to subject the length determined from the thickness of the cover 72 further to subtraction in order to obtain the length extending along the surface of the first wearable element 5. Another conceivable method is to obtain the length from the thickness of the cover 72 by calculating, through CAD simulation, a difference between an inner dimension of the cover 72 and an outer dimension of the same. Still another method is to accumulate beforehand data on a difference between the measurement value obtained in the presence of the cover 72 and the measurement value obtained in the absence of the cover 72 and subsequently use an average value of the differences. For reference, when the thickness of the cover 72 is small, there is little need to take into account the length determined from the thickness of the cover 72, and hence the length determined from the thickness of the cover 72 does not need to be subjected to subtraction.

The length of the belt-like portion 102 is a length extending lengthwise from the short side 106c which is one end of the belt-like portion 102 to the short side 108c which is the other end of the same. The length of the belt-like portion 102 is a sum of the longitudinal length of the bottom belt-like portion 104, the longitudinal length of the left belt-like portion 106, and the longitudinal length of the right belt-like portion 108. As shown in FIG. 20, a longitudinal length L104 of the bottom belt-like portion 104 is a length of a linear imaginary line 104N running through the widthwise center of the bottom belt-like portion 104. A longitudinal length L106 of the left belt-like portion 106 is a length of a linear imaginary line 106N that is parallel to the long sides 106a and 106b and that is in contact with the imaginary line 104N. A longitudinal length L108 of the right belt-like portion 108 is a length of a linear imaginary line 108N that is parallel to the long sides 108a and 108b and that is in contact with the imaginary line 104N.

In particular, on the occasion of measurement of the ball girth, since the measurement value (i.e., the measurement length of the scale mark indicator 40) is added to a fixed value (i.e., the longitudinal length of the belt-like portion 102), an overall error can be made small even when a measurement error exists in the measurement value. For instance, on the occasion of measurement of a ball girth of 258 mm, when measurement is performed by winding a scale measuring section around the foot and when a measurement error is 1%, an error of 2.58 mm arises. However, the fixed value (i.e., the longitudinal length of the belt-like portion 102) is 220 mm and when the measurement value (i.e., the measurement length of the scale mark indicator 40) is 38 mm, an error of 0.38 mm arises provided that the measurement error is 1%. Hence, the accuracy of measurement can be enhanced.

The first ball girth ratio and the second ball girth ratio are those mentioned above, and the first ball girth angle and the second ball girth angle are those mentioned above. Hence, the ball girth can be measured accurately. The first ball girth ratio, the second ball girth ratio, the first ball girth angle, and the second ball girth angle are found through trial and error by the applicants. The ball girth can be measured accurately.

The longitudinal length (the length of the belt-like portion 122) of the belt-like portion 122 is previously measured, and the measurement length of the scale mark indicator 50 is added to the length of the belt-like portion 122, so that the circumferential length in the position of the belt-like portion 122 can be obtained. The instep girth (i.e., the instep girth length) can be obtained by subtracting the length, which is twice the thickness of the bottom plate 60, from the circumferential length in the position of the belt-like portion 122. In a word, the bottom plate 60 is provided on the first wearable element 5, and the circumferential length in the position of the belt-like portion 122 is a value including the length that is twice the thickness of the bottom plate 60. When the upper surface of the bottom plate 60 is regarded as an upper surface of the footbed of the shoe, an originally desirable instep girth length (in other words, a circumferential length in the position of the instep girth on the inner surface of the shoe to be manufactured) is a circumferential length of a pathway that runs through a position on the upper surface of the bottom plate 60. Hence, the length that is twice the thickness of the bottom plate 60 is subtracted from the circumferential length in the position of the belt-like portion 122.

In the first wearable element 5, even when the bottom plate 60 is provided on the inside of the sole 14, the circumferential length in the position of the belt-like portion 122 includes the length that is twice the thickness of the bottom plate 60. Therefore, the length that is twice the thickness of the bottom plate 60 is subtracted from the circumferential length in the position of the belt-like portion 122. When the cover 12 of the first wearable element 5 is not provided with the sole 14, the sole 14 of the cover 12 to be likened to a sock is not provided. Hence, the length that is twice the thickness of the bottom plate 60 is subtracted from the circumferential length in the position of the belt-like portion 122, and the length equal to the thickness of the cover 12 is added.

When the belt-like portion 122 is provided outside the cover 72, it is preferable to subject the length, which is determined from the thickness of the cover 72, to subtraction further in order to obtain the length extending along the surface of the first wearable element 5.

The length of the belt-like portion 122 is a length extending longitudinally from the short side 126c which is one end of the belt-like portion 122 to the short side 128c which is the other end of the same. The length of the belt-like portion 122 is a sum of the longitudinal length of the bottom belt-like portion 124, the longitudinal length of the left belt-like portion 126, and the longitudinal length of the right belt-like portion 128. As shown in FIG. 21, a longitudinal length L124 of the bottom belt-like portion 124 is a length of a linear imaginary line 124N running through the widthwise center of the belt-like portion 124. A longitudinal length L126 of the left belt-like portion 126 is a length of a linear imaginary line 126N that is parallel to the long sides 126a and 126b and that is in contact with the imaginary line 124N. A longitudinal length L128 of the right belt-like portion 128 is a length of a linear imaginary line 128N that is parallel to the long sides 128a and 128b and that is in contact with the imaginary line 124N.

In particular, on the occasion of measurement of the instep girth, since the measurement value (i.e., the measurement length of the scale mark indicator 50) is added to a fixed value (i.e., the longitudinal length of the belt-like portion 122), an overall error can be made small even when a measurement error exists in the measurement value.

The first wearable element 5 is provided with the bottom plate 60. Hence, space is created below the foot arch, and space between the foot arch and the footbed of the shoe can be reproduced. Thus, an instep girth suitable for manufacturing shoes can be measured. In a word, when a foot to be measured has an arch, the foot arch is situated at the position of an instep girth. If the position of the instep girth of the foot is simply measured by use of the scale measuring section, measurement is effected while the scale measuring section remains in contact with the surface of the foot arch in the position of the foot arch. As a result, it becomes impossible to take measurement in consideration of the space below the foot arch. In the embodiment, since the bottom plate 60 is provided, the instep girth can be measured with the space created below the foot arch, so that shoes can be manufactured in consideration of the shoe last. Specifically, the space for letting the foot into the shoe cannot be ensured without in consideration of the space below the foot arch. For this reason, a material of the shoe last is provided even at the position of the foot arch in the shoe last. The shoes can be manufactured in consideration of the configuration of such a shoe last.

Therefore, the shoe last is created in accordance with the instep girth determined from the measurement value acquired by the foot size measurement tool 1 of the embodiment and shoes are manufactured with the shoe last. So that the shoes can be manufactured in consideration of the configuration of such a shoe last. The space is created between the foot arch and the footbed of the shoe, whereby an area of the foot arch on the bottom of the foot assumes an arch shape. Physical shock, which would occur during walking, is absorbed by the arch-shaped area. A strain on the foot becomes lessened. Further, as a result of creation of the space, the foot arch on the bottom of the foot acts as a pump. The pump circulates air in the shoe to thus be able to prevent occurrence of footy sweat.

The first instep girth ratio and the second instep girth ratio are those mentioned above, and the first instep girth angle and the second instep girth angle are those mentioned above. Hence, the instep girth can be measured accurately. The first instep girth ratio, the second instep girth ratio, the first instep girth angle, and the second instep girth angle are found through trial and error by the applicants. The instep girth can be measured accurately.

In the cover 12, the sole 14 is secured to the bottom plate 60, the sole 14 does expand or contract. When the scale mark indicators 40 and 50 are bonded to the cover 12, the area of the cover 12 bonded to the scale mark indicator 40 and the area of the cover 12 bonded to the scale mark indicator 50 do not expand or contract. When the brims of the scale mark indicators 40 and 50 are circumferentially sewed, the area of the cover 12 enclosed by the sewing thread does not expand or contract. The cover 12 expands and contracts in the area except the area that does not involve expansion or contract, and hence expansion and contraction of the cover 12 which would occur when the foot wears the first wearable element 5 are not hindered. When the bottom plate 60 is circumferentially sewed to the sole 14 by the sewing thread, sewing is performed by use of a stretchable sewing thread, like rubber thread etc. Thereby, the area of the cover 12 enclosed by the sewing thread can expand and contract. When the scale mark indicators 40 and 50 are sewed, sewing is performed by use of a stretchable sewing thread, such as rubber thread etc., whereby the area enclosed by the sewing thread can expand and contract.

Likewise, when the ball girth measurement portion 100 and the instep girth measurement portion 120 are bonded to the cover 72, the area of the cover 72 bonded to the ball girth measurement portion 100 and the instep girth measurement portion 120 does not expand or contract. When the ball girth measurement portion 100 is circumferentially sewed, the area of the cover 72 enclosed by the sewing thread does not expand or contract. When the instep girth measurement portion 120 is circumferentially sewed, the area of the cover 72 enclosed by the sewing thread does not expand or contract. However, the cover 72 expands and contracts in the area except the area that does not involve expansion or contraction. Hence, expansion and contraction of the cover 72 which would occur when the foot wears are not hindered. When the ball girth measurement portion 100 and the instep girth measurement portion 120 are circumferentially sewed by the sewing thread, sewing is performed by use of a stretchable sewing thread like rubber, whereby the area of the cover 72 enclosed by the sewing thread can also expand and contract.

The planar image of the first wearable element 5 and the second wearable element 70 with the foot inside is photographed thereby to capture images of the scale mark indicators 40 and 50 (i.e., a measurement image). The measurement length of the scale mark indicator 40 and the measurement length of the scale mark indicator 50 can be obtained from the images, and hence the ball girth and the instep girth can be calculated. To photograph the images, the minimum requirement is to capture from above the first wearable element 5 and the second wearable element 70 with the foot inside by a digital camera. The measurement images can be easily photographed.

After the ball girth and the instep girth have been measured, the shoe last is manufactured according to the foot length and the thus-measured ball girth and instep girth, and shoes are manufactured with the shoe last.

As to the foot size measurement tool 1, the foot wears the first wearable element 5 and further the second wearable element 70. The ball girth is measured by the ball girth measurement portion 100, and the instep girth is measured by the instep girth measurement portion 120. The ball girth and the instep girth are measured while the foot is kept in the first wearable element 5. The foot wearing the first wearable element 5 reproduces a state where the foot is kept in one sock. In other words, the ball girth and the instep girth can be said to be measured while the foot is kept in one sock. In short, when wearing shoes, a person usually wears socks. Therefore, ball girth and instep girth are measured with mimicking the state of wearing socks, so that the shoe last fitting the foot wearing the foot size measurement tool can be manufactured.

As above, as to the foot size measurement tool 1 of the present embodiment, the scale marks of the scale mark indicators 40 and 50 can be read only by letting the foot into the first wearable element 5 and the second wearable element 70 corresponding to the foot length, whereby the ball girth and the instep girth can be obtained. There is no necessity to wind the scale measuring section with scale marks around foot, and ball girth and instep girth can be readily measured.

Since short distance measurement is taken with the scale mark indicators 40 and 50, measurement errors can be made smaller.

Images for measurement can be captured by photographing the foot wearing the first wearable element 5 and the second wearable element 70 from above. Accordingly, images for measurement can also be easily photographed.

The bottom plate 60 is provided in the first wearable element 5. Space is created below the foot arch when the foot wears the first wearable element 5. Hence, instep girth suitable for manufacture of shoes can be measured. In short, on the occasion of manufacture of shoes, the shoe last is formed such that space is created between the foot arch and the footbed of the shoe. Therefore, the instep girth suitable for manufacture of shoes can be measured as a result of placement of the bottom plate 60.

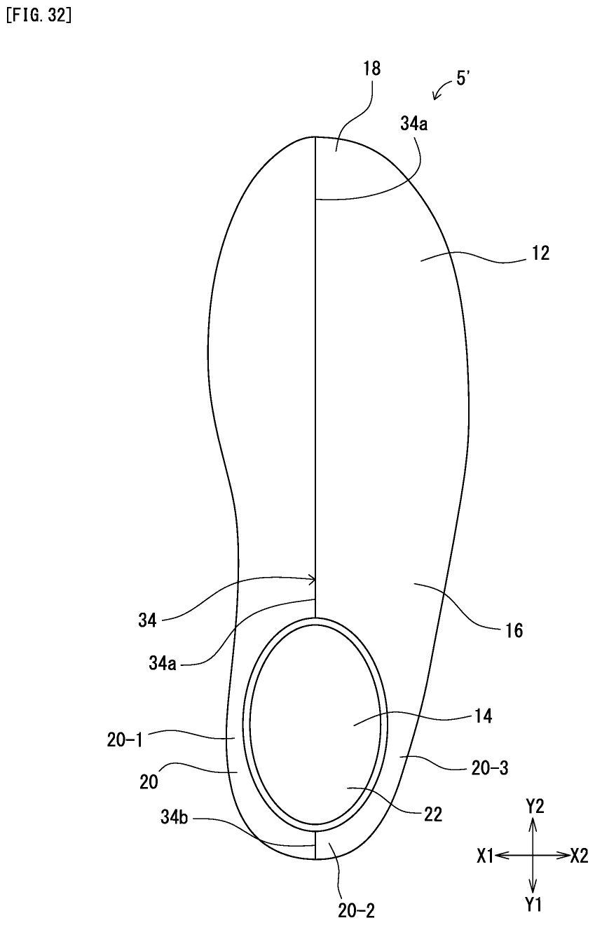

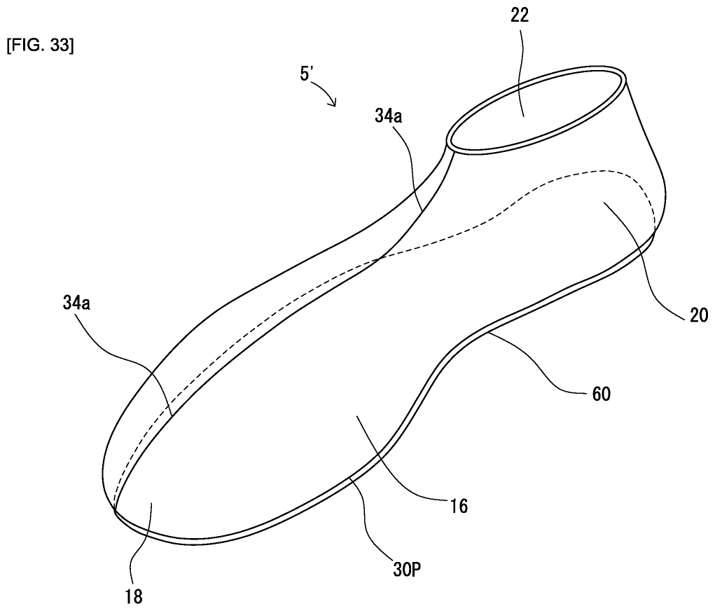

Next, a first modification of the foot size measurement tool 1 will be described. In the above description, the wearable main body 10 of the first wearable element 5 is provided with the scale mark indicators 40 and 50. However, as shown in FIGS. 32 through 35, the configuration of the scale mark indicators 40 and 50 is omitted from a foot size measurement tool 1′ of the first modification, and a measurement ancillary tool 150 is provided.

Specifically, a first wearable element 5′ shown in FIG. 32 is essentially analogous in configuration to the first wearable element 5 shown in FIGS. 1 through 5. However, the first wearable element 5′ is not equipped with the scale mark indicators 40 and 50 but has the cover (which may also be a foot cover or a bag-shaped portion) 12 and the bottom plate 60 secured to the cover 12.

The cover 12 of the first modification is analogous in configuration to the cover 12 in the first wearable element 5, and has the sole 14, the instep 16, the toe 18, and the heel 20. As in the case with the first wearable element 5, the cover 12 is provided with the center indication line 34 but does not have the ball girth indication line 30 and the instep girth indication line 32.

The bottom plate 60 is analogous in configuration to the bottom plate 60 in the first wearable element 5; assumes a flat and substantially-foot-like shape; and is formed from a material that does not exhibiting flexibility (i.e., an inflexible material, or also a material of low flexibility) and also a material that does not exhibit stretchability (i.e., an unstretchable material, or also a stretchability-resistant material).

The cover 12 of the first wearable element 5′ is analogous to the cover 12 of the first wearable element 5. The configuration of the sole 14 in the cover 12 can also be omitted even from the first wearable element 5′. In the area of the first wearable element 5′ exclusive of the sole 14, the toe 18 and lower area of the heel 20 can also be omitted. All that is required of the cover 12 is to be shaped to cover at least the instep and have a shoe opening above for letting the foot in.

The second wearable element 70 in the first modification is analogous in configuration to the second wearable element 70 shown in FIGS. 12 through 20.

Even in the first modification, there is prepared a foot size measurement tool set, in which the first wearable element 5′ and the second wearable element 70 are different in length of foot length direction from each other. The foot size measurement tool 1′ adapting to the foot length of the foot to be measured is selected from the foot size measurement tool set.

The measurement ancillary tool 150 is a plate-like member having the shape of a square frame, and has belt-like portions 152 and 154 provided parallel to each other and belt-like portions 156 and 158 that are provided at a right angle to the belt-like portions 152 and 154 and parallel to each other. The measurement ancillary tool 150, in its entirety, assumes the shape of a square frame. Long sides of the respective belt-like portions 152 through 158 are parallel to each other, and an inner side 152a of the belt-like portion 152 and an inner side 154a of the belt-like portion 154 are parallel to each other. An inner side 156a of the belt-like portion 156 and an inner side 158a of the belt-like portion 158 are parallel to each other. Since the measurement ancillary tool 150 is formed as above, a square opening K150 is placed inside the tool.

The opening K150 has such a size that the short sides 106c, 108c, 126c, and 128c are situated in the opening K150 with the foot wearing the first wearable element 5 and the second wearable element 70. The length L150 between the sides 152a and 154a has a longitudinal length L109 at least between the front end position of the short side 106c and the rear end position of the short side 128c. The length L151 between the sides 156a and 158a is formed to such an extent that the short sides 106c, 108c, 126c, and 128c are sufficiently located within the opening K150 even when the length between the short side 106c and the short side 108c becomes longer or the length between the short side 126c and the short side 128c becomes longer as a result of the foot wearing the first wearable element 5 and the second wearable element 70. In consideration of the case where the lateral width of the foot is large, it is preferable to make the length L151 sufficiently long in accordance with the foot length of the second wearable element 70. It is assumed that a value of the length L150 and that of the length L151 are previously measured. Since the length L150 is previously determined, a “member having a predetermined length” is made up of the belt-like portions 152 and 152 that are spaced the length L150 apart from each other. Since the length L151 is previously determined, a “member having a predetermined length” is made up of the belt-like portions 156 and 158 that are spaced the length L151 from each other.

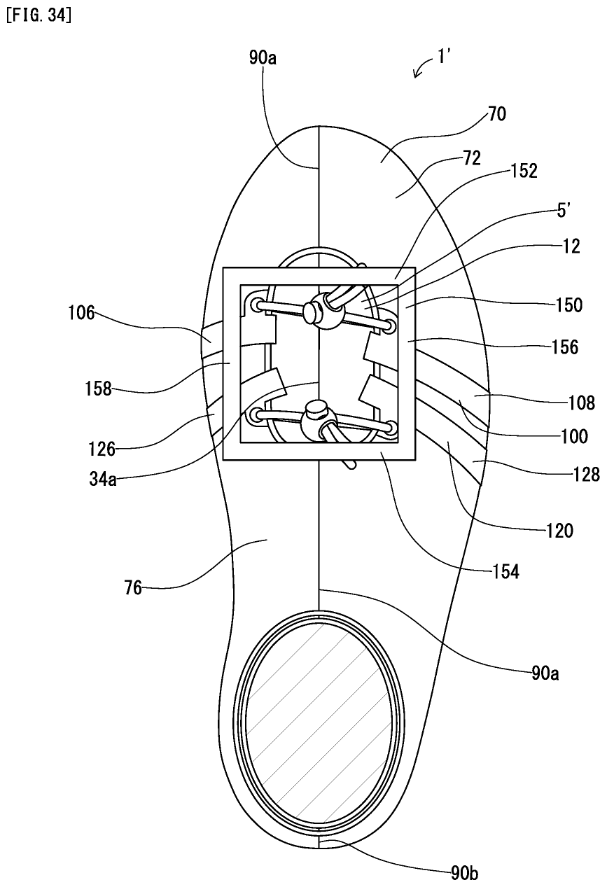

With regard to the method to use the foot size measurement tool 1′ of the first modification, as in the case with the foot size measurement tool 1, the foot wears the first wearable element 5′ and the second wearable element 7 adapting to the foot length. As in the case with the foot size measurement tool 1, the center indication line 34a of the first wearable element 5′ and the center indication line 90a of the second wearable element 70 coincide with each other as shown in FIG. 34.

As shown in FIG. 34, the measurement ancillary tool 150 is placed on the second wearable element 70, and the short sides 106c, 108c, 126c, and 128c are situated within the opening K150 of the measurement ancillary tool 150. While measurement ancillary tool 150 is arranged as shown in FIG. 34, the measurement ancillary tool 150 is photographed in the area within the measurement ancillary tool 150 and the opening K150.

From the photographed image, the length L105 between the short side 106c and the short side 108c (the length along the curved shape of the left belt-like portion 106 and the right belt-like portion 108) is measured by comparison with the lengths L150 and L151. Likewise, the length L125 between the short side 126c and the short side 128c (the length along the curved shape of the left belt-like portion 126 and the right belt-like portion 128) is measured by comparison with the lengths L150 and L151. With regard to the method to measure the length L105, a curvature of the curved shape of the left belt-like portion 106 and the right belt-like portion 108 is previously determined. A length L105′ of straight line between an intermediate equidistant position between both ends of the short side 106c and an intermediate equidistant position between both ends of the short side 108c is measured by comparison with the lengths L150 and L151. Subsequently, the length L105 is calculated from the curvature. The same also applies to the method to measure a length L125.

In the above description, the measurement ancillary tool 150 assumes the shape of a square frame. Another conceivable example of the measurement ancillary tool 150 is a sheet that shows a first straight line group including a plurality of mutually-straight straight lines and a second straight line group including mutually-parallel straight lines orthogonal to the straight lines of the first straight line group like plotting paper. The foot wearing the foot size measurement tool 1′ is held on the sheet, and the foot size measurement tool 1′ is photographed with the sheet. Compared with a length between the straight lines in the first straight line group and a length between the straight lines in the second straight line group, thereby measuring the length L105 and the length L125 may be calculated.

All that is required of the measurement ancillary tool to be a member where at least three targets of measurement, i.e., a first photographing point, a second photographing point, and a third photographing point, are spaced from each other and to be a member to be photographed together with the foot size measurement tool 1. If the lengths between two sets of points among the three points and an angle of a straight lines between the two sets of points have been determined previously, the lengths L105 and L125 can be measured even when the photographed image is tilted relative to the direction of the plan view of the photographed image.

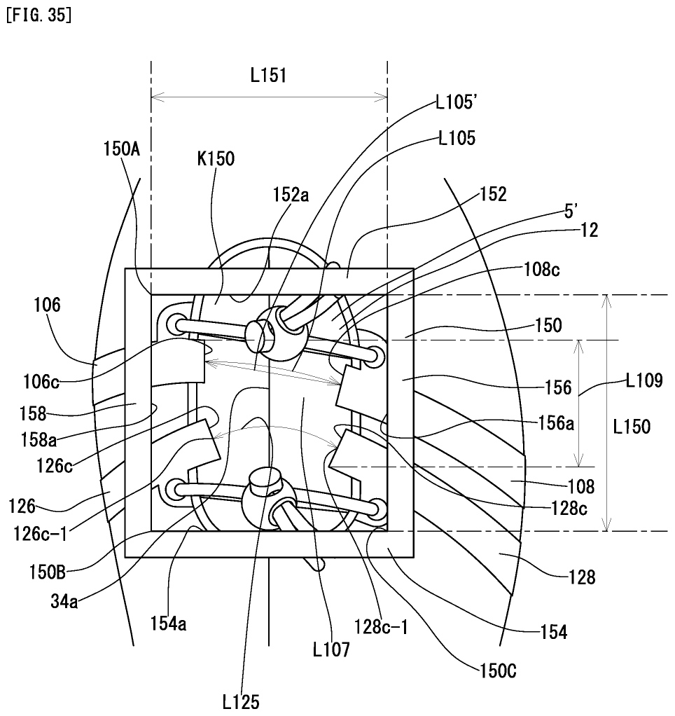

For instance, in the measurement ancillary tool 150 shown in FIGS. 34 and 35, provided that a corner (the first photographing point) 150A between the sides 152a and 158a, a corner (the second photographing point) 150B between the sides 158a and 154a, and a corner (the third photographing point) 150C between the sides 154a and 156a are taken as three photographing points; that a straight line between the corners 150A and 150B is taken as a first inter-corner straight line and a straight line between the corners 150B and 150C is taken as a second inter-corner straight line; and that the length of the first inter-corner straight line, the length of the second inter-corner straight line, and an angle (90 degrees in the example shown in FIG. 35) between the first inter-corner straight line and the second inter-corner straight line are previously determined, the photographed image can be corrected to an planar image. Hence, the length L105 and the length L125 can be measured on the basis of the thus-corrected image.

Therefore, for instance, the foot wearing the foot size measurement tool 1′ is held in the sheet that shows three points; i.e., the first photographing point through the third photographing point, and the foot is photographed along with the three points. Thereby, the lengths L105 and L125 can be measured.

Although the short sides 106c, 108c, 126c, and 128c are formed so as to protrude inside the opening 76a in the foot size measurement tool 1′, the short sides can also be formed along the edge of the opening 76a. There is no problem even when the short sides do not reach the edge of the opening 76a at photographing, as long as the short sides 106c, 108c, 126c, and 128c can be photographed. In a word, all that is required of the short sides 106c, 108c, 126c, and 128c is to be placed in proximity to the opening 76a. In the example shown in FIG. 35, the minimum requirement is to place the short sides at position within the frame of the measurement ancillary portion 150.

As mentioned above, the measurement ancillary tool 150 is used in place of the scale mark indicators 40 and 50 in the foot size measurement tool 1′, so that the ball girth and the instep girth can be obtained. The scale measuring section with scale marks does not need to be wound around the foot, and the ball girth and the instep girth can be readily measured. Moreover, a short distance between two short sides (i.e., a distance between the short sides 106c and 108c and a distance between the short sides 126c and 128c) is measured, and hence an error in measurement can be reduced.

Even in the foot size measurement tool 1′, an image for measurement can be obtained by photographing from above the first wearable element 5 and the second wearable element 70 worn over the foot, so that the image for measurement can be readily photographed.

Even in the foot size measurement tool 1′, the first wearable element 5 is provided with the bottom plate 60. Space is created below the foot arch when the foot wears the first wearable element 5. Hence, an instep girth suitable for manufacture of shoes can be measurement.

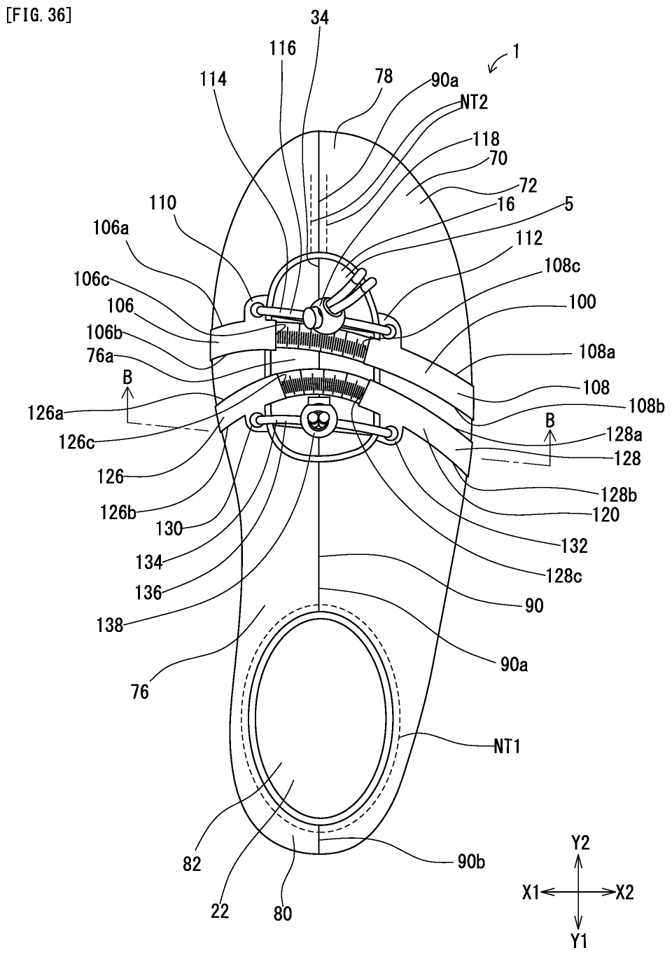

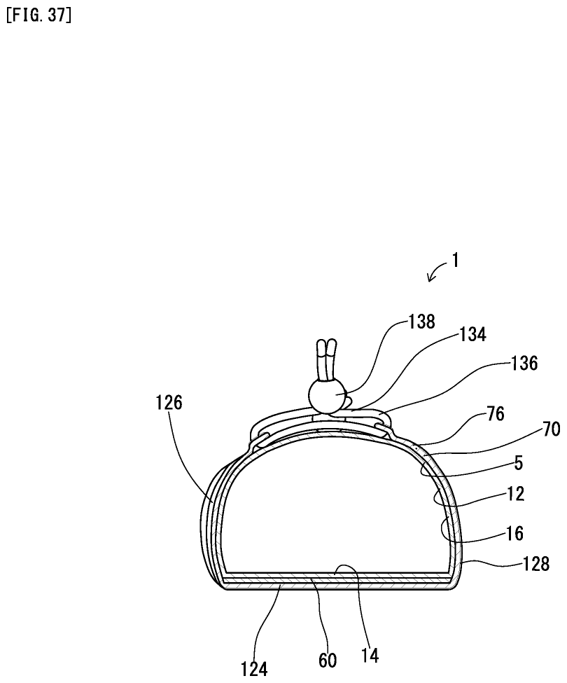

In the above descriptions, the first wearable element 5 and the second wearable element 70 are separated from each other in the foot size measurement tool 1. In the above description, during use of the foot size measurement tool 1, the second wearable element 70 is worn over the first wearable element 5 after the foot has been slipped into the first wearable element 5. However, the first wearable element 5 can also be secured to the second wearable element 70. In the foot size measurement tool 1 here, as shown in FIGS. 36 and 37, the sole 74 is situated on the lower side of the bottom plate 60. When the foot size measurement tool 1 is viewed in plan view, the opening 22 serving as the shoe opening of the cover 12 becomes visible through the inside of the opening 82 that acts as the shoe opening of the cover 72. In above state, the first wearable element 5 and the second wearable element 70 are secured. The center indication line 34 and the center indication line 90 are in line with each other in a situation where the first wearable element 5 and the second wearable element 70 are secured.

The way to secure the first wearable element 5 and the second wearable element 70 includes sewing and bonding. In the case of sewing, as shown in FIG. 36, an area extending along the sides of the opening 22 and the area extending along the sides of the opening 82 are sewed by a sewing thread NT1 whereby the shoe opening of the cover 12 and that of the cover 72 are sewed, and the leading-end area of the instep 16 and the leading-end area of the instep 76 are sewed by a sewing thread T2, whereby the leading-end area of the instep of the cover 12 and that of the cover 72 are sewed. Further, when the first wearable element 5 and the second wearable element 70 are secured by bonding, the area extending along the sides of the opening 22 and the area extending along the sizes of the opening 82 are bonded, and the leading-end area of the instep 16 and the leading-end area of the instep 76 are bonded. On the occasion of bonding, there is a way to place a thermoplastic resin between a bonding area of the cover 12 and that of the cover 72 and subject the resin to heating and thermal welding.

As a result of the first wearable element 5 and the second wearable element 70 being secured, the foot can wear the foot size measurement tool 1 in one operation. By keeping the center indication line 34 and the center indication line 90 in line with each other, bringing the center indication line 34 in line with the center indication line 90, which would be required when the foot kept in the first wearable element 5 is worn over the second wearable element 70, will become unnecessary. Therefore, the first wearable element 5 and the second wearable element 70 do not need to be aligned to each other.

In the above descriptions, the first wearable element 5′ and the second wearable element 70 are separated from each other in the foot size measurement tool 1′. The first wearable element 5′ can also be secured to the second wearable element 70. As in the case of the first wearable element 5 being secured to the second wearable element 70 in the foot size measurement tool 1, the first wearable element 5′ and the second wearable element 70 are secured to each other with the sole 74 situated on the lower wide of the bottom plate 60 in the foot size measurement tool 1′. In the situation where the first wearable element 5′ and the second wearable element 70 are secured, the center indication line 34 and the center indication line 90 are in line with each other.

As in the case of the first wearable element 5 being secured to the second wearable element 70 in the foot size measurement tool 1, the way to secure the first wearable element 5′ and the second wearable element 70 is implemented by sewing or bonding. Specific sewing and bonding ways are similar to those employed when the first wearable element 5 is secured to the second wearable element 70 in the foot size measurement tool 1 and hence their detailed explanations are omitted.

As a result of the first wearable element 5′ and the second wearable element 70 being secured to each other as mentioned above, the foot can wear the foot size measurement tool 1′ in one operation. Further, by keeping the center indication line 34 and the center indication line 90 in line with each other, bringing the center indication line 34 in line with the center indication line 90, which would be required when the foot kept in the first wearable element 5′ is worn over the second wearable element 70, will become unnecessary. Therefore, the first wearable element 5 and the second wearable element 70 do not need to be aligned to each other.

Even when the first wearable element 5(5′) and the second wearable element 70 are secured to each other, since the cover 12 and the cover 72 are made of stretchable material, there is no hindrance to expanding the covers 12 and 72 in agreement with the shape of the foot when the foot wears the foot size measurement tool 1(1′).

In the above description, the shoe opening area of the cover 12 and that of the cover 72 are secured to each other and the leading-end area of the instep 16 and that of the instep 76 are secured to each other. However, another of the first wearable element 5(5′) and that of the second wearable element 70 can also be secured to each other. For instance, side surfaces of the insteps 16 and 76 or the bottom plate 60 and the sole 74 of the cover 72 can also be secured to each other. Where the first wearable element 5(5′) and the second wearable element 70 are secured to each other, the scale mark indicator 40 would not be secured to the ball girth measurement portion 100 and the instep girth measurement portion 120, and the scale mark indicator 50 would not be secured to the ball girth measurement portion 100 and the instep girth measurement portion 120. The minimum requirement to achieve such a configuration is to let the short sides 106c and 108c of the ball girth measurement portion 100 move relatively to the scale mark indicator 40 and to let the short sides 126c and 128c of the instep girth measurement portion 120 move relatively to the scale mark indicator 50. In this regard, the first wearable element 5(5′) must correspond to the second wearable element 70 in the front/rear, left/right, up/down direction. As above, the area of the shoe opening of the cover 12 and that of the cover 72 are secured to each other and the leading-end area of the instep 16 and that of the instep 76 are secured to each other, whereby correspondence can be ensured in the front/rear, left/right, up/down direction.

A second modification of the foot size measurement tool will now be described. The foot size measurement tool 1 and the foot size measurement tool 1′ are equipped with the first wearable element 5(5′) and the second wearable element 70. On the contrary, a foot size measurement tool 1″ of the second modification has only one wearable element.

The foot size measurement tool 1″ has a cover (may also be called “foot cover” or “bag-shaped portion”) 12′ and a bottom plate 60 secured to a bottom surface of the cover 12′.

The cover 12′ is substantially analogous in configuration to the cover 12 in the first wearable element 5 of the foot size measurement tool 1. The cover 12′ assumes the shape of a bag into which a foot slips (may also take the shape of a bag that covers foot) (or may also take the shape of socks or hoses). The cover 12′ has the sole 14, the instep 16 which continually extends from the sole 14 continually leads, the toe 18 which continually extends from the sole 14 and the instep 16 continually lead, and the heel 20 which continually extends from the sole 14 and the instep 16. The cover 12′ as a whole is integrally formed from an elastic, flexible material. An elastic, flexible material forming the cover 12′ is similar to that forming the cover 12. The sole 14 of the cover 12′ is similar in configuration to the sole 14 of the cover 12. The instep 16 of the cover 12′ is similar in configuration to the instep 16 of the cover 12. The toe 18 of the cover 12′ is similar in configuration to the top 18 of the cover 12. The heel 20 of the cover 12′ is similar in configuration to the heel 20 of the cover 12.

The cover 12′ is provided with the ball girth indication line 20, the instep girth indication line 32, and the center indication line 34. The foot size measurement tool 1″ is not equipped with the scale mark indicators 40 and 50.

As in the case of the cover 12 in the first wearable element 5 of the foot size measurement tool 1, the ball girth indication line (the ball girth indication portion) 30 is provided on a substantially-arc-shaped curve (a first imaginary line) 31G which connects the left end point 30P to the right end point 30Q and which is bowed to the front side in a plan view of the cover 12′. The ball girth indication line 30 in the cover 12′ continually extends from the left end point 30P to the right end point 30Q along the curve 31G. The ball girth indication line 30 is a linear indication line (assuming specifically the shape of a solid line) and printed or handwritten.

As in the case with the curve 31G in the foot size measurement tool 1, the curve 31G (may also substantially) coincides with the curve 31L in the plan view of the curve 12′. The ball girth ratio and ball girth angle of the first straight line are same as those acquired with the foot size measurement tool 1.

The ball girth indication line 30 is laid from the left end point 30P to the right end point 30Q. The ball girth indication line 30 can be said to extend from one end (the left end point 30P) to the other end (the right end point 30Q) along a ball girth in the area (specific area) of the cover 12′ except the sole 14. The ball girth indication line 30 can also be said to be provided in a range (specific range) from the left end point 30P to the right end point 30Q within a range (i.e., a loop-shaped range extending along the ball girth) of the cover 12′ that extends along the ball girth. The specific range is a range in the ball girth except an area corresponding to the bottom of the foot.

The indication portion can also be provided along the position of the ball girth indication line 30 in lieu of the indication line. For instance, the ball girth indication portion can also be formed from an embroidery thread or a multi-opening arrangement. In the case of an embroidery thread, a stretchable thread is used. In the case of a multi-opening arrangement, circular openings, for instance, are arranged along the position of the ball girth indication line 30.

As in the case of the cover 12 in the first wearable element 5 of the foot size measurement tool 1, when the cover 12′ is viewed in plan view, the instep girth indication line (instep girth indication portion) 32 is provided on a substantially-arc-shaped curve (a second imaginary line) 33G which connects the left end point 32P to the right end point 32Q and which is bowed to the front side (the toe side). The instep girth indication line 32 in the cover 12′ continually extends from the left end point 32P to the right end point 32Q along the curve 33G. The instep girth indication line 32 is a linear indication line (assuming specifically the shape of a solid line) and printed or handwritten.

As in the case with the curve 33G in the foot size measurement tool 1, the curve 33G (may also substantially) coincides with the curve 33L in the case of the plan perspective view of the curve 12′. The instep girth ratio and instep girth angle of the straight line (the second straight line) are same as those acquired with the foot size measurement tool 1.

The instep girth indication line 32 is laid from the left end point 32P to the right end point 32Q. The instep girth indication line 32 can be said to be extend from one end (the left end point 32P) to the other end (the right end point 32Q) along an instep girth in the area (specific area) of the cover 12′ except the sole 14. The instep girth indication line 32 can also be said to be provided in a range (specific range) from the left end point 32P to the right end point 32Q within a range (i.e., a loop-shaped range extending along the instep girth) of the cover 12′ that extends along the instep girth. The specific range is a range in the instep girth except an area corresponding to the bottom of the foot.

The indication portion can also be provided along the position of the instep girth indication line 32 in lieu of the indication line. For instance, the instep girth indication portion can also be formed from an embroidery thread or a multi-opening arrangement. In the case of an embroidery thread, a stretchable thread is used. In the case of a multi-opening arrangement, circular openings, for instance, are arranged along the position of the instep girth indication line 32.

As in the case of the cover 12 in the first wearable element 5 of the foot size measurement tool 1, the center indication line 34 has the center indication line 34a formed from the leading end of the cover 12 to the front end of the opening 22 and the center indication line 34b formed from the rear end of the cover 12 to the rear end of the opening 22. The center indication lines 34a and 34b are formed at a position corresponding to the center line 34L. The center indication line 34 is printed or handwritten. An indication portion can also be provided in place of the indication line along the position of the center indication line 34. The center indication portion can also be formed from; for instance, an embroidery thread or a multi-opening arrangement. In the case of an embroidery thread, a stretchable thread is used. In the case of the multi-opening arrangement, circular openings, for instance, are arranged along the position of the center indication line 34.

The bottom plate 60 is same as configuration to the bottom plate 60 in the first wearable element 5 of the foot size measurement tool 1. The bottom plate 60 assumes a shape of a flat plate and a substantially-foot-like shape and exhibits inflexibility. Alternatively, when the foot wears the foot size measurement tool 1″, the bottom plate 60 exhibits low flexibility to such an extent that the foot plate 60 does not become deformed along the shape of the bottom of the foot. As in the case of the cover 12 in the first wearable element 5 of the foot size measurement tool 1, the bottom plate 60 is secured to a lower surface of the sole 14 of the cover 12′ by bonding or sewing. As in the case with the foot size measurement tool 1, when the bottom plate 60 is secured to the sole 14 of the cover 12′ by bonding, at least circumference of the bottom plate 60 is bonded to the sole 14. However, it is preferable to bond the entirety of the bottom plate 60 to the sole 14. Further, the bottom plate 60 and the sole 14 can also be secured by sewing. In this case, the bottom plate 60 is secured to the sole 14 by circumferentially sewing at least the circumference of the bottom plate 60. In short, the bottom plate 60 is to be secured to the cover 12 at least along the circumference of the bottom plate 60. As in the case with the bottom plate 60 in the first wearable element 5 of the foot size measurement tool 1 (see FIG. 8), the sole 60 can also be provided inside the cover 12 and secured to the upper surface of the sole 14 by bonding, sewing, or the like. As in the case of the foot size measurement tool 1, even when the bottom plate 60 is provided inside the cover 12, the bottom plate 60 is secured to an upper surface of the sole 14 by bonding, adhesion, or the like. For instance, the bottom plate 60 is bonded to the upper surface of the sole 14 by an adhesion. When the bottom plate 60 is bonded to the sole 14 by an adhesion, at least the circumference of the bottom plate 60 is bonded to the sole 14. However, it is preferable to bond the entirety of the bottom plate 60 to the sole 14. Alternatively, the bottom plate 60 and the sole 14 can also be sewed. In this case, the bottom plate 60 is secured to the sole 14 by circumferentially sewing at least the circumference of the bottom plate 60. In short, the bottom plate 60 is to be secured to the cover 12 at least along the circumference of the bottom plate 60.

Although the bottom plate 60 assumes the shape of a flat plate, the upper and lower surfaces of the bottom plate 60 may also assume a curved shape in conformity to a surface shape of an inner bottom of a shoe to be manufactured and a surface shape of a bottom of the shoe last. In short, the bottom plate 60 may also be shaped as illustrated in FIG. 11.

In the above description, the cover 12′ assumes a bag-shaped contour and has the sole 14, the instep 16, the toe 18, and the heel 20. However, the configuration of the sole 14 can also be omitted, and the lower ends of the instep 16, the toe 18, and the heel 20 can also be secured to and along the circumference (may also be an edge) of the bottom plate 60. In short, the cover 12′ may assume an open shape downwards. In this case, the way to secure the cover 12′ to the bottom plate 60 is same to that for securing the cover 12 in the first wearable element 1 of the foot size measurement tool 1 as shown in FIG. 10(a) and FIG. 10(b).

When the configuration of the sole 14 is omitted, the first straight line, the second straight line, the left end point 30P, the right end point 30Q, the left end point 32P, and the right end point 32Q are determined with reference to the bottom plate 60 in lieu of the sole 14 as mentioned above. The left end point 30P, the right end point 30Q, the left end point 32P, and the right end point 32Q are located at a lower end of the cover 12′ (i.e., positions of contact points with the bottom plate 60). Therefore, the ball girth indication line is provided from one end (i.e., the left end point 30P) to the other end (i.e., the right end point 30Q) of the cover 12′ along the ball girth. The instep indication line is provided from one end (i.e., the left end point 32P) to the other end (i.e., the right end point 32Q) of the cover 12′ along the instep girth.

As above, the foot size measurement tool 1″ is a configuration as a result that the scale mark indicators 40 and 50 are omitted from the first wearable element 5 shown in FIGS. 1 through 5 and the ball girth indication line 30 is formed from the left end point 30P to the right end point 30Q and the instep girth indication line 32 is formed from the left end point 32P to the right end point 32Q.

An explanation will now be given to the way to use the foot size measurement tool 1″ having the above configuration. As contrasted with the foot size measurement tool 1 and the foot size measurement tool 1′, the foot size measurement tool 1″ provides measurements of a ball girth and an instep girth by use of a 3D measurement device.

First, the foot to be measured wears the foot size measurement tool 1″. In short, there is prepared a foot size measurement tool set, in which a plurality of foot size measurement tools longitudinally differ in foot length from each other. Select, from the foot size measurement tool set, the foot size measurement tool 1″ adapting to the length of the foot to be measured. Let the foot wear the selected foot size measurement tool 1″ like socks.

FIG. 24(a) shows a transverse cross section of the foot size measurement tool 1″ with the foot F not inside. FIG. 24(b) shows a transverse cross section of the foot size measurement tool 1″ with the foot F inside. The cover 12′ stretches according to an outer contour of the foot F and further closely adhere to the surface of the foot F (since the sole 14 is secured to the bottom plate 60, the sole 14 will not be closely adhere to the bottom of the foot).

When the foot with a foot arch wears the foot size measurement tool 1″, space Fs is created below the foot arch Fa of the foot F. Specifically, since the sole 14 of the cover 12′ is bonded to the bottom plate 60, the sole 14 will not closely adhere to the bottom surface of the foot F, and the space Fs is created below the foot arch Fa. Specifically, the space Fs is created below the foot arch by the bottom plate 60 while the foot with the arch is held in the foot size measurement tool 1″. As a result, the space Fs can reproduce the space to be created between the foot arch Fa, which is present when the foot wears the shoe while remaining in contact with a footbed of the shoe, and the footbed.

The length of the ball girth indication line 30 (taken as a ball girth indication length) and the length of the instep girth indication line 32 (taken as an instep girth indication line length) are measured by means of the 3D measurement device with the foot wearing the foot size measurement tool 1″. In a word, the length of the ball girth indication line 30 from the left end point 30P to the right end point 30Q is measured, and the instep girth indication line 32 from the left end point 32P and the right end point 32Q is also measured.

A straight line distance (taken as a first straight line length) between the left end point 30P and the right end point 30Q can be measured by means of the 3D measurement device. The ball girth is measured with the 3D measurement device by summing up the ball girth indication line length and the first straight line length. Further, the straight line distance (taken as a second straight line length) between the left end point 32P and the right end point 32Q can also be measured by means of the 3D measurement device. The instep girth is measured with the 3D measurement device by summing up the instep girth indication line length and the second straight line length.

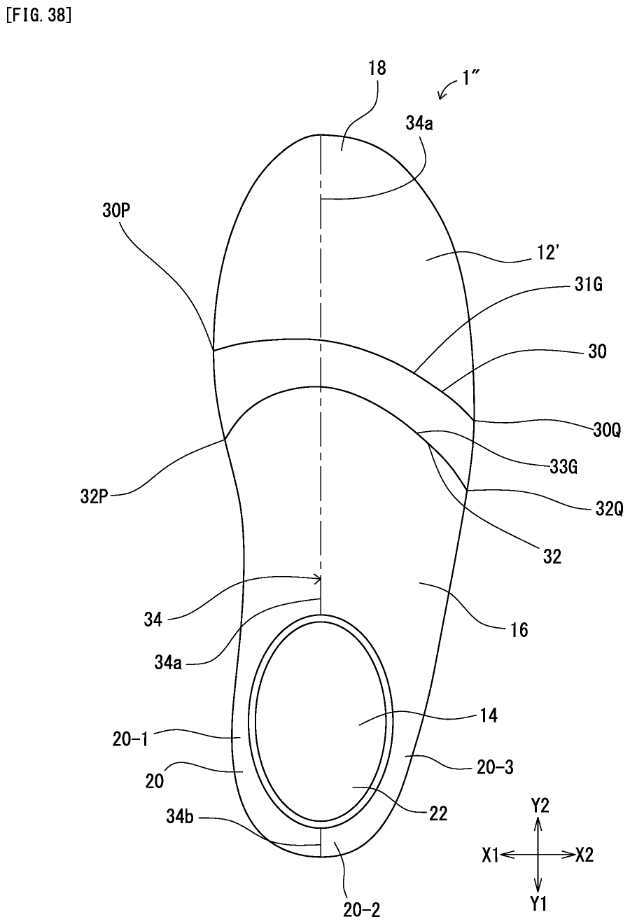

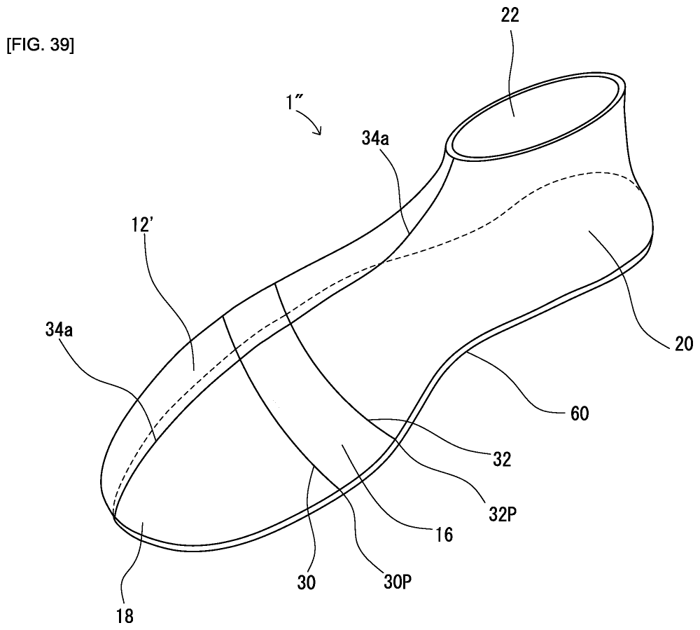

As mentioned above, as to the foot size measurement tool 1″ shown in FIGS. 38 and 39, the foot wears the foot size measurement tool 1″ that adapts to the foot length, the length along the ball girth indication line 30 and the length along the instep girth indication line 32 are measured by means of the 3D measurement device, whereby the ball girth and instep girth can be obtained. The scale measuring section with scale marks does not need to be wound around the foot, so that the ball girth and instep girth can be readily measured.

The bottom plate 60 is provided in the foot size measurement tool 1″, and space is created below the foot arch of the foot (i.e., space is created below the foot arch by the bottom plate 60) when the foot (specifically having a foot arch) wears the foot size measurement tool 1″. Hence, an instep girth suitable for manufacture of shoes can be measured. In short, on the occasion of manufacture of shoes, since the shoe last is formed such that space is created between the foot arch and the footbed of the shoe, the instep girth suitable for manufacture of shoes can be measured as a result of placement of the bottom plate 60.

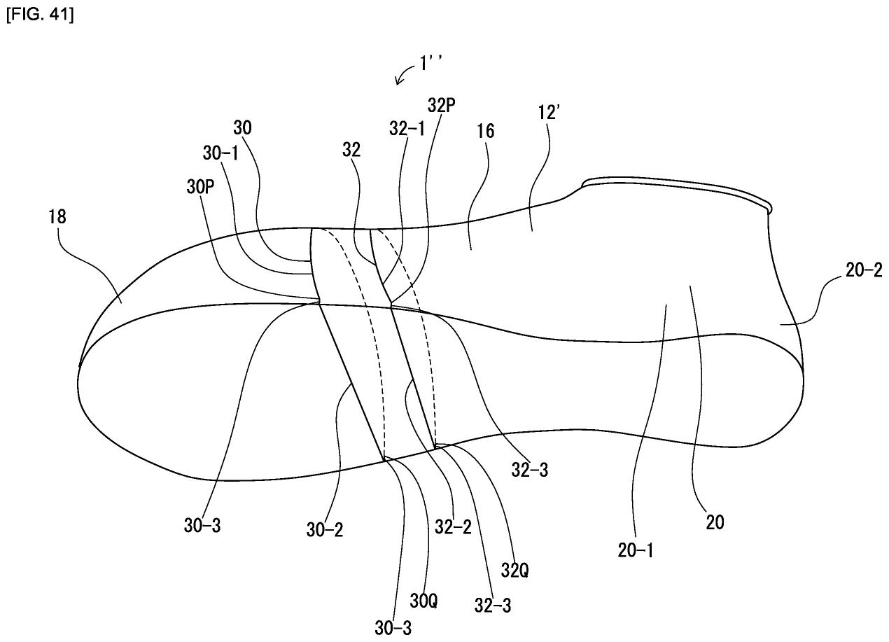

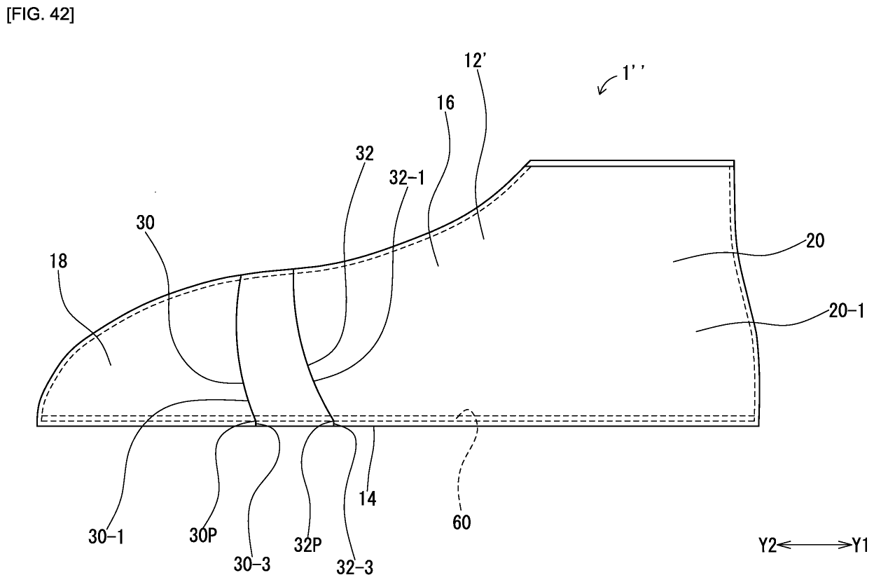

In the foot size measurement tool 1″ shown in FIGS. 38 and 39, the bottom plate 60 is disposed outside the cover 12′. However, as in the case of the foot size measurement tool shown in FIG. 8, the bottom plate 60 can also be disposed inside the cover 12′. In other words, the scale mark indicators 40 and 50 can also be omitted from the configuration shown in FIG. 8. Further, the ball girth indication line 30 can also be formed from the left end point 30P to the right end point 30Q, and the instep girth indication line 32 can also be formed from the left end point 32P to the right end point 32Q. In short, in the foot size measurement tool 1″ shown in FIGS. 41 and 42 to be described later, the ball girth indication line 30 is formed from only the ball girth indication line 30-1, and the instep girth indication line 32 is formed from only the instep girth indication line 32-1.

More specifically, the ball girth indication line 30 is placed from one end (the left end point 30P) to the other end (the right end point 30Q) along the ball girth in the specific area of the cover 12′. The instep girth indication line 32 is placed from one end (the left end point 32P) to the other end (the right end point 32Q) along the instep girth in the specific area of the cover 12′. The specific area of the cover 12′ is an area of cover 12′ that is upper than the position (i.e., positions of the left end points 30P and 32P and the right end points 30Q and 32Q) which is above the bottom of the sole 14 by the thickness of the bottom plate 60.

The ball girth indication portion is placed from one end to the other end in the specific range within the range extending along the ball girth of the cover 12′. The specific range in a range stretching along the ball girth of the cover 12′ is an upper portion of the cover 12′ that is upper than the position which is above the bottom of the sole 14 by the thickness of the bottom plate 60. The instep girth indication portion is placed from one end to the other end in the specific range within the range extending along the instep girth of the cover 12′. The specific range in the range that stretches along the instep girth of the cover 12′ is an upper portion of the cover 12′ that is upper than the position which is above the bottom of the sole 14 by the thickness of the bottom plate 60.

As mentioned above, even when the bottom plate 60 is provided inside the cover 12′, the length (the ball girth indication line length) from the left end point 30P to the right end point 30Q along the ball girth indication line 30 and the straight distance (the first straight length) between the left end point 30P and the right end point 30Q are measured by means of the 3D measurement device. The ball girth is measured by summing up the ball girth indication line length and the first straight line length.

Likewise, the length (the instep girth indication line length) that extends from the left end point 32P to the right end point 32Q along the instep girth indication line 32 and the straight distance (the second straight line length) between the left end point 32P and the right end point 32Q are measured by means of the 3D measurement device. As a result, the instep girth is measured by summing up the instep girth line indication line and the second straight line length.

In the foot size measurement tool 1″, only the cover 12′ is provided with the ball girth indication line 30 and the instep girth indication line 32. However, the bottom plate 60 is also provided with the ball girth indication line 30 and the instep girth indication line 32, and the ball girth indication line 30 and the instep girth indication line 32 can be formed circumferentially.

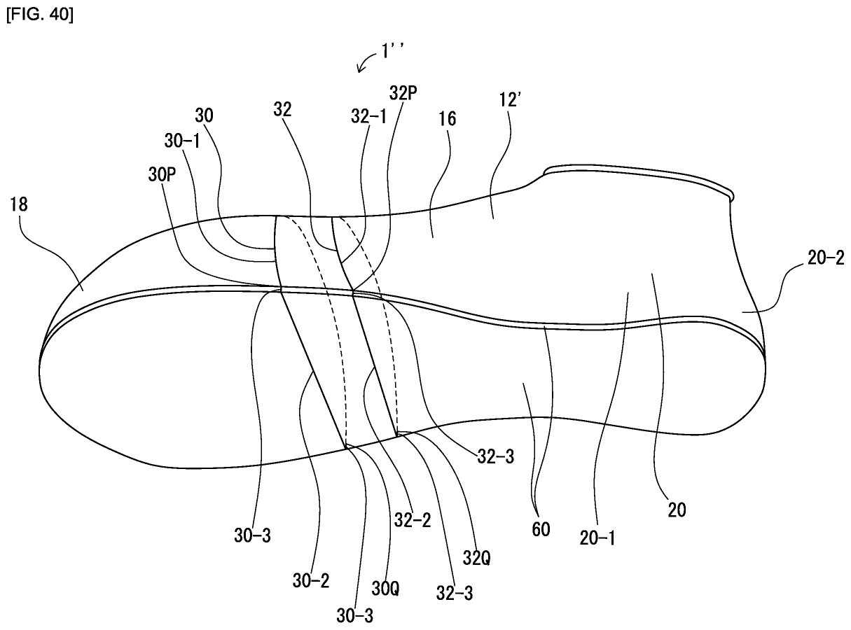

As shown in FIG. 40, the ball girth indication line 30 has the ball girth indication line 30-1 provided on the cover 12′, the ball girth indication line 30-2 provided on the bottom surface of the bottom plate 60, and the ball girth indication line 30-3 provided on the side surface of the bottom plate 60. The ball girth indication line 30 is formed as one loop from the ball girth indication line 30-1, the ball girth indication line 30-2, and the ball girth indication line 30-3.

In the plan perspective view of the foot size measurement tool 1″, the ball girth indication line 30-2 is placed in a position substantially coinciding with the first straight line 30L. The ball girth indication line 30-2 is formed from inner end to an outer end in the bottom surface of the bottom plate 60.

The ball girth indication lines 30-3 are put on the inside and outside of the side surface of the bottom plate 60. One ball girth indication line 30-3 connects one end of the ball girth indication line 30-2 to the left end point 30P. The other ball girth indication line 30-3 connects the other end of the ball girth indication line 30-2 to the right end point 30Q. For information, the ball girth to be originally measured does not take account of the length of the ball girth indication line 30-3. Hence, the direction of the ball girth indication line 30-3 is oriented to a direction normal to the surface of the bottom plate 60 (alternatively a direction perpendicular to the center line 34L).

The instep girth indication line 32 has an instep girth indication line 32-1 provided on the cover 12′; the instep girth indication line 32-2 provided on the bottom surface of the bottom plate 60; and the instep girth indication line 32-3 provided on the side surface of the bottom plate 60. The instep girth indication line 32 is formed as one loop from the instep girth indication line 32-1, the instep girth indication line 32-2 and the instep girth indication line 32-3.

In the plan perspective view of the foot size measurement tool 1′, the instep girth indication line 32-2 is placed at a position substantially coinciding with the second straight line 32L. The instep girth indication line 32-2 is formed from an inner end to outer end of the bottom surface of the bottom plate 60.

The instep girth indication line 32-3 is put on the inside and outside of the side surface of the bottom plate 60. One instep girth indication line 32-3 connects one end of the instep girth indication line 32-2 to the left end point 32P. The other instep girth indication line 32-3 connects the other end of the instep girth indication line 32-2 to the right end point 32Q. For information, the instep girth to be originally measured does not take account of the length of the instep girth indication line 32-3. Hence, the direction of the instep girth indication line 32-3 is oriented to a direction normal to the surface of the bottom plate 60 (alternatively a direction perpendicular to the center line 34L).

As to the foot size measurement tool 1″ shown in FIG. 40, a foot whose length is to be measured is worn over the foot size measurement tool 1″. In short, there is prepared a foot size measurement tool set, in which a plurality of foot size measurement tools longitudinally differ in foot length from each other. Select, from the foot size measurement tool set, the foot size measurement tool 1″ adapting to the length of the foot to be measured. Let the footwear the selected foot size measurement tool 1″ like socks.

The length extending along the ball girth indication line 30 (i.e., the length extending along a loop-shaped line) and the length extending along the instep girth indication line 32 (i.e., the length extending along a loop-shaped line) are measured by means of the 3D measurement device. The length that is twice the length of the ball girth indication line 30-3 is subtracted from the length of the ball girth indication line 30, thereby calculating a ball girth. The length that is twice the length of the instep girth indication line 32-3 is subtracted from the length of the instep girth indication line 32, thereby calculating a instep girth. Incidentally, although the length that is twice the length of the ball girth indication line 30-3 is subtracted from the length of the ball girth indication line 30, the length that is twice the thickness of the bottom plate 60 can also be subtracted from the length of the ball girth indication line 30. Although the length that is twice the length of the instep girth indication line 32-3 is subtracted from the length of the instep girth indication line 32, the length that is twice the thickness of the bottom plate 60 can also be subtracted from the length of the instep girth indication line 32.

Even in the foot size measurement tool 1″ shown in FIG. 40, the ball girth and instep girth can be obtained by means of the 3D measurement device. Hence, the scale measuring section with scale marks do not need to be wound around the foot, so that the ball girth and instep girth can be readily measured. In particular, since the ball girth indication line 30 and the instep girth indication line 32 are formed in a loop shape, the minimum requirement is to measure the ball girth and instep girth by means of the 3D measurement device along the ball girth indication line 30 and the instep girth indication line 32, so that the ball girth and instep girth can be readily measured.

The bottom plate 60 is provided in the foot size measurement tool 1″ shown in FIG. 40, and space is created below the foot arch of the foot (i.e., space is created below the foot arch by the bottom plate 60) when the foot (specifically having a foot arch) wears the foot size measurement tool 1″. Hence, an instep girth suitable for manufacture of shoes can be measured.

In the configuration shown in FIG. 40, the bottom plate 60 is disposed outside the cover 12′. As is the case shown in FIG. 8, the bottom plate 60 is disposed on the inside of the cover 12′, and the ball girth indication line can also be formed on the sole 14 of the cover 12′. The ball girth indication line can also be formed in a loop shape. The instep girth indication line can also be formed on the sole 14 of the cover 12′, and the instep girth indication line can also be formed in a loop shape. Even when the bottom plate 60 is disposed inside the cover 12, as mentioned above the bottom plate 60 is secured to the upper surface of the sole 14 by adhesion or sewing. For instance, the bottom plate 60 is bonded to the upper surface of the sole 14 by means of an adhesive. When the bottom plate 60 is bonded to the sole 14, at least the circumference of the bottom plate 60 is bonded to the sole 14. Preferably, the entirety of the bottom plate 60 is bonded fixedly to the sole 14. The bottom plate 60 and the sole 14 can also be fixed by sewing. In this case, the bottom plate 60 is secured to the sole 14 by circumferentially sewing at least the circumference of the bottom plate 60. In short, the bottom plate 60 is to be secured to the cover 12 at least along the circumference of the bottom plate 60.

As shown in FIGS. 41 and 42, the ball girth indication line 30 is formed in a loop shape on the cover 12′. The ball girth indication line 30 has the ball girth indication line 30-1 provided on the instep 16, the ball girth indication line 30-2 provided on the sole 14 (i.e., the bottom surface of the sole 14), and the pair of ball girth indication lines 30-3 provided in a lower-end area of the instep 16. The ball girth indication line 30-1, the ball girth indication line 30-2, and the two ball girth indication lines 30-3 make up of a loop shape. One ball girth indication line 30-3 connects the end of the ball girth indication line 30-2 to the left end point 30P, and the other ball girth indication line 30-3 connects the end of the ball girth indication line 30-2 to the right end point 30Q. The two ball girth indication lines 30-3 are formed in a direction normal to the surface of the bottom plate 60 (alternatively a direction perpendicular to the center line 34L). As in the case shown in FIG. 8, the left end point 30P and the right end point 30Q are points located at positions that are elevated above the bottom surface of the sole 14 by the thickness of the bottom plate 60. The length of the ball girth indication line 30-3 is equivalent to the thickness of the bottom plate 60. The ball girth indication line 3-2 (may also be substantially) coincides with the first straight line 30L.

Likewise, the instep girth indication line 32 is formed in a loop shape on the cover 12′. The instep girth indication line 32 has the instep girth indication line 32-1 provided on the instep 16, the instep girth indication line 32-2 provided on the sole 14 (i.e., the bottom surface of the sole 14), and the pair of instep girth indication lines 32-3 provided in a lower-end area of the instep 16. The ball girth indication line 32-1, the ball girth indication line 32-2, and the two ball girth indication lines 32-3 are made up of a loop shape. One instep girth indication line 32-3 connects the end of the ball girth indication line 32-2 to the left end point 32P, and the other instep girth indication line 32-3 connects the end of the instep girth indication line 32-2 to the right end point 32Q. The two instep girth indication lines 32-3 are formed in a direction normal to the surface of the bottom plate 60 (alternatively a direction perpendicular to the center line 34L). As in the case shown in FIG. 8, the left end point 32P and the right end point 32Q are points located at positions that are elevated above the bottom surface of the sole 14 by the thickness of the bottom plate 60. The length of the instep girth indication line 32-3 (may also be substantially) coincides with the second straight line 32L. As above, in the configuration shown in FIGS. 41 and 42, the ball girth indication line 30 and the instep girth indication line 32 are formed even in the area of the cover 12′ other than the specific area, and the ball girth indication portion and the instep girth indication portion are formed in a loop shape, respectively.

Even in the foot size measurement tool 1″ shown in FIGS. 41 and 42, as in the case with the foot size measurement tool 1″ shown in FIG. 40, the length of the ball girth indication line 30 (i.e., the length extending along a loop-shaped line) and the length of the instep indication line 32 (i.e., the length extending along a loop-shaped line) are measured by means of the 3D measurement device. The length that is twice the length of the ball girth indication line 30-3 is subtracted from the length of the ball girth indication line 30, thereby calculating a ball girth. Incidentally, the length that is twice the length of the instep girth indication line 32-3 is subtracted from the length of the instep girth indication line 32, thereby calculating a instep girth. Incidentally, although the length that is twice the length of the ball girth indication line 30-3 is subtracted from the length of the ball girth indication line 30, length that is twice the thickness of the bottom plate 60 may also be subtracted from the length of the ball girth indication line 30. Although the length that is twice the length of the instep girth indication line 32-3 is subtracted from the length of the instep girth indication line 32, the length that is twice the thickness of the bottom plate 60 can also be subtracted from the length of the instep girth indication line 32.

Even in the foot size measurement tool 1″ shown in FIGS. 41 and 42, the ball girth and instep girth can be obtained by means of the 3D measurement device. Hence, the scale measuring section with scale marks do not need to be wound around the foot, so that the ball girth and instep girth can be readily measured. In particular, since the ball girth indication line 30 and the instep girth indication line 32 are formed in a loop shape, the minimum requirement is to measure the ball girth and instep girth by means of the 3D measurement device along the ball girth indication line 30 and the instep girth indication line 32, so that the ball girth and instep girth can be readily measured.

The bottom plate 60 is provided in the foot size measurement tool 1″ shown in FIGS. 41 and 42, and space is created below the foot arch of the foot when the foot wears the foot size measurement tool 1″. Hence, an instep girth suitable for manufacture of shoes can be measured.

In the foot size measurement tool 1″ shown in FIGS. 41 and 42, the left end point 30P and the right end point 30Q may be positioned at the ends of the ball girth indication line 30-2 to omit the two ball girth indication lines 30-3. Further, the left end point 32P and the right end point 32Q may be positioned at the ends of the ball girth indication line 32-2 to omit the two ball girth indication lines 32-3.

In the foot size measurement tool 1″ shown in FIG. 40 and the foot size measurement tool 1″ shown in FIGS. 41 and 42, the ball girth indication line 30 is made up of the ball girth indication line 30-1, the ball girth indication line 30-2, and the ball girth indication lines 30-3. The instep girth indication line 32 is made up of the instep girth indication line 32-1, the instep girth indication line 32-2, and the instep girth indication lines 32-3. However, the ball girth indication lines 30-3 can also be omitted, and the ball girth indication line 30 can be formed from only the ball girth indication line 30-1 and the ball girth indication line 30-2 (i.e., the ball girth indication line is not connected between the left end point 30P and the end of the ball girth indication line 30-2. In addition, the ball girth indication line is not connected between the right end point 30Q and the ball girth indication line 30-2). Further, the instep girth indication lines 32-3 can also be omitted, and the instep girth indication line 32 can be formed from only the instep girth indication line 32-1 and the instep girth indication line 32-2 (i.e., the instep girth indication line is not connected between the left end point 32P and the end of the instep girth indication line 32-2. In addition, the instep girth indication line is not connected between the right end point 32Q and the instep girth indication line 32-2). In the case, the length of the ball girth indication line 30-1 and the length of the ball girth indication line 30-2 are measured, and the ball girth can be measured by summing up the thus-measured lengths to each other. The length of the instep girth indication line 32-1 and the length of the instep girth indication line 32-2 are measured, and the instep girth can be measured by summing up the thus-measured lengths.

In the foot size measurement tool 1″ of the second embodiment, where the cover 12′ assumes a bag-shaped contour, the cover 12′ is deemed as socks, whereby the ball girth and instep girth can be measured with mimicking the state of wearing socks. The shoe last fitting the foot wearing the foot size measurement tool can be formed.

In the foot size measurement tool 1″ of the second modification, the ball girth indication line 30 acting as a ball girth indication portion and the instep girth indication line 32 acting as an instep girth indication portion are taken as being a solid line. However, the lines may be non-linear, so long as the 3D measurement device can implement measurement. For instance, a dotted line or a dotted pattern provided along the ball girth and instep girth may also be usable.

### Descriptions of Reference Numerals

1, 1′, 1″ FOOT SIZE MEASUREMENT TOOL
5, 5′ FIRST WEARABLE ELEMENT
10 WEARABLE MAIN BODY
12, 12′ COVER
12-1 SHEET
12-2, 12-3 CLOTH
14 SOLE
16 INSTEP
16a FOLD-OVER PORTION
18 TOE
18a FOLD-OVER PORTION
20 HEEL
22 OPENING
30 BALL GIRTH INDICATION LINE
30a LEFT BALL GIRTH INDICATION LINE
30b RIGHT BALL GIRTH INDICATION LINE
30-1, 30-2, 30-2 BALL GIRTH INDICATION LINE
31G CURVE
30L FIRST STRAIGHT LINE
30P LEFT END POINT
30Q RIGHT END POINT
31L CURVE
32 INSTEP GIRTH INDICATION LINE
32a LEFT INSTEP GIRTH INDICATION LINE
32b RIGHT INSTEP GIRTH INDICATION LINE
32-1, 32-2, 32-3 INSTEP GIRTH INDICATION LINE
33G CURVE
32L SECOND STRAIGHT LINE
32P LEFT END POINT
32Q RIGHT END POINT
33L CURVE
34, 34a, 34b CENTER INDICATION LINE
34G CURVE
34L CENTER LINE
34-1 LEADING END
34-2 REAR END
40 SCALE MARK INDICATOR
40a, 40b LONG SIDE
40b, 40c SHORT SIDE
50 SCALE MARK INDICATOR
50a, 50b LONG SIDE
50b, 50c SHORT SIDE
60 BOTTOM PLATE
70 SECOND WEARABLE ELEMENT
72 COVER
72-1 SHEET
72-2, 72-3 CLOTH
74 SOLE
74L CENTER LINE
74-1 LEADING END
74-2 REAR END
76 INSTEP
76a OPENING
76a-1 CIRCUMFERENCE
76b-1, 76b-2, 76c-1, 76c-2 HOLE
77 SEWING THREAD
77′ ELASTIC MEMBER
78 TOE
80 HEEL
82 OPENING
90, 90a, 90b CENTER INDICATION LINE
90G CURVE
90L CENTER LINE
100 BALL GIRTH MEASUREMENT PORTION
102 BELT-LIKE PORTION
104 BOTTOM BELT-LIKE PORTION
104a, 104b LONG SIDE
104G LINE
104L FIRST STRAIGHT LINE
104-1 INTERSECTION POINT
105G CURVE
106a, 106b LONG SIDE
106c LEFT BELT-LIKE PORTION
108 RIGHT BELT-LIKE PORTION
108a, 108b LONG SIDE
108c SHORT SIDE
110, 112 TAB
114 FASTENING PORTION
116 LACE
118 STOPPER
120 INSTEP GIRTH MEASUREMENT PORTION
122 BELT-LIKE PORTION
122-1, 122-2 BROKEN LINE
124 BOTTOM BELT-LIKE PORTION
124a, 124b LONG SIDE
124G LINE
124L SECOND STRAIGHT LINE
124-1 INTERSECTION POINT
125G, 125L CURVE
126 LEFT BELT-LIKE PORTION
126a, 126b LONG SIDE
126L CURVE
128 RIGHT BELT-LIKE PORTION
128a, 128b LONG SIDE
128c SHORT SIDE
130, 132 TAB
132P, 132Q CONTACT POINT
134 FASTENING PORTION
136 LACE
138 STOPPER
150 MEASUREMENT ANCILLARY TOOL
152, 154, 156, 158 BELT-LIKE PORTION
152a, 154a, 156a, 158a SIDE
F FOOT
Fa FOOT ARCH
Fs SPACE
L40, L50, L76b, L76c, L104, L106, L107, L108, L124, L127, L127′, L126, L128 LENGTH
NT1, NT2 SEWING THREAD

1. A foot size measurement tool for measuring the size of a foot, comprising:
a first wearable element (5, 5′) and a second wearable element (70);
the first wearable element has a first cover (12) and a bottom plate (60) assuming substantially-foot-like shape and plate-shape;
the first cover is formed from a stretchable, flexible material and having a shape for covering at least an instep and having a shoe opening for letting the foot in;
a bottom plate is secured to the first cover such that the bottom plate is situated on a bottom of the foot while the foot is kept in the first wearable element;
the second wearable element has a second cover (72), a ball girth circumferential portion (102) provided on the second cover, and an instep circumferential portion (122) provided on the second cover;
the second cover is formed from a stretchable, flexible material, assumes a bag-shaped form for letting the foot in, and has a shoe opening for letting the foot in; and an opening (76a) being provided in a second cover instep (76) that is an area located on an instep side when the foot wears the second wearable element;
the ball girth circumferential portion is formed in a narrowly-elongated shape on an exterior or interior surface of the second cover at a position on the second cover corresponding to a ball girth of the foot when the foot wears the second wearable element from an area on one side of left and right sides of the instep to an area on the other side of the instep via a second cover sole (74) that is an area situated below the bottom plate when the foot wearing the first wearable element is slipped into the second wearable element, and a pair of first end sides (106c, 108c), which are ends on longitudinal both sides of the ball girth circumferential portion are spaced from each other; the instep girth circumferential portion is formed in a narrowly-elongated shape on an exterior or interior surface of the second cover at a position on the second cover corresponding to an instep girth of the foot when the foot wears the second wearable element from an area on one side of left and right sides of the instep to an area on the other side of the instep via the second cover sole (74), and a pair of second end sides (126c, 128c), which are ends on longitudinal both sides of the instep girth circumferential portion, being spaced from each other;
the ball girth circumferential portion and the instep girth circumferential portion are formed from an unstretchable or stretch-resistant material; and
the foot size measurement tool is used while the second wearable element is worn over the first wearable element with the foot inside.

2. The foot size measurement tool according to claim 1, wherein the first cover has a first cover sole that is an area situated on the bottom of the foot when the foot wears the first wearable element, and as a whole assumes the shape of a bag into which the foot is slipped; and
the bottom plate is provided on an exterior or interior surface of the first cover sole.

3. The foot size measurement tool according to claim 2, wherein the bottom plate is secured to the first cover sole along at least a circumference of the bottom plate.

4. The foot size measurement tool according to claim 1, wherein the first cover assumes a shape that covers an instep, toe and a heel and a downwardly-opened shape, and a lower end of the first cover is secured to a circumference of the bottom plate.

5. The foot size measurement tool according to claim 1, wherein the first cover has a first scale mark indicator (40) and a second scale mark indicator (50);
the first scale mark indicator is provided at a position on the exterior surface of the first cover corresponding to a ball girth on the instep-side of the first cover when the foot wears the first wearable element, and scale marks for measuring a size are arranged on the first scale mark indicator in a direction in line with the ball girth;
the second scale mark indicator is provided at a position on the exterior surface of the first cover corresponding to an instep girth on the instep-side of the first cover when the foot wears the first wearable element, and scale marks for measuring a size are arranged on the second scale mark indicator in a direction in line with the instep girth;
the first scale mark indicator and the second scale mark indicator are formed from an unstretchable or stretch-resistant material;
a pair of first end sides on the ball girth circumferential portion protrudes from an edge of the opening toward the opening or along the edge of the opening;
a pair of second end sides on the instep girth circumferential portion protrudes from an edge of the opening toward the opening or along the edge of the opening; and
the first scale mark indicator is visible between the pair of first end sides and the second scale mark indicator is visible between the pair of second end sides in a plan view while the second wearable element is worn over the first wearable element with the foot inside.

6. The foot size measurement tool according to claim 1, further comprising a measurement ancillary tool (150) that is to be photographed along with the foot size measurement tool while the second wearable element is worn over the first wearable element with the foot inside, wherein a first photographing point (150A), a second photographing point (150B) and a third photographing point (150C), which serve as three measurement targets to be photographed, are provided so as to be spaced apart from each other.

7. A foot size measurement tool for measuring the size of a foot, comprising:
a first wearable element (5, 5′) and a second wearable element (70);
the first wearable element has a wearable main body (10) and a bottom plate (60) assuming substantially-foot-like shape and plate-shape;
the wearable main body is formed from an elastic, flexible material and has a first cover (12) that assumes a bag-shaped form for letting a foot in and that has a shoe opening for letting the foot in, a first scale mark indicator (40) which is placed on an exterior surface of the first cover at an instep-side position corresponding to a ball girth when the foot wears the first wearable element, and a second scale mark indicator (50) which is placed on the exterior surface of the first cover at an instep-side position corresponding to an instep girth when the foot wears the first wearable element; scale marks used for measuring a size are arranged on the first scale mark indicator in a direction in line with the ball girth; scale marks for measuring a size are arranged on the second scale mark indicator in a direction in line with the instep girth; and the first scale mark and the second scale mark being formed from an unstretchable or stretch-resistant material;
the bottom plate is secured to an exterior or interior surface of a first cover sole (14) that is an area of the first cover situated on bottom of the foot when the foot wears the first wearable element;
the second wearable element has a second cover (72), a ball girth circumferential portion (102) provided on the second cover, and an instep circumferential portion (122) provided on the second cover;
the second cover is formed from an elastic, flexible material, assuming a bag-shaped form for letting the foot in, and has a shoe opening for letting the foot in; and an opening (76a) being provided in a second cover instep (76) that is an area situated on an instep-side position when the foot wears the second wearable element;
the ball girth circumferential portion is formed in a narrowly-elongated shape on an exterior or interior surface of the second cover at a position on the second cover corresponding to a ball girth of the foot when the foot wears the second wearable element from an area on one side of left and right sides of the instep to an area on the other side of the instep via a second cover sole (74) that is an area situated below the bottom plate when the foot wearing the first wearable element is slipped into the second wearable element, and a pair of first end sides (106c, 108c), which are ends on longitudinal both sides of the ball girth circumferential portion are spaced from each other; and the pair of first end sides protrudes from a edge of the opening toward the opening or along the edge of the opening;
the instep girth circumferential portion is formed in a narrowly-elongated shape on an exterior or interior surface of the second cover at a position on the second cover corresponding to an instep girth of the foot when the foot wears the second wearable element from an area on one side of left and right sides of the instep to an area on the other side of the instep via the second cover sole (74), and a pair of second end sides (126c, 128c), which are ends on longitudinal both sides of the instep girth circumferential portion, being spaced from each other; and the pair of second end sides protrudes from the edge of the opening toward the opening or along the edge of the opening;
the ball girth circumferential portion and the instep girth circumferential portion being formed from an unstretchable or stretch-resistant material; and
the first scale mark indicator being visible between the pair of first end sides and the second scale mark indicator being visible between the pair of second end sides in a plan view while the second wearable element is worn over the first wearable element with the foot inside.

8. The foot size measurement tool according to claim 5, wherein the first cover has, when the foot wears the first wearable element, a first cover instep (16) that is an area located on the instep side of the foot, a first cover toe (18) that is an area located on the toe side of the foot, and a first cover heel (20) that is an area located on the heel of the foot;
the first scale mark indicator is provided on a first imaginary line (31G) on the first cover instep; the first imaginary line substantially coincides with a first imaginary curve (31L) as viewed in plan perspective view; in a first worn state in which the first wearable element is worn over the foot whose length adapts to a length from the toe-side end to heel-side end of the first wearable element and in a plan view of the first wearable element, the first imaginary straight line passes (30L) through a location where a first ball girth ratio, which is a ratio of a length (H2) of the first imaginary center line from the heel-side end to a length (H1) of a first imaginary center line (34L) which is a straight line from a toe-side end to heel-side end of the first wearable element, ranges from 61.5 to 71.5%; and where a first ball girth angle (α1), which is an angle formed between a toe-side direction of the first imaginary center line and a foot's-inner-side direction of the first imaginary straight line with respect to a left-right direction of the first wearable element, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate as viewed in a plan view, and is bowed toward the toe; the second scale mark indicator is provided on a second imaginary line (33G) on the second cover instep; the second imaginary line substantially coincides with a second imaginary curve (33L) as viewed in plan perspective view; when the first wearable element is viewed in plan view in the first worn state, a second imaginary straight line (32L) passes through a location where a first instep girth ratio, which is a ratio of a length of the first imaginary center line from the heel-side end to the length (H1) of the first imaginary center line from the toe-side end to heel-side end of the first wearable element, ranges from 51.0 to 61.0%; and where a first instep girth angle (α2), which is an angle formed between the toe-side direction of the first imaginary center line and a foot's-inner-side direction of the second imaginary straight line with respect to the left-right direction of the first wearable element, ranges from 75.5 to 85.5 degrees for men and from 74.5 to 84.5 degrees for women; and the second imaginary curve interconnects two contact points (32P, 32Q) between the second imaginary straight line (32L) and the contour of the bottom plate as viewed in a plan view, and is bowed toward the toe;
the second cover has the second cover sole and the second cover instep and, when the second wearable element is worn over the first wearable element with the foot inside, also has a second cover toe (78) that is a toe-size area of the foot and a second cover heel (80) that is a heel-side area of the foot;
the ball girth circumferential portion has a ball girth bottom configuration (104) provided on the second cover sole, a ball girth first lateral configuration (106) provided from one end of the ball girth bottom configuration and on the second cover instep, and a ball girth second lateral configuration (108) provided from the other end of the ball girth bottom configuration and also on the second cover instep;
the ball girth bottom configuration is provided on a third imaginary line (104G) in the second cover sole, and the third imaginary line substantially coincides, in a plan perspective view, with the first imaginary straight line (30L) in a second worn state in which the second wearable element is worn over the first wearable element with the foot inside while the length of the second wearable element from a toe-side end to heel-side end corresponds to a length of the first imaginary center line;
the ball girth first lateral configuration and the ball girth second lateral configuration are provided on a fourth imaginary line (105G) in the second cover instep, and the fourth imaginary line substantially coincides with the first imaginary curve (31L) in the second worn state when the second wearable element is viewed in plan perspective view;
the instep girth circumferential portion has an instep girth bottom configuration (124) provided on the second cover sole, an instep girth first lateral configuration (126) provided from one end of the instep girth bottom configuration and on the second cover instep, and an instep girth second lateral configuration (128) provided from the other end of the instep girth bottom configuration and also on the second cover instep;
an instep girth bottom configuration is provided on a fifth imaginary line (124G) in the second cover sole, and in the second worn state, the fifth imaginary line substantially coincides with the second imaginary straight line (32L) in plan perspective view; and
the instep first lateral configuration and the instep second lateral configuration are provided on a sixth imaginary line (125G) in the second cover instep, and the sixth imaginary line substantially coincides with the second imaginary line (33L) in the plan perspective view of the second wearable element.

9. The foot size measurement tool according to claim 8, wherein the ball girth bottom configuration, the ball girth first lateral configuration, and the ball girth second lateral configuration each assume a belt-like shape that has mutually-lateral long sides; and
the instep girth bottom configuration, the instep girth first lateral configuration, and the instep second lateral configuration each assume a belt-like shape that has mutually-lateral long sides.

10. The foot size measurement tool according to claim 9, wherein, in a developed state of the ball girth circumferential portion, a toe-side angle, which is formed between a direction of the long side of the ball girth bottom configuration and a direction of the long side of the ball girth first lateral configuration, ranges from 185 to 191 degrees, and a toe-side angle, which is made between a direction of the long side of the ball girth bottom configuration and a direction of the long side of the ball girth second lateral configuration, ranges from 151 to 157 degrees;
a toe-side angle closer to the ball girth first lateral configuration, which is made by a direction of a boundary (102-1) between the ball girth bottom configuration and the ball girth first lateral configuration with a direction of the long side of the ball girth first lateral configuration, ranges from 73 to 79 degrees;
a toe-side angle closer to the ball girth second lateral configuration, which is formed by a direction of a boundary (102-2) between the ball girth bottom configuration and the ball girth second lateral configuration with a direction of the long side of the ball girth second lateral configuration, ranges from 67 to 73 degrees;
in a developed state of the instep girth circumferential portion, a toe-side angle, which is formed between a direction of the long side of the instep girth bottom configuration and a direction of the long side of the instep girth first lateral configuration, ranges from 188 to 194 degrees, and a toe-side angle, which is formed between a direction of the long side of the instep girth bottom configuration and a direction of the long side of the instep girth second lateral configuration, ranges from 172 to 178 degrees;
a toe-side angle closer to the instep girth first lateral configuration, which is formed by a direction of a boundary (122-1) between the instep girth bottom configuration and the instep girth first lateral configuration with a direction of the long side of the instep girth first lateral configuration, ranges from 64 to 70 degrees; and
a toe-side angle closer to the instep girth second lateral configuration, which is formed by a direction of a boundary (122-2) between the instep girth bottom configuration and the instep girth second lateral configuration with a direction of the long side of the instep girth second lateral configuration, ranges from 77 to 83 degrees.

11. The foot size measurement tool according to claim 5, wherein the first scale mark indicator and the second scale mark indicator are unstretchable or stretch-resistant in at least a direction of arrangement of the scale marks.

12. The foot size measurement tool according to claim 1, wherein, in an instep-side area of the first cover with the first wearable element the foot inside, a first center indication portion (34a) is aligned, with respect to a direction of foot length from the toe-side end to heel-side end of the first wearable element, to a first imaginary center line (34L) that is a straight line from a toe-side end to heel-side end of the first wearable element in a plan view of the first wearable element; and
in a second cover instep of the second wearable element, a second center indication portion (90a) is aligned, with respect to a direction of foot length from the toe-side end to heel-side end of the second wearable element, to a second imaginary center line (90L) that is a straight line from a toe-side end to heel-side end of the second wearable element in a plan view of the second wearable element.

13. The foot size measurement tool according to claim 1, wherein a first tab (110) that protrudes from one edge area of the ball girth circumferential portion to a toe or heel side is provided in an area adjoining the edge of the opening in the second cover, and a second tab (112) that protrudes from the other edge area of the ball girth circumferential portion to the toe or heel side is provided in an area adjoining the edge of the opening in the second cover;
the first tab and the area on the second cover where the first tab is provided each have a first hole (110-1, 76b-1) for inserting the first lace (116), and the second tab and the area on the second cover where the second tab is provided each have a second hole (112-1, 76b-1) for inserting the first lace (116);
a third tab (130) that protrudes from one edge area of the instep girth circumferential portion to a toe or heel side is provided in an area adjoining the edge of the opening in the second cover, and a fourth tab (132) that protrudes from the other edge area of the instep girth circumferential portion to the toe or heel side is provided in an area adjoining the edge of the opening in the second cover;
the third tab and the area on the second cover where the third tab is provided each have a third hole (130-1, 76c-1) for inserting the second lace (136), and the fourth tab and the area on the second cover where the fourth tab is provided each have a fourth hole (132-1, 76c-2) for inserting the second lace (136);
the first lace inserted into the first tab and the second tab and the second lace inserted into the third tab and the fourth tab are provided; and
the first lace adjusts the degree of fastening between the first tab and the second tab, and the second lace adjusts the degree of fastening between the third tab and the fourth tab.

14. The foot size measurement tool according to claim 1, wherein the instep of the second cover is provided with a stretchable elastic member (77, 77′) along the edge of the opening.

15. The foot size measurement tool according to claim 1, wherein the ball circumferential portion exhibits unstretchability or stretch resistance at least longitudinally, and the instep circumferential portion exhibits unstretchability or stretch resistance at least longitudinally;
the first cover of the first wearable element exhibits stretchability at least in a direction orthogonal to the direction of a foot length that is a direction from the toe-side end to heel-side end of the first wearable element; and
the second cover of the second wearable element exhibits stretchability at least in a direction orthogonal to the direction of a foot length that is a direction from the toe-side end to heel-side end of the second wearable element.

16. The foot size measurement tool according to claim 1, wherein the bottom plate is formed from an inflexible material or a material that exhibits low flexibility to such an extent that the bottom plate is not deformed along the shape of the bottom of the foot when the foot wears the first wearable element.

17. The foot size measurement tool according to claim 1, wherein the first wearable element and the second wearable element are separately structured, and during use of the foot size measurement tool, the foot wears the first wearable element, and the second wearable element is worn over the first wearable element.

18. The foot size measurement tool according to claim 1, wherein the first wearable element is provided inside the second wearable element; the second cover sole is placed on a lower side of the bottom plate; and the first wearable element is secured to the second wearable element while the shoe opening of the first cover is visible through the shoe opening of the second cover when the foot size measurement tool is viewed in plan view.

19. The foot size measurement tool set equipped with the plurality of foot size measurement tools defined in claim 1, wherein the first wearable elements in the plurality of foot size measurement tools differ from each other in terms of a length from a toe-side end to heel-side end of the first wearable element, and
the second wearable elements in the plurality of foot size measurement tools differ from each other in terms of a length from a toe-side end to heel-side end of the second wearable element.

20. A foot size measurement tool for measuring a foot size, comprising:
a cover (12) and a bottom plate (60) that is secured to the cover and assumes a substantially-foot-like shape and plate-shape;
the cover is formed from a stretchable, flexible material, assuming a shape which covers at least areas of an instep, a toe, and a heel, that is the area except the bottom of the foot on the surface of the foot, and having a shoe opening for letting the foot in;
the bottom plate is secured to the cover along at least the circumference of the bottom plate such that the bottom plate is situated on the bottom of the foot while the foot wears the foot size measurement tool;
a ball girth indication portion (30) is provided on an exterior surface of the cover at a position corresponding to a ball girth of the foot when the foot wears the foot size measurement tool;
an instep girth indication portion (32) is provided on an exterior surface of the cover at a position corresponding to an instep girth of the foot when the foot wears the foot size measurement tool; and
space is created below a foot arch by the bottom plate while the foot with a foot arch wears the foot size measurement tool.

21. The foot size measurement tool according to claim 20, wherein the cover has a sole (14) that is an area located on the bottom of the foot when the foot wears the foot size measurement tool, and the cover as a whole assumes a bag shape into which the foot is slipped;
the bottom plate is provided on an exterior surface of the sole;
the ball girth indication portion is placed at least from one end to the other end in a specific area of the cover along the ball girth;
the instep girth indication portion is placed at least from one end to the other end in a specific area of the cover along the instep girth; and
the specific area of the cover is an area on the cover except the sole.

22. The foot size measurement tool according to claim 20, wherein the cover has a sole (14) that is an area located on the bottom of the foot when the foot wears the foot size measurement tool, and the cover as a whole assumes a bag shape into which the foot is slipped;
the bottom plate is provided on an interior surface of the sole;
the ball girth indication portion is placed at least from one end to the other end along the ball girth in a specific area of the cover;
the instep girth indication portion is placed at least from one end to the other end along the instep girth in a specific area of the cover; and
the specific area of the cover is an upper area of the cover that is upper than the position which is above the bottom of the sole by the thickness of the bottom plate.

23. The foot size measurement tool according to claim 20, wherein the cover assumes a downwardly-opened shape, and a lower end of the cover is secured to the bottom plate along a circumference;
the ball girth indication portion is placed at least from one end to the other end of the cover along the ball girth; and
the instep girth indication portion is placed at least from one end to the other end of the cover along the instep girth.

24. The foot size measurement tool according to claim 21, wherein the ball girth indication portion is placed at a position corresponding to a ball girth on a bottom surface of the bottom plate, and the instep girth indication portion is placed at a position corresponding to an instep girth on the bottom surface of the bottom plate.

25. A foot size measurement tool for measuring a foot size, comprising:
a cover (12) and a plate-like bottom plate (60) that is secured to the cover and assumes shape of a substantially-foot-shaped form;
the cover is formed from a stretchable, flexible material, has a sole (14) that is an area located on bottom of a foot when the foot wears the foot size measurement tool, and as a whole assumes a bag shape into which the foot is slipped;
the bottom plate is provided on an interior surface of the sole;
a ball girth indication portion (30) is provided, on an exterior surface of the cover, at a position corresponding to a ball girth of the foot when the foot wears the foot size measurement tool, and the ball girth indication portion is placed at least from one end to the other end in a specific area of the cover along the ball girth;
an instep girth indication portion (32) is provided, on an exterior surface of the cover, at a position corresponding to an instep girth of the foot when the foot wears the foot size measurement tool, and the instep girth indication portion is placed at least from one end to the other end in a specific area of the cover along the instep girth;
the specific area of the cover is an upper area of the cover that is upper than the position which is above the bottom of the sole by the thickness of the bottom plate; and
space is created below a foot arch by the bottom plate while the foot with a foot arch wears the foot size measurement tool.

26. The foot size measurement tool according to claim 25, wherein the ball girth indication portion is provided in shape of a loop on the cover, and the instep girth indication portion is provided in shape of a loop on the cover.

27. The foot size measurement tool according to claim 20, wherein the ball girth indication portion is a linear indication portion laid along the ball girth, and the instep girth indication portion is a linear indication laid along the instep girth.

28. The foot size measurement tool according to claim 20, wherein, the cover has, when the foot wears the foot size measurement tool, an instep (16) that is an area located on the instep side of the foot, a toe (18) that is an area located on the toe side of the foot, and a heel (20) that is an area located on the heel side of the foot; a ball girth indication portion is provided on a first imaginary line (31G) on the instep; the first imaginary line substantially coincides with a first imaginary curve (31L) as viewed in plan perspective view; in a worn state in which the wearable element is worn over the foot whose length adapts to a length from the toe-side end to heel-side end of the foot size measurement tool and in a plan view of the foot size measurement tool, a first imaginary straight line (30L) passes through a location where a ball girth ratio of a length (H2) of the imaginary center line from the heel-side end to a length (H1) of an imaginary center line (34L) which is a straight line from a toe-side end to heel-side end of the foot size measurement tool ranges from 61.5 to 71.5%; a ball girth angle (α1), which is formed between a toe-side direction of the imaginary center line and a foot's-inner-side direction of the imaginary straight line with respect to a left-right direction of the foot size measurement tool, ranges from 69.0 to 79.0 degrees for men and from 68.0 to 78.0 degrees for women; and the first imaginary curve (31L) interconnects two contact points (30P, 30Q) between the first imaginary straight line (30L) and a contour of the bottom plate viewed in a plan view, and is bowed toward the toe;
the instep girth indication portion is provided on a second imaginary line (33G) over the instep; the second imaginary line substantially coincides with a second imaginary curve (33L) as views in plan perspective view; and when the foot size measurement tool is viewed in plan view in a worn state, a second imaginary straight line (32L) passes through a location where an instep girth ratio of a length of the imaginary centerline from the heel-side end to the length (H1) of the imaginary center line ranges from 51.0 to 61.0%; an instep girth angle (α2), which is formed between the toe-side direction of the imaginary center line and a foot's-inner-side direction of the second imaginary straight line with respect to the left-right direction of the foot size measurement tool, ranges from 75.5 to 85.5 degrees for men and from 74.5 to 84.5 degrees for women; and a second imaginary curve (33L) interconnects two contact points (32P, 32Q) between a second imaginary straight line (32L) and the contour of the bottom plate as viewed in a plan view, and is bowed toward the toe.

29. The foot size measurement tool according to claim 20, wherein the cover exhibits stretchability at least in a direction orthogonal to a direction of a foot length that is a direction of the foot size measurement tool from a toe-side end to a heel-side end.

30. The foot size measurement tool according to claim 20, wherein the bottom plate is formed from an inflexible material or a material that exhibits low flexibility to such an extent that the bottom plate is not deformed along the shape of the bottom of the foot when the foot wears the foot size measurement tool.

31. The foot size measurement tool according to claim 1, wherein the bottom plate assumes the shape of a flat plate.

32. The foot size measurement tool according to claim 1, wherein the bottom plate assumes a plate-like shape having a curve that adapts to a curved shape of a shoe inner bottom of a shoe to be manufactured or a curved shape of a bottom surface of a shoe last.

33. A foot size measurement tool set having the plurality of foot size measurement tools defined in claim 20, wherein the plurality of foot size measurement tools differ from each other in terms of a length from a toe-side end to heel-side end of the foot size measurement tool.
